(19) United States
(12) Patent Application Publication
(10) Pub. No.: US 2025/0077183 A1
(43) Pub. Date: Mar. 6, 2025

(54) NORMALIZER FOR OPERATING ON FLOATING-POINT DATA

(71) Applicant: SK hynix Inc., Icheon-si Gyeonggi-do (KR)

(72) Inventor: Seong Ju LEE, San Jose, CA (US)

(73) Assignee: SK hynix Inc., Icheon-si Gyeonggi-do (KR)

(21) Appl. No.: 18/953,913

(22) Filed: Nov. 20, 2024

Related U.S. Application Data
(63) Continuation-in-part of application No. 17/503,770, filed on Oct. 18, 2021.

(30) Foreign Application Priority Data
May 18, 2021 (KR) 10-2021-0064088

(51) Int. Cl. G06F 7/556; G06F 5/01; G06F 7/499

(52) U.S. Cl. CPC G06F 7/556; G06F 5/012; G06F 7/49915; G06F 7/49973

(57) ABSTRACT

A normalizer for performing normalization on floating-point data includes a search circuit configured to receive selected mantissa data and to output reference exponent data and shift data, the selected mantissa data being either mantissa data of the floating-point data or 2's complement data of the mantissa data, an exponent adder configured to output normalized exponent data by adding exponent data of the floating-point data and the reference exponent data, and a unidirectional mantissa shifter configured to output normalized mantissa data by performing a unidirectional shift on the selected mantissa data based on a value of the shift data.

### CROSS-REFERENCE TO RELATED APPLICATIONS

The present application is a continuation-in-part application of U.S. patent application Ser. No. 17/503,770, filed on Oct. 18, 2021, which claims priority under 35 U.S.C. § 119 (a) to Korean application number 10-2021-0064088, filed on May 18, 2021, in the Korean Intellectual Property Office, which applications are incorporated herein by reference in their entirety.

### BACKGROUND

### 1. Technical Field

Various embodiments of the present teachings relate to normalizers for floating-point data operations, and more particularly to normalizers comprising a unidirectional mantissa shifter.

### 2. Related Art

### SUMMARY

A normalizer according to an embodiment of the present disclosure may include a search circuit configured to receive selected mantissa data and to output reference exponent data and shift data, the selected mantissa data being either mantissa data of floating-point data or 2's complement data of the mantissa data, an exponent adder configured to output normalized exponent data by adding exponent data of the floating-point data and the reference exponent data, and a unidirectional mantissa shifter configured to output normalized mantissa data by performing a unidirectional shift on the selected mantissa data based on a value of the shift data.

A normalizer according to an embodiment of the present disclosure may include a reference exponent data generator configured to generate and output reference exponent data based on mantissa data of floating-point data, a first exponent adder configured to output modified exponent data by performing a first exponent addition on exponent data of the floating-point data and the reference exponent data, a search circuit configured to receive selected mantissa data and to output shift data, the selected mantissa data being either the mantissa data of the floating-point data or 2's complement data of the mantissa data, a second exponent adder configured to output normalized exponent data by performing a second exponent addition on the modified exponent data and the shift data, and a unidirectional mantissa shifter configured to output normalized mantissa data by performing a unidirectional shift on the selected mantissa data based on a value of the shift data.

### BRIEF DESCRIPTION OF THE DRAWINGS

Certain features of the disclosed technology are illustrated by various embodiments with reference to the attached drawings, in which:

FIG. 1 is a block diagram illustrating an artificial intelligence accelerator according to an embodiment of the present disclosure;

FIG. 2 is a timing diagram illustrating an accumulative adding calculation of an accumulative addition circuit included in the artificial intelligence accelerator of FIG. 1;

FIG. 3 illustrates an example of a matrix multiplying calculation executed by a multiplication/accumulation (MAC) operation of the artificial intelligence accelerator of FIG. 1;

FIG. 4 illustrates a process of storing weight data in FIG. 3 into a left memory bank and a right memory bank included in the artificial intelligence accelerator of FIG. 1;

FIG. 5 illustrates a process of storing vector data in FIG. 3 into a first global buffer and a second global buffer included in the artificial intelligence accelerator of FIG. 1;

FIG. 6 is a block diagram illustrating an example of configurations and operations of a left multiplication circuit, a right multiplication circuit, and an integrated adder tree included in the artificial intelligence accelerator of FIG. 1;

FIG. 7 is a block diagram illustrating an example of configurations and operations of a left accumulator and a right accumulator constituting an accumulative addition circuit included in the artificial intelligence accelerator of FIG. 1;

FIG. 8 is a block diagram illustrating an example of a configuration of a left accumulative adder included in a left accumulator shown in FIG. 7;

FIG. 9 is a block diagram illustrating an example of a configuration of an exponent operation circuit included in the left accumulative adder of FIG. 8;

FIG. 10 is a block diagram illustrating an example of a configuration of a mantissa operation circuit included in the left accumulative adder of FIG. 8;

FIG. 11 is a block diagram illustrating an example of a configuration of a normalizer included in the left accumulative adder of FIG. 8;

FIG. 12 illustrates an operation of processing exponent part data and mantissa part data during an accumulative adding calculation of the left accumulative adder described with reference to FIGS. 8 to 11;

FIG. 13 illustrates operation timings of a left accumulative adder and a right accumulative adder shown in FIG. 7;

FIG. 14 is a block diagram illustrating an artificial intelligence accelerator according to another embodiment of the present disclosure;

FIG. 15 is a block diagram illustrating an example of a configuration of a left multiplication/addition circuit included in the artificial intelligence accelerator of FIG. 14;

FIG. 16 is a block diagram illustrating an example of a configuration of a right multiplication/addition circuit included in the artificial intelligence accelerator of FIG. 14;

FIG. 17 is a block diagram illustrating an artificial intelligence accelerator according to yet another embodiment of the present disclosure;

FIG. 18 is a block diagram illustrating an example of a configuration of a first MAC unit included in the artificial intelligence accelerator of FIG. 17;

FIG. 19 is a block diagram illustrating another example of a configuration of a first MAC unit included in the artificial intelligence accelerator of FIG. 17;

FIG. 20 illustrates a matrix multiplying calculation executed by a MAC operation of the artificial intelligence accelerator of FIG. 17;

FIG. 21 is a block diagram illustrating a normalizer according to an embodiment of the present disclosure.

FIG. 22 is a block diagram illustrating an example of a “1” search circuit included in a normalizer of FIG. 21.

FIG. 23 is a block diagram illustrating another example of a “1” search circuit included in a normalizer of FIG. 21.

FIGS. 24 and 25 are block diagrams illustrating an example of a look-up table included in a “1” search circuit of FIG. 23.

FIG. 26 is a block diagram illustrating an example of a unidirectional mantissa shifter included in a normalizer of FIG. 21.

FIG. 27 is a circuit diagram illustrating an example of a first shift stage included in a unidirectional mantissa shifter of FIG. 26.

FIG. 28 is a circuit diagram illustrating an example of a second shift stage included in a unidirectional mantissa shifter of FIG. 26.

FIG. 29 is a circuit diagram illustrating an example of a third shift stage included in a unidirectional mantissa shifter of FIG. 26.

FIG. 30 is a circuit diagram illustrating an example of a fourth shift stage included in a unidirectional mantissa shifter of FIG. 26.

FIG. 31 is a circuit diagram illustrating an example of a fifth shift stage included in a unidirectional mantissa shifter of FIG. 26.

FIG. 32 is a block diagram illustrating a floating-point addition circuit including a normalizer according to an embodiment of the present disclosure.

FIG. 33 is a block diagram illustrating an example of a floating-point adder included in a floating-point addition circuit of FIG. 32.

FIG. 34 is a block diagram illustrating an example of an exponent processing circuit included in a floating-point adder of FIG. 33.

FIG. 35 is a block diagram illustrating an example of a mantissa processing circuit included in a floating-point adder of FIG. 33.

FIGS. 36 to 38 are block diagrams for explaining operations of a floating-point adder of FIG. 33.

FIG. 39 is a diagram illustrating an operation of a unidirectional mantissa shifter included in a normalizer of FIG. 38.

FIG. 40 is a diagram illustrating an example of operations of a normalizer included in a floating-point addition circuit of FIG. 32.

FIG. 41 is a diagram illustrating an operation of a unidirectional mantissa shifter included in a normalizer of FIG. 40.

FIG. 42 is a diagram illustrating a further example of operations of a normalizer included in a floating-point addition circuit of FIG. 32.

FIG. 43 is a diagram illustrating an example of operation of a unidirectional mantissa shifter included in a normalizer of FIG. 42.

FIG. 44 is a block diagram illustrating a normalizer according to another embodiment of the present disclosure.

FIG. 45 is a diagram illustrating an example of an operation of a reference exponent data generator included in a normalizer of FIG. 44.

FIG. 46 is a block diagram illustrating an example of a “1” search circuit included in a normalizer of FIG. 44.

FIG. 47 is a block diagram illustrating a further example of a “1” search circuit included in a normalizer of FIG. 44.

FIGS. 48 and 49 are diagrams illustrating an example of a look-up table included in a “1” search circuit of FIG. 47.

FIG. 50 is a block diagram illustrating an example of an operation of a normalizer of FIG. 44.

FIG. 51 is a block diagram illustrating a further example of an operation of a normalizer of FIG. 44.

FIG. 52 is a block diagram illustrating a further example of an operation of a normalizer of FIG. 44.

### DETAILED DESCRIPTION OF THE EMBODIMENTS

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed. A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In an embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure. Although the following embodiments are described in conjunction with dynamic random access memory (DRAM) devices, it may be apparent to those of ordinary skill in the art that the present disclosure is not limited to the DRAM devices. For example, the following embodiments may be equally applied to various memory devices such as an SRAM, a synchronous DRAM (SDRAM), a double data rate synchronous DRAM (DDR SDRAM, DDR2 SDRAM, or DDR3 SDRAM), a graphic double data rate synchronous DRAM (GDDR, GDDR2, GDDR3, or the like), a quad data rate DRAM (QDR DRAM), a Rambus extreme data rate DRAM (Rambus XDR DRAM), a fast page mode DRAM (FPM DRAM), a video DRAM (VDRAM), an extended data output DRAM (EDO DRAM), a burst extended data output DRAM (BEDO DRAM), a multibank DRAM (MDRAM), a synchronous graphic RAM (SGRAM), or another type DRAM.

Various embodiments are directed to artificial intelligence accelerators.

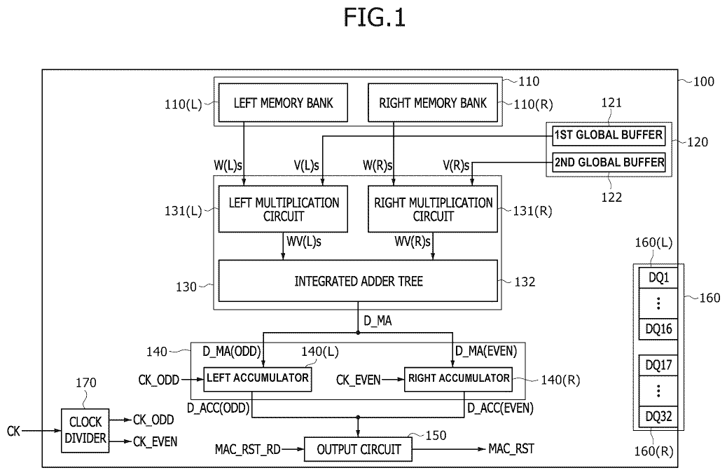

FIG. 1 is a block diagram illustrating an artificial intelligence (AI) accelerator 100 according to an embodiment of the present disclosure. In an embodiment, the AI accelerator 100 may have a processing-in-memory (PIM) structure performing an arithmetic operation in a memory structural device. Alternatively, the AI accelerator 100 may have a structure of a graphic processing unit (GPU), an application specific integrated circuit (ASIC) specified to deep learning operations, or a field programmable gate array (FPGA) based on a programmable logic. Hereinafter, the following embodiments will be described in conjunction with a case that the AI accelerator 100 performs a MAC operation. However, the following embodiments may be merely some examples of the present disclosure. Accordingly, the AI accelerator 100 may be configured to perform other arithmetic operations (including an accumulative adding calculation) other than the MAC operation.

Referring to FIG. 1, the AI accelerator 100 may include a first memory circuit 110, a second memory circuit 120, a multiplication circuit/adder tree 130, an accumulative addition circuit 140, an output circuit 150, a data input/output (I/O) circuit 160, a clock divider 170.

The first memory circuit 110 may include a left memory bank 110(L) and a right memory bank 110(R) which are disposed to be physically distinguished from each other. The left memory bank 110(L) and the right memory bank 110(R) may have substantially the same memory size. The left memory bank 110(L) may store left weight data W(L)s used for a MAC operation, and the right memory bank 110(R) may store right weight data W(R)s used for the MAC operation. The left memory bank 110(L) may transmit the left weight data W(L)s to the multiplication circuit/adder tree 130 in response to a control signal for controlling the MAC operation, and the right memory bank 110(R) may transmit the right weight data W(R)s to the multiplication circuit/adder tree 130 in response to a control signal for controlling the MAC operation.

The second memory circuit 120 may include a first global buffer 121 and a second global buffer 122. The first global buffer 121 may store left vector data V(L)s used for the MAC operation, and the second global buffer 122 may store right vector data V(R)s used for the MAC operation. The first global buffer 121 may transmit the left vector data V(L)s to the multiplication circuit/adder tree 130 in response to a control signal for controlling the MAC operation, and the second global buffer 122 may transmit the right vector data V(R)s to the multiplication circuit/adder tree 130 in response to a control signal for controlling the MAC operation. Although not shown in FIG. 1, the left vector data V(L)s and the right vector data V(R)s may be transmitted from the first global buffer 121 and the second global buffer 122 to the multiplication circuit/adder tree 130 through a global data I/O line (GIO).

The multiplication circuit/adder tree 130 may perform a multiplying calculation and an adding calculation using the weight data W(L)s and W(R)s and the vector data V(L)s ad V(R)s outputted from the first and second memory circuits 110 and 120 as input data, thereby generating and outputting multiplication/addition result data D_MA. The multiplication circuit/adder tree 130 may include a left multiplication circuit 131(L), a right multiplication circuit 131(R), and an integrated adder tree 132. The left multiplication circuit 131(L) may receive the left weight data W(L)s and the left vector data V(L)s from respective ones of the left memory bank 110(L) and the first global buffer 121. The left multiplication circuit 131(L) may perform a multiplying calculation on the left weight data W(L)s and the left vector data V(L)s to generate and output left multiplication result data WV(L)s. The right multiplication circuit 131(R) may receive the right weight data W(R)s and the right vector data V(R)s from respective ones of the right memory bank 110(R) and the second global buffer 122. The right multiplication circuit 131(R) may perform a multiplying calculation on the right weight data W(R)s and the right vector data V(R)s to generate and output right multiplication result data WV(R)s. The left multiplication result data WV(L)s and the right multiplication result data WV(R)s may be transmitted to the integrated adder tree 132. The integrated adder tree 132 may perform an adding calculation on the left multiplication result data WV(L)s and the right multiplication result data WV(R)s outputted from respective ones of the left multiplication circuit 131(L) and the right multiplication circuit 131(R), thereby generating and outputting the multiplication/addition result data D_MA.

The accumulative addition circuit 140 may perform an accumulative adding calculation for adding the multiplication/addition result data D_MA outputted from the multiplication circuit/adder tree 130 to latched data generated by a previous accumulative adding calculation, thereby generating and outputting accumulated data D_ACC. The accumulative addition circuit 140 may include a left accumulator 140(L) and a right accumulator 140(R). The left accumulator 140(L) and the right accumulator 140(R) may alternately receive the multiplication/addition result data D_MA from the multiplication circuit/adder tree 130. For example, the left accumulator 140(L) may receive odd-numbered multiplication/addition result data D_MA(ODD) from the multiplication circuit/adder tree 130, and the right accumulator 140(R) may receive even-numbered multiplication/addition result data D_MA(EVEN) from the multiplication circuit/adder tree 130. The left accumulator 140(L) may perform an accumulative adding calculation for adding the odd-numbered multiplication/addition result data D_MA(ODD) outputted from the multiplication circuit/adder tree 130 to the latched data generated by a previous accumulative adding calculation, thereby generating and outputting odd-numbered accumulated data D_ACC(ODD). The accumulative adding calculation of the left accumulator 140(L) may be performed in synchronization with an odd clock signal CK_ODD. The right accumulator 140(R) may perform an accumulative adding calculation for adding the even-numbered multiplication/addition result data D_MA(EVEN) outputted from the multiplication circuit/adder tree 130 to the latched data generated by a previous accumulative adding calculation, thereby generating and outputting even-numbered accumulated data D_ACC(EVEN). The accumulative adding calculation of the right accumulator 140(R) may be performed in synchronization with an even clock signal CK_EVEN. The output circuit 150 may receive the odd-numbered accumulated data D_ACC(ODD) or the even-numbered accumulated data D_ACC(EVEN) from the accumulative addition circuit 140. The output circuit 150 may output the odd-numbered accumulated data D_ACC(ODD) or the even-numbered accumulated data D_ACC(EVEN) as MAC result data MAC_RST corresponding to a result of a final MAC operation in response to a MAC result read signal MAC_RST_RD having a first logic level such as a logic “high” level. A logic level of the MAC result read signal MAC_RST_RD may change from a logic “low” level into a logic “high” level when the odd-numbered accumulated data D_ACC(ODD) or the even-numbered accumulated data D_ACC(EVEN) generated by termination of the MAC operations on all of the weight data W(L)s and W(R)s and all of the vector data V(L)s and V(R)s are transmitted to the output circuit 150.

The data I/O circuit 160 may provide a means for data transmission between the AI accelerator 100 and an external device such as a host or a controller. The data I/O circuit 160 may include left data I/O terminals 160(L) and right data I/O terminals 160(R). The left data I/O terminals 160(L) may provide transmission paths of read data outputted from the left memory bank 110(L) or write data inputted to the left memory bank 110(L). In an embodiment, the left data I/O terminals 160(L) may include a plurality of data I/O terminals, for example, first to sixteenth data I/O terminals DQ1˜DQ16. The right data I/O terminals 160(R) may provide transmission paths of read data outputted from the right memory bank 110(R) or write data inputted to the right memory bank 110(R). In an embodiment, the right data I/O terminals 160(R) may include a plurality of data I/O terminals, for example, seventeenth to 32^{nd} data I/O terminals DQ17˜DQ32. The left data I/O terminals 160(L) and the right data I/O terminals 160(R) may provide transmission paths of the MAC result data MAC_RST outputted from the output circuit 150.

The clock divider 170 may divide a clock signal CK inputted to the AI accelerator 100 to generate and output the odd clock signal CK_ODD and the even clock signal CK_EVEN. The odd clock signal CK_ODD may be comprised of only odd pulses among pulses of the clock signal CK, and the even clock signal CK_EVEN may be comprised of only even pulses among the pulses of the clock signal CK. Thus, each of the odd clock signal CK_ODD and the even clock signal CK_EVEN may have a cycle which is twice a cycle of the clock signal CK. In an embodiment, the clock divider 170 may delay the clock signal CK by a certain time to generate and output the odd clock signal CK_ODD and the even clock signal CK_EVEN having a cycle which is twice a cycle of the clock signal CK. The clock divider 170 may transmit the odd clock signal CK_ODD to the left accumulator 140(L) of the accumulative addition circuit 140 and may transmit the even clock signal CK_EVEN to the right accumulator 140(R) of the accumulative addition circuit 140.

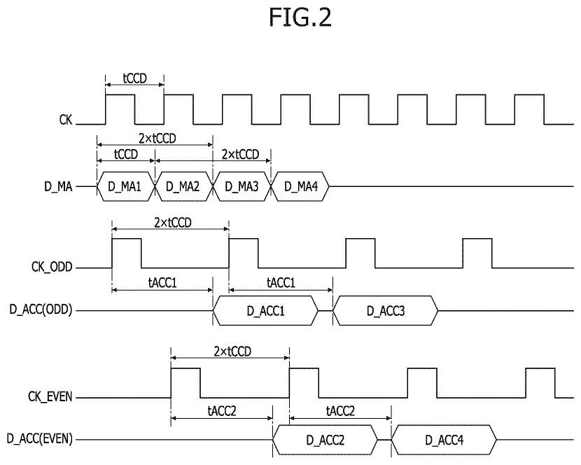

FIG. 2 is a timing diagram illustrating an accumulative adding calculation of the accumulative addition circuit 140 included in the AI accelerator 100 of FIG. 1. In the present embodiment, it may be assumed that the clock signal CK inputted to the clock divider 170 may have a cycle which is equal to a CAS to CAS delay time “tCCD” corresponding to an interval time between column addresses. In addition, it may be assumed that a time it takes the multiplication circuit/adder tree 130 to perform a multiplying calculation and an adding calculation is shorter than the CAS to CAS delay time “tCCD”.

Referring to FIGS. 1 and 2, first to fourth multiplication/addition result data D_MA1˜D_MA4 outputted from the multiplication circuit/adder tree 130 may be alternately transmitted to the left accumulator 140(L) and the right accumulator 140(R). Thus, the odd-numbered multiplication/addition result data D_MA(ODD) (i.e., the first and third multiplication/addition result data D_MA1 and D_MA3) may be transmitted to the left accumulator 140(L), and the even-numbered multiplication/addition result data D_MA(EVEN) (i.e., the second and fourth multiplication/addition result data D_MA2 and D_MA4) may be transmitted to the right accumulator 140(R). In an embodiment, the first to fourth multiplication/addition result data D_MA1˜D_MA4 may be outputted from the multiplication circuit/adder tree 130 at an interval time of the CAS to CAS delay time “tCCD”. Accordingly, the left accumulator 140(L) may receive the first and third multiplication/addition result data D_MA1 and D_MA3 at an interval time of twice the CAS to CAS delay time “tCCD”. Similarly, the right accumulator 140(R) may receive the second and fourth multiplication/addition result data D_MA2 and D_MA4 at an interval time of twice the CAS to CAS delay time “tCCD”.

The left accumulator 140(L) may be synchronized with a first pulse of the odd clock signal CK_ODD to perform an accumulative adding calculation on the first multiplication/addition result data D_MA1 and the latched data. The first pulse of the odd clock signal CK_ODD may be generated at a point in time when a certain time elapses from a point in time when a first pulse of the clock signal CK occurs. Because a first accumulative adding calculation is performed, a latch circuit of the left accumulator 140(L) may be reset to have a value of zero as the latched data. Thus, the left accumulator 140(L) may terminate the accumulative adding calculation at a point in time when a first accumulative addition time “tACC1” elapses from a point in time when the first pulse of the odd clock signal CK_ODD is generated, thereby generating first accumulated data D_ACC1 as first odd-numbered accumulated data D_ACC(ODD). The first accumulative addition time “tACC1” may mean a time it takes the left accumulator 140(L) to perform an accumulative adding calculation. The first accumulated data D_ACC1 may be used as latched data during a next accumulative adding calculation of the left accumulator 140(L).

The right accumulator 140(R) may be synchronized with a first pulse of the even clock signal CK_EVEN to perform an accumulative adding calculation on the second multiplication/addition result data D_MA2 and the latched data. The first pulse of the even clock signal CK_EVEN may be generated at a point in time when a certain time elapses from a point in time when a second pulse of the clock signal CK occurs. Because the first accumulative adding calculation is performed, a latch circuit of the right accumulator 140(R) may also be reset to have a value of zero as the latched data. Thus, the right accumulator 140(R) may terminate the accumulative adding calculation at a point in time when a second accumulative addition time “tACC2” elapses from a point in time when the first pulse of the even clock signal CK_EVEN is generated, thereby generating second accumulated data D_ACC2 as first even-numbered accumulated data D_ACC(EVEN). The second accumulative addition time “tACC2” may mean a time it takes the right accumulator 140(R) to perform an accumulative adding calculation. The second accumulated data D_ACC2 may be used as latched data during a next accumulative adding calculation of the right accumulator 140(R).

The left accumulator 140(L) may be synchronized with a second pulse of the odd clock signal CK_ODD to perform an accumulative adding calculation on the third multiplication/addition result data D_MA3 and the latched data (i.e., the first accumulated data D_ACC1). The second pulse of the odd clock signal CK_ODD may be generated at a point in time when a certain time elapses from a point in time when a third pulse of the clock signal CK occurs. The left accumulator 140(L) may terminate the accumulative adding calculation at a point in time when the first accumulative addition time “tACC1” elapses from a point in time when the second pulse of the odd clock signal CK_ODD is generated, thereby generating third accumulated data D_ACC3 as second odd-numbered accumulated data D_ACC(ODD). The third accumulated data D_ACC3 may be used as latched data during a next accumulative adding calculation of the left accumulator 140(L).

The right accumulator 140(R) may be synchronized with a second pulse of the even clock signal CK_EVEN to perform an accumulative adding calculation on the fourth multiplication/addition result data D_MA4 and the latched data (i.e., the second accumulated data D_ACC2). The second pulse of the even clock signal CK_EVEN may be generated at a point in time when a certain time elapses from a point in time when a fourth pulse of the clock signal CK occurs. The right accumulator 140(R) may terminate the accumulative adding calculation at a point in time when the second accumulative addition time “tACC2” elapses from a point in time when the second pulse of the even clock signal CK_EVEN is generated, thereby generating fourth accumulated data D_ACC4 as second even-numbered accumulated data D_ACC(EVEN). The fourth accumulated data D_ACC4 may be used as latched data during a next accumulative adding calculation of the right accumulator 140(R).

As described above, the first accumulative addition time “tACC1” it takes the left accumulator 140(L) to perform the accumulative adding calculation may be longer than the CAS to CAS delay time “tCCD” and may be shorter than twice the CAS to CAS delay time “tCCD”. Similarly, the second accumulative addition time “tACC2” it takes the right accumulator 140(R) to perform the accumulative adding calculation may also be longer than the CAS to CAS delay time “tCCD” and may be shorter than twice the CAS to CAS delay time “tCCD”. In general, in the event that the multiplication/addition result data D_MA are generated at an interval time of the CAS to CAS delay time “tCCD” and the accumulative addition time “tACC” is longer than the CAS to CAS delay time “tCCD”, a point in time when the multiplication/addition result data D_MA are transmitted to an accumulative adder of an accumulator is inconsistent with a point in time when the latched data are transmitted to the accumulative adder of the accumulator. Thus, in such a case, it may be necessary to adjust the CAS to CAS delay time “tCCD” during the MAC operation. However, in case of the AI accelerator 100 according to the present embodiment, the left accumulator 140(L) and the right accumulator 140(R) may perform an accumulative adding calculation within the first accumulative addition time “tACC1” and the second accumulative addition time “tACC2”, which are shorter than twice the CAS to CAS delay time “tCCD”, respectively. Thus, it may be unnecessary to adjust the CAS to CAS delay time “tCCD” during the MAC operation. In addition, in the event that each memory bank is divided into the left memory bank 110(L) and the right memory bank 110(R), a left MAC operator and a right MAC operator may be disposed to be allocated to respective ones of the left memory bank 110(L) and the right memory bank 110(R). Each of the left MAC operator and the right MAC operator may include an accumulator. In the AI accelerator 100 according to the present embodiment, the left accumulator 140(L) may be realized using an accumulator included in the left MAC operator, and the right accumulator 140(R) may be realized using an accumulator included in the right MAC operator. Thus, it may be unnecessary to additionally dispose accumulators occupying a relatively large area in the AI accelerator 100. Accordingly, it may be possible to realize compact AI accelerators.

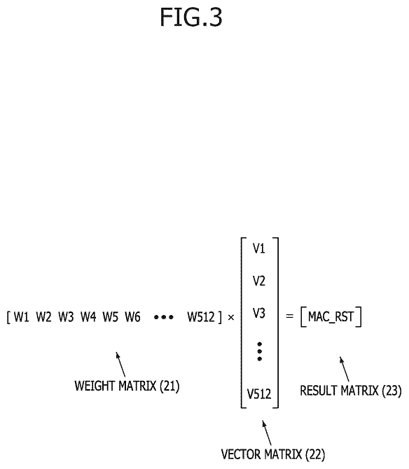

FIG. 3 illustrates an example of a matrix multiplying calculation executed by a MAC operation of the AI accelerator 100 of FIG. 1. Referring to FIG. 3, the AI accelerator 100 may perform a matrix-vector multiplying calculation on a weight matrix 21 and a vector matrix 22 to generate a result matrix 23. The present embodiment will be described in conjunction with a case that the weight matrix 21 is a ‘1×512’ matrix having one row and 512 columns, the vector matrix 22 is a ‘512×1’ matrix having 512 rows and one column, and the result matrix 23 is a ‘1×1’ matrix having one row and one column. The weight matrix 21 may have 512 elements corresponding to 512 sets of weight data W1˜W512 (i.e., first to 512th weight data W1˜W512). The vector matrix 22 may also have 512 elements corresponding to 512 sets of vector data V1˜V512 (i.e., first to 512^{th} vector data V1˜V512). The result matrix 23 may have one element corresponding to one set of the MAC result data MAC_RST. The MAC result data MAC_RST of the result matrix 23 may be generated by a matrix-vector multiplying calculation on the weight data W1˜W512 and the vector data V1˜V512. Hereinafter, it may be assumed that each of the first to 512^{th} weight data W1˜W512 and each of the first to 512^{th} vector data V1˜V512 have an IEEE 754 format (i.e., 32-bit single-precision floating-point format).

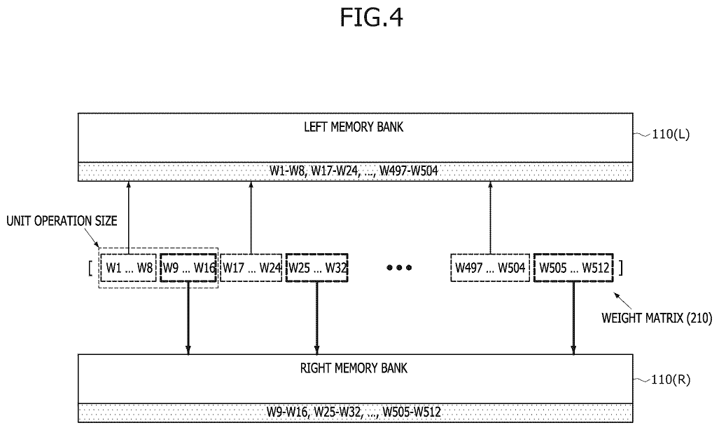

FIG. 4 illustrates a process of storing the weight data W1˜W512 of FIG. 3 into the left memory bank 110(L) and the right memory bank 110(R) included in the AI accelerator 100 of FIG. 1. As described with reference to FIG. 1, the weight data W1˜W512 used for the MAC operation may be stored in the left memory bank 110(L) and the right memory bank 110(R). Hereinafter, the weight data stored in the left memory bank 110(L) will be referred to as ‘left weight data’, and the weight data stored in the right memory bank 110(R) will be referred to as ‘right weight data’.

Referring to FIG. 4, the weight data W1˜W512 of the weight matrix 21 illustrated in FIG. 3 may be evenly allocated to the left memory bank 110(L) and the right memory bank 110(R) by a unit operation size. The unit operation size may be defined as a size of the weigh data (or the vector data) which are used for a single MAC operation of the AI accelerator 100 illustrated in FIG. 1. The unit operation size may be determined according to a hardware configuration of the multiplication circuit/adder tree 130 included in the AI accelerator 100. Hereinafter, it may be assumed that a size (i.e., the unit operation size) of the weight data processed by a single arithmetic operation of the multiplication circuit/adder tree 130 is 512 bits. As described with reference to FIG. 3, because each set of the plural sets of the weight data W1˜W512 and the plural sets of the vector data V1˜V512 has 32 bits, 16 sets of the weight data may be processed by a single MAC operation of the AI accelerator 100. In such a case, the first to 512^{th} weight data W1˜W512 may be evenly allocated to both of the left memory bank 110(L) and the right memory bank 110(R) in units of 16 sets of the weight data.

Specifically, a first group of 16 sets of the weight data (i.e., the first to sixteenth weight data W1˜W16 may be evenly allocated to and stored in the left memory bank 110(L) and the right memory bank 110(R). That is, the first to eighth weight data W1˜W8 may be stored in the left memory bank 110(L), and the ninth to sixteenth weight data W9˜W16 may be stored in the right memory bank 110(R). A second group of 16 sets of the weight data (i.e., the seventeenth to 32^{nd} weight data W17˜W32) may also be evenly allocated to and stored in the left memory bank 110(L) and the right memory bank 110(R). That is, the seventeenth to 24^{th} weight data W17˜W24 may be stored in the left memory bank 110(L), and the 25^{th} to 32^{nd} weight data W25˜W32 may be stored in the right memory bank 110(R). Similarly, a 32^{nd} group of 16 sets of the weight data (i.e., the 497^{th} to 512^{th} weight data W497˜W512) may also be evenly allocated to and stored in the left memory bank 110(L) and the right memory bank 110(R). That is, the 497^{th} to 504^{th} weight data W497˜W504 may be stored in the left memory bank 110(L), and the 505^{th} to 512^{th} weight data W505˜W512 may be stored in the right memory bank 110(R).

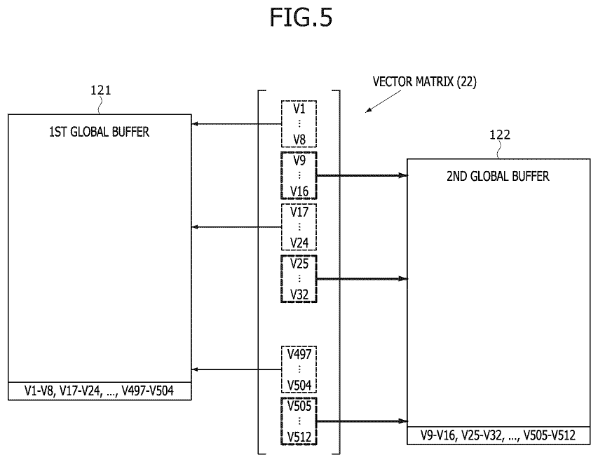

FIG. 5 illustrates a process of storing the vector data V1˜V512 of FIG. 3 into the first global buffer 121 and the second global buffer 122 included in the AI accelerator 100 of FIG. 1. Referring to FIG. 5, the vector data V1˜V512 the vector matrix 22 illustrated in FIG. 3 may be evenly allocated to the first global buffer 121 and the second global buffer 122 by the unit operation size. Because the unit operation size is defined as 512 bits in the present embodiment, the first to 512^{th} vector data V1˜V512 may be evenly allocated to both of the first global buffer 121 and the second global buffer 122 in units of 16 sets of the vector data. Specifically, a first group of 16 sets of the vector data (i.e., the first to sixteenth vector data V1˜V16 may be evenly allocated to and stored in the first global buffer 121 and the second global buffer 122. That is, the first to eighth vector data V1˜V8 may be stored in the first global buffer 121, and the ninth to sixteenth vector data V9˜V16 may be stored in the second global buffer 122. A second group of 16 sets of the vector data (i.e., the seventeenth to 32^{nd} vector data V17˜V32) may also be evenly allocated to and stored in the first global buffer 121 and the second global buffer 122. That is, the seventeenth to 24^{th} weight data V17˜V24 may be stored in the first global buffer 121, and the 25^{th} to 32^{nd} vector data W25˜W32 may be stored in the second global buffer 122. Similarly, a 32^{nd} group of 16 sets of the vector (i.e., the 497^{th} to 512^{th} vector data V497˜V512) may also be evenly allocated to and stored in the first global buffer 121 and the second global buffer 122. That is, the 497^{th} to 504^{th} vector data V497˜V504 may be stored in the first global buffer 121, and the 505^{th} to 512^{th} vector data V505˜V512 may be stored in the second global buffer 122.

In case of the present embodiment, because a single MAC operation is performed using 16 sets of the weight data and 16 sets of the vector data as input data, it may be necessary to iteratively perform the MAC operation 32 times in order to generate the MAC result data MAC_RST of the result matrix 23 illustrated in FIG. 3. A first MAC operation of the 32 MAC operations may be performed using the first group of 16 sets of the weight data W1˜W16 and the first group of 16 sets of the vector data V1˜V16 as input data. In such a case, the left memory bank 110(L) may transmit the first to eight weight data W1˜W8 to the left multiplication circuit 131(L), and the right memory bank 110(R) may transmit the ninth to sixteenth weight data W9˜W16 to the right multiplication circuit 131(R). In addition, the first global buffer 121 may transmit the first to eight vector data V1˜V8 to the left multiplication circuit 131(L), and the second global buffer 122 may transmit the ninth to sixteenth vector data V9˜V16 to the right multiplication circuit 131(R).

A second MAC operation of the 32 MAC operations may be performed using the second group of 16 sets of the weight data W17˜W32 and the second group of 16 sets of the vector data V17˜V32 as input data. In such a case, the left memory bank 110(L) may transmit the seventeenth to 24^{th} weight data W17˜W24 to the left multiplication circuit 131(L), and the right memory bank 110(R) may transmit the 25^{th} to 32^{nd} weight data W25˜W32 to the right multiplication circuit 131(R). In addition, the first global buffer 121 may transmit the seventeenth to 24^{th} vector data V17˜V24 to the left multiplication circuit 131(L), and the second global buffer 122 may transmit the 25^{th} to 32^{nd} vector data V25˜V32 to the right multiplication circuit 131(R). Similarly, a 32^{nd} MAC operation corresponding to the last MAC operation of the 32 MAC operations may be performed using the 32^{nd} group of 16 sets of the weight data W497˜W512 and the 32^{nd} group of 16 sets of the vector data V497˜V512 as input data. In such a case, the left memory bank 110(L) may transmit the 497^{th} to 504^{th} weight data W497˜W504 to the left multiplication circuit 131(L), and the right memory bank 110(R) may transmit the 505^{th} to 512^{th} weight data W505˜W512 to the right multiplication circuit 131(R). In addition, the first global buffer 121 may transmit the 497^{th} to 504^{th} vector data V497˜V504 to the left multiplication circuit 131(L), and the second global buffer 122 may transmit the 505^{th} to 512^{th} vector data V505˜V512 to the right multiplication circuit 131(R).

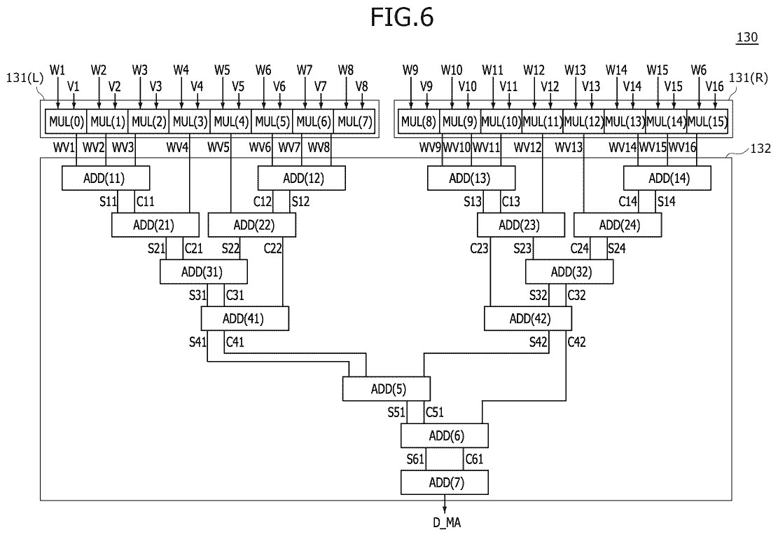

FIG. 6 is a block diagram illustrating an example of configurations and operations of the left multiplication circuit 131(L), the right multiplication circuit 131(R), and the integrated adder tree 132 included in the AI accelerator 100 of FIG. 1. Referring to FIG. 6, the left multiplication circuit 131(L) may include a plurality of multipliers, for example, first to eighth multipliers MUL(0)˜MUL(7). The first to eighth multipliers MUL(0)˜MUL(7) may receive the first to eighth weight data W1˜W8 from the left memory bank 110(L), respectively. In addition, the first to eighth multipliers MUL(0)˜MUL(7) may receive the first to eighth vector data V1˜V8 from the first global buffer (121 of FIG. 1), respectively. The first to eighth weight data W1˜W8 may constitute the left weight data W(L)s described with reference to FIG. 1, and the first to eighth vector data V1˜V8 may constitute the left vector data V(L)s described with reference to FIG. 1. The right multiplication circuit 131(R) may include a plurality of multipliers, for example, ninth to sixteenth multipliers MUL(8)˜MUL(15). The ninth to sixteenth multipliers MUL(8)˜MUL(15) may receive the ninth to sixteenth weight data W9˜W16 from the right memory bank 110(R), respectively. In addition, the ninth to sixteenth multipliers MUL(8)˜MUL(15) may receive the ninth to sixteenth vector data V9˜V16 from the second global buffer (122 of FIG. 1), respectively. The ninth to sixteenth weight data W9˜W16 may constitute the right weight data W(R)s described with reference to FIG. 1, and the ninth to sixteenth vector data V9˜V16 may constitute the right vector data V(R)s described with reference to FIG. 1.

The first to eighth multipliers MUL(0)˜MUL(7) of the left multiplication circuit 131(L) may perform multiplying calculations on the first to eighth weight data W1˜W8 and the first to eighth vector data V1˜V8 to generate first to eighth multiplication result data WV1˜WV8. For example, the first multiplier MUL(0) may perform a multiplying calculation on the first weight data W1 and the first vector data V1 to generate the first multiplication result data WV1, and the second multiplier MUL(1) may perform a multiplying calculation on the second weight data W2 and the second vector data V2 to generate the second multiplication result data WV2. In the same way, the third to eighth multipliers MUL(2)˜MUL(7) may also perform multiplying calculations on the third to eighth weight data W3˜W8 and the third to eighth vector data V3˜V8 to generate the third to eighth multiplication result data WV3˜WV8. The first to eighth multiplication result data WV1˜WV8 outputted from the first to eighth multipliers MUL(0)˜MUL(7) may be transmitted to the integrated adder tree 132.

The ninth to sixteenth multipliers MUL(8)˜MUL(15) of the right multiplication circuit 131(R) may perform multiplying calculations on the ninth to sixteenth weight data W9˜W15 and the ninth to sixteenth vector data V9˜V16 to generate ninth to sixteenth multiplication result data WV9˜WV16. For example, the ninth multiplier MUL(8) may perform a multiplying calculation on the ninth weight data W9 and the ninth vector data V9 to generate the ninth multiplication result data WV9, and the tenth multiplier MUL(9) may perform a multiplying calculation on the tenth weight data W10 and the tenth vector data V10 to generate the tenth multiplication result data WV10. In the same way, the eleventh to sixteenth multipliers MUL(10)˜MUL(15) may also perform multiplying calculations on the eleventh to sixteenth weight data W11˜W16 and the eleventh to sixteenth vector data V11˜V16 to generate the eleventh to sixteenth multiplication result data WV11˜WV16. The ninth to sixteenth multiplication result data WV9˜WV16 outputted from the ninth to sixteenth multipliers MUL(8)˜MUL(15) may be transmitted to the integrated adder tree 132.

The integrated adder tree 312 may perform an adding calculation on the first to eighth multiplication result data WV1˜WV8 outputted from the left multiplication circuit 131(L) and an adding calculation on the ninth to sixteenth multiplication result data WV9˜WV16 outputted from the right multiplication circuit 131(R). The integrated adder tree 312 may output the multiplication/addition result data D_MA as a result of the adding calculations. The integrated adder tree 312 may include a plurality of adders ADDs which are arrayed to have a hierarchical structure such as a tree structure. In the present embodiment, the integrated adder tree 312 may be comprised of a plurality of full-adders and a half-adder. However, the present embodiment is merely an example of the present disclosure. Accordingly, in some other embodiment, the integrated adder tree 312 may be comprised of only a plurality of half-adders. In the present embodiment, four full-adders ADD(11)˜ADD(14) may be disposed in a first stage located at a highest level of the integrated adder tree 312, and four full-adders ADD(21)˜ADD(24) may also be disposed in a second stage located at a second highest level of the integrated adder tree 312. In addition, two full-adders ADD(31) and ADD(32) may be disposed in a third stage located at a third highest level of the integrated adder tree 312, and two full-adders ADD(41) and ADD(42) may also be disposed in a fourth stage located at a fourth highest level of the integrated adder tree 312. Moreover, one full-adder ADD(5) may be disposed in a fifth stage located at a fifth highest level of the integrated adder tree 312, and one full-adder ADD(6) may also be disposed in a sixth stage located at a sixth highest level of the integrated adder tree 312. Furthermore, one half-adder ADD(7) May be disposed in a seventh stage located at a lowest level of the integrated adder tree 312.

The first full-adder ADD(11) in the first stage may perform an adding calculation on the first to third multiplication result data WV1˜WV3 outputted from the first to third multipliers MUL(0)˜MUL(2) of the left multiplication circuit 131(L), thereby generating and outputting added data S11 and a carry C11. The second full-adder ADD(12) in the first stage may perform an adding calculation on the sixth to eighth multiplication result data WV6˜WV8 outputted from the sixth to eighth multipliers MUL(5)˜MUL(7) of the left multiplication circuit 131(L), thereby generating and outputting added data S12 and a carry C12. The third full-adder ADD(13) in the first stage may perform an adding calculation on the ninth to eleventh multiplication result data WV9˜WV11 outputted from the ninth to eleventh multipliers MUL(8)˜MUL(10) of the right multiplication circuit 131(R), thereby generating and outputting added data S13 and a carry C13. The fourth full-adder ADD(14) in the first stage may perform an adding calculation on the fourteenth to sixteenth multiplication result data WV14˜WV16 outputted from the fourteenth to sixteenth multipliers MUL(13)˜MUL(15) of the right multiplication circuit 131(R), thereby generating and outputting added data S14 and a carry C14.

The first full-adder ADD(21) in the second stage may perform an adding calculation on the added data S11 and the carry C11 outputted from the first full-adder ADD(11) in the first stage and the fourth multiplication result data WV4 outputted from the fourth multiplier MUL(3) of the left multiplication circuit 131(L), thereby generating and outputting added data S21 and a carry C21. The second full-adder ADD(22) in the second stage may perform an adding calculation on the added data S12 and the carry C12 outputted from the second full-adder ADD(12) in the first stage and the fifth multiplication result data WV5 outputted from the fifth multiplier MUL(4) of the left multiplication circuit 131(L), thereby generating and outputting added data S22 and a carry C22. The third full-adder ADD(23) in the second stage may perform an adding calculation on the added data S13 and the carry C13 outputted from the third full-adder ADD(13) in the first stage and the twelfth multiplication result data WV12 outputted from the twelfth multiplier MUL(11) of the right multiplication circuit 131(R), thereby generating and outputting added data S23 and a carry C23. The fourth full-adder ADD(24) in the second stage may perform an adding calculation on the added data S14 and the carry C14 outputted from the fourth full-adder ADD(14) in the first stage and the thirteenth multiplication result data WV13 outputted from the thirteenth multiplier MUL(12) of the right multiplication circuit 131(R), thereby generating and outputting added data S24 and a carry C24.

The first full-adder ADD(31) in the third stage may perform an adding calculation on the added data S21 and the carry C21 outputted from the first full-adder ADD(21) in the second stage and the added data S22 outputted from the second full-adder ADD(22) in the second stage, thereby generating and outputting added data S31 and a carry C31. The second full-adder ADD(32) in the third stage may perform an adding calculation on the added data S23 outputted from the third full-adder ADD(23) in the second stage and the added data S24 and the carry C24 outputted from the fourth full-adder ADD(24) in the second stage, thereby generating and outputting added data S32 and a carry C32.

The first full-adder ADD(41) in the fourth stage may perform an adding calculation on the added data S31 and the carry C31 outputted from the first full-adder ADD(31) in the third stage and the carry C(22) outputted from the second full-adder ADD(22) in the second stage, thereby generating and outputting added data S41 and a carry C41. The second full-adder ADD(42) in the fourth stage may perform an adding calculation on the carry (C23) outputted from the third full-adder ADD(23) in the second stage and the added data S32 and the carry C32 outputted from the second full-adder ADD(32) in the third stage, thereby generating and outputting added data S42 and a carry C42.

The full-adder ADD(5) in the fifth stage may perform an adding calculation on the added data S41 and the carry C41 outputted from the first full-adder ADD(41) in the fourth stage and the added data S42 outputted from the second full-adder ADD(42) in the fourth stage, thereby generating and outputting added data S51 and a carry C51. The full-adder ADD(6) in the sixth stage may perform an adding calculation on the added data S51 and the carry C51 outputted from the full-adder ADD(5) in the fifth stage and the carry C42 outputted from the second full-adder ADD(42) in the fourth stage, thereby generating and outputting added data S61 and a carry C61. The half-adder ADD(7) in the seventh stage may perform an adding calculation on the added data S61 and the carry C61 outputted from the full-adder ADD(6) in the sixth stage, thereby generating and outputting the multiplication/addition result data D_MA. The multiplication/addition result data D_MA outputted from the half-adder ADD(7) in the seventh stage may be transmitted to the accumulative addition circuit 140.

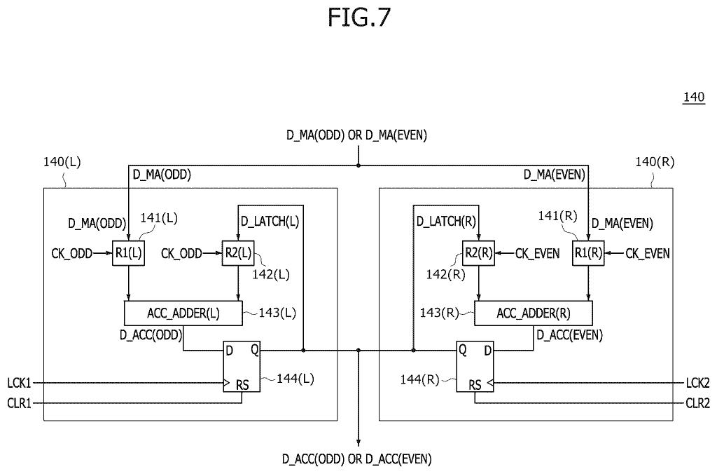

FIG. 7 is a block diagram illustrating an example of configurations and operations of the left accumulator 140(L) and the right accumulator 140(R) constituting the accumulative addition circuit 140 included in the AI accelerator 100 of FIG. 1. Referring to FIG. 7, the left accumulator 140(L) may include a first left register (R1(L)) 141(L), a second left register (R2(L)) 142(L), a left accumulative adder (ACC_ADDER(L)) 143(L), and a left latch circuit 144(L). The first left register 141(L) may receive the odd-numbered multiplication/addition result data D_MA(ODD) from the multiplication circuit/adder tree (130 of FIG. 1). The first left register 141(L) may be synchronized with the odd clock signal CK_ODD outputted from the clock divider (170 of FIG. 1) to transmit the odd-numbered multiplication/addition result data D_MA(ODD) to the left accumulative adder 143(L). The second left register 142(L) may receive left latched data D_LATCH(L) from the left latch circuit 144(L). The left latched data D_LATCH(L) may correspond to the odd-numbered accumulated data D_ACC(ODD) which are transmitted from the left accumulative adder 143(L) to the left latch circuit 144(L) and are latched by the left latch circuit 144(L) during a previous MAC operation. The second left register 142(L) may be synchronized with the odd clock signal CK_ODD outputted from the clock divider (170 of FIG. 1) to transmit the left latched data D_LATCH(L) to the left accumulative adder 143(L). In an embodiment, the second left register 142(L) may include an implied bit datum of “1.” into the left latched data D_LATCH(L) and may transmit the left latched data D_LATCH(L) including the implied bit datum to the left accumulative adder 143(L). In an embodiment, each of the first left register 141(L) and the second left register 142(L) may include at least one flip-flop.

The left accumulative adder 143(L) may perform an adding calculation on the odd-numbered multiplication/addition result data D_MA(ODD) outputted from the first left register 141(L) and the left latched data D_LATCH(L) outputted from the second left register 142(L) to generate the odd-numbered accumulated data D_ACC(ODD). The left accumulative adder 143(L) may transmit the odd-numbered accumulated data D_ACC(ODD) to an input terminal D of the left latch circuit 144(L). The left latch circuit 144(L) may latch the odd-numbered accumulated data D_ACC(ODD), which are inputted through the input terminal D, in response to a first latch clock signal LCK1 having a first logic level (e.g., a logic “high” level) inputted to a clock terminal of the left latch circuit 144(L). In addition, the left latch circuit 144(L) may output the latched data of the odd-numbered accumulated data D_ACC(ODD) through an output terminal Q of the left latch circuit 144(L) in response to the first latch clock signal LCK1 having the first logic level (e.g., a logic “high” level). Output data of the left latch circuit 144(L) may be fed back to the second left register 142(L) and may also be transmitted to the output circuit (150 of FIG. 1). When the left latch circuit 144(L) terminates latch operations of the MAC operations, the left latch circuit 144(L) may be reset in response to a first clear signal CLR1 having a logic “high” level.

The right accumulator 140(R) may include a first right register (R1(R)) 141(R), a second right register (R2(R)) 142(R), a right accumulative adder (ACC_ADDER(R)) 143(R), and a right latch circuit 144(R). The first right register 141(R) may receive the even-numbered multiplication/addition result data D_MA(EVEN) from the multiplication circuit/adder tree (130 of FIG. 1). The first right register 141(R) may be synchronized with the even clock signal CK_EVEN outputted from the clock divider (170 of FIG. 1) to transmit the even-numbered multiplication/addition result data D_MA(EVEN) to the right accumulative adder 143(R). The second right register 142(R) may receive right latched data D_LATCH(R) from the right latch circuit 144(R). The right latched data D_LATCH(R) may correspond to the even-numbered accumulated data D_ACC(EVEN) which are transmitted from the right accumulative adder 143(R) to the right latch circuit 144(R) and are latched by the right latch circuit 144(R) during a previous MAC operation. The second right register 142(R) may be synchronized with the even clock signal CK_EVEN outputted from the clock divider (170 of FIG. 1) to transmit the right latched data D_LATCH(R) to the right accumulative adder 143(R). In an embodiment, the second right register 142(R) may include an implied bit datum of “1.” into the right latched data D_LATCH(R) and may transmit the right latched data D_LATCH(R) including the implied bit datum to the right accumulative adder 143(R). In an embodiment, each of the first right register 141(R) and the second right register 142(R) may include at least one flip-flop.

The right accumulative adder 143(R) may perform an adding calculation on the even-numbered multiplication/addition result data D_MA(EVEN) outputted from the first right register 141(R) and the right latched data D_LATCH(R) outputted from the second right register 142(R) to generate the even-numbered accumulated data D_ACC(EVEN). The right accumulative adder 143(R) may transmit the even-numbered accumulated data D_ACC(EVEN) to an input terminal D of the right latch circuit 144(R). The right latch circuit 144(R) may latch the even-numbered accumulated data D_ACC(EVEN), which are inputted through the input terminal D, in response to a second latch clock signal LCK2 having the first logic level (e.g., a logic “high” level) inputted to a clock terminal of the right latch circuit 144(R). In addition, the right latch circuit 144(R) may output the latched data of the even-numbered accumulated data D_ACC(EVEN) through an output terminal Q of the right latch circuit 144(R) in response to the second latch clock signal LCK2 having the first logic level (e.g., a logic “high” level). Output data of the right latch circuit 144(R) may be fed back to the second right register 142(R) and may also be transmitted to the output circuit (150 of FIG. 1). When the right latch circuit 144(R) terminates latch operations of the MAC operations, the right latch circuit 144(R) may be reset in response to a second clear signal CLR2 having a logic “high” level.

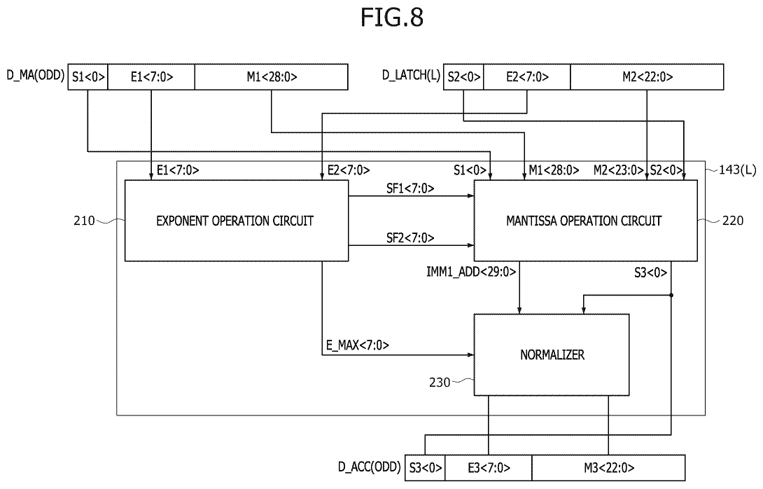

FIG. 8 is a block diagram illustrating an example of a configuration of the left accumulative adder 143(L) included in the left accumulator 140(L) shown in FIG. 7. The following descriptions on the left accumulative adder 143(L) may be equally applied to the right accumulative adder 143(R). In the present embodiment, it may be assumed that each of the first to 512^{th} weight data W1˜W512 and each of the first to 512^{th} vector data V1˜V512 have a 32-bit single-precision floating-point format, as described with reference to FIG. 3. Thus, each of the first to 512^{th} weight data W1˜W512 and each of the first to 512^{th} vector data V1˜V512 may be comprised of a sign datum having one bit, first exponent data having 8 bits, and mantissa data having 23 bits. The number of bits included in the mantissa data may increase during the adding calculation of the integrated adder tree 132 included in the multiplication circuit/adder tree 130. In the present embodiment, it may be assumed that the number of bits included in the mantissa data increases by six bits due to generation of carry bits during the adding calculation of the integrated adder tree 132 included in the multiplication circuit/adder tree 130. Accordingly, the odd-numbered multiplication/addition result data D_MA(ODD) may be comprised of a first sign datum S1<0> having one bit, first exponent data E1<7:0> having 8 bits, and first mantissa data M1<28:0> having 29 bits. Because the left latched data D_LATCH(L) are normalized during a previous additive adding calculation, the left latched data D_LATCH(L) may be comprised of a second sign datum S2<0> having one bit, second exponent data E2<7:0> having 8 bits, and second mantissa data M2<22:0> having 23 bits. An implied bit datum may be included in the second mantissa data M2<22:0> having 23 bits of the left latched data D_LATCH(L) before the second mantissa data M2<22:0> are inputted to the left accumulative adder 143(L). Thus, second mantissa data M2<23:0> having 24 bits may be inputted to the left accumulative adder 143(L).

Referring to FIG. 8, the left accumulative adder 143(L) may include an exponent operation circuit 210, a mantissa operation circuit 220, and a normalizer 230. The exponent operation circuit 210 may receive the first exponent data E1<7:0> of the odd-numbered multiplication/addition result data D_MA(ODD) from the first left register 141(L) and may also receive the second exponent data E2<7:0> of the left latched data D_LATCH(L) from the second left register 142(L). The exponent operation circuit 210 may perform an exponent operation on the first exponent data E1<7:0> and the second exponent data E2<7:0>. The exponent operation circuit 210 may generate and output maximum exponent data E_MAX<7:0>, first shift data SF1<7:0>, and second shift data SF2<7:0> as a result of the exponent operation. The maximum exponent data E_MAX<7:0> may correspond to data having a larger value out of the first shift data SF1<7:0> and the second shift data SF2<7:0>. The first shift data SF1<7:0> may have a first shift value corresponding to the number of bits that the first mantissa data M1<28:0> of the odd-numbered multiplication/addition result data D_MA(ODD) has to be shifted. The second shift data SF2<7:0> may have a second shift value corresponding to the number of bits that the second mantissa data M2<23:0> of the left latched data D_LATCH(L) has to be shifted. The first shift data SF1<7:0> and the second shift data SF2<7:0> outputted from the exponent operation circuit 210 may be transmitted to the mantissa operation circuit 220. The maximum exponent data E_MAX<7:0> outputted from the exponent operation circuit 210 may be transmitted to the normalizer 230.

The mantissa operation circuit 220 may receive the first sign datum S1<0> and the first mantissa data M1<28:0> of the odd-numbered multiplication/addition result data D_MA(ODD) from the first left register 141(L). The mantissa operation circuit 220 may also receive the second sign datum S2<0> and the second mantissa data M2<23:0> of the left latched data D_LATCH(L) from the second left register 142(L). In addition, the mantissa operation circuit 220 may receive the first shift data SF1<7:0> and the second shift data SF2<7:0> from the exponent operation circuit 210. The mantissa operation circuit 220 may perform a mantissa operation on the first mantissa data M1<28:0> and the second mantissa data M2<23:0> to generate a third sign datum S3<0> of the odd-numbered accumulated data D_ACC(ODD) and a first interim mantissa addition data IMM1_ADD<29:0>. The third sign datum S3<0> of the odd-numbered accumulated data D_ACC(ODD) and the first interim mantissa addition data IMM1_ADD<29:0> may be transmitted to the normalizer 230.

The normalizer 230 may receive the third sign datum S3<0> and the first interim mantissa addition data IMM1_ADD<29:0> from the mantissa operation circuit 220. In addition, the normalizer 230 may receive the maximum exponent data E_MAX<7:0> from the exponent operation circuit 210. The normalizer 230 may perform a normalization operation using the maximum exponent data E_MAX<7:0>, the first interim mantissa addition data IMM1_ADD<29:0>, and the third sign datum S3<0> as input data, thereby generating and outputting third exponent data E3<7:0> having 8 bits and third mantissa data M3<22:0> having 23 bits of the odd-numbered accumulated data D_ACC(ODD). The third sign datum S3<0> outputted from the mantissa operation circuit 220 and the third exponent data E3<7:0> and the third mantissa data M3<22:0> outputted from the normalizer 230 may be transmitted to the input terminal D of the left latch circuit 144(L), as described with reference to FIG. 7.

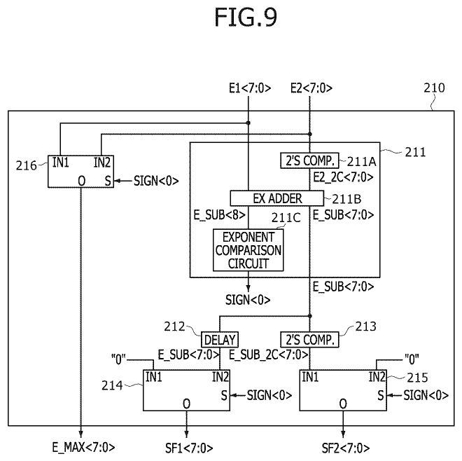

FIG. 9 is a block diagram illustrating an example of a configuration of the exponent operation circuit 210 included in the left accumulative adder 143(L) of FIG. 8. Referring to FIG. 9, the exponent operation circuit 210 may include an exponent subtraction circuit 211, a delay circuit 212, a 2's complement circuit 213, a first selector 214, a second selector 215, and a third selector 216. In an embodiment, each of the first to third selectors 214, 215, and 216 may include a 2-to-1 multiplexer. The exponent subtraction circuit 211 may include a 2's complement processor 211A, an exponent adder 211B, and an exponent comparison circuit 211C. In the present embodiment, the exponent adder 211B may be comprised of an adder for adding integers.

The exponent subtraction circuit 211 may receive the first exponent data E1<7:0> of the odd-numbered multiplication/addition result data D_MA(ODD) and the second exponent data E2<7:0> of the left latched data D_LATCH(L). The exponent subtraction circuit 211 may generate 2's complement data of the second exponent data E2<7:0> in order to perform an arithmetic operation (E1<7:0>-E2<7:0>) for subtracting the second exponent data E2<7:0> from the first exponent data E1<7:0>. Thereafter, the exponent subtraction circuit 211 may add the 2's complement data of the second exponent data E2<7:0> to the first exponent data E1<7:0>. More specifically, the first exponent data E1<7:0> may be transmitted to a first input terminal of the exponent adder 211B, and the second exponent data E2<7:0> may be transmitted to the 2's complement processor 211A. The 2's complement processor 211A may calculate a 2's complement value of the second exponent data E2<7:0> to generate and output 2's complement data E2_2C<7:0> of the second exponent data E2<7:0>. The 2's complement data E2_2C<7:0> of the second exponent data E2<7:0> may be transmitted to a second input terminal of the exponent adder 211B.

The exponent adder 211B may add the 2's complement data E2_2C<7:0> of the second exponent data E2<7:0> to the first exponent data E1<7:0> to generate exponent subtraction data E_SUB<8:0> having 9 bits. The exponent adder 211B may separate the exponent subtraction data E_SUB<8:0> into two parts of a most significant bit (MSB) datum E_SUB<8> and 8-bit low-order data E_SUB<7:0> obtained by removing the MSB datum E_SUB<8> from the exponent subtraction data E_SUB<8:0>. The exponent adder 211B may transmit the MSB datum E_SUB<8> to the exponent comparison circuit 211C and may transmit the 8-bit low-order data E_SUB<7:0> to the delay circuit 212 and the 2's complement circuit 213.

The exponent comparison circuit 211C may compare a value of the first exponent data E1<7:0> with a value of the second exponent data E2<7:0> using the MSB datum E_SUB<8> outputted from the exponent adder 211B and may generate and output a sign signal SIGN<0> as the comparison result. Specifically, when a value of the first exponent data E1<7:0> is greater than a value of the second exponent data E2<7:0>, roundup may occur during the adding calculation of the exponent adder 211B. In such a case, the MSB datum E_SUB<8> may have a binary number of “1”. When the MSB datum E_SUB<8> has a binary number of “1”, the exponent comparison circuit 211C may output the sign signal SIGN<0> having a logic “low” level (e.g., a binary number of “0”) which denotes that the 8-bit low-order data E_SUB<7:0> are a positive number. In such a case, the second mantissa data M2<23:0> may be shifted by the number of bits corresponding to a difference value between absolute values of the first exponent data E1<7:0> and the second exponent data E2<7:0> such that the first exponent data E1<7:0> and the second exponent data E2<7:0> have the same absolute value. In contrast, when a value of the first exponent data E1<7:0> is less than a value of the second exponent data E2<7:0>, no roundup occurs during the adding calculation of the exponent adder 211B. In such a case, the MSB datum E_SUB<8> may have a binary number of “0”. When the MSB datum E_SUB<8> has a binary number of “0”, the exponent comparison circuit 211C may output the sign signal SIGN<0> having a logic “high” level (e.g., a binary number of “1”) which denotes that the 8-bit low-order data E_SUB<7:0> are a negative number. In such a case, the first mantissa data M1<28:0> may be shifted by the number of bits corresponding to a difference value between absolute values of the first exponent data E1<7:0> and the second exponent data E2<7:0> such that the first exponent data E1<7:0> and the second exponent data E2<7:0> have the same absolute value. The sign signal SIGN<0> outputted from the exponent comparison circuit 211C may be transmitted to selection terminals S of the first to third selectors 214, 215, and 216.

The delay circuit 212 may delay the 8-bit low-order data E_SUB<7:0>, which are outputted from the exponent adder 211B of the exponent subtraction circuit 211, by a certain delay time and may output the delayed data of the 8-bit low-order data E_SUB<7:0>. In an embodiment, the certain delay time may correspond to a period it takes the 2's complement circuit 213 to perform an arithmetic operation for calculating the 2's complement data of the 8-bit low-order data E_SUB<7:0>. The 8-bit low-order data E_SUB<7:0> outputted from the delay circuit 212 may be transmitted to a second input terminal IN2 of the first selector 214. The 2's complement circuit 213 may calculate a 2's complement value of the 8-bit low-order data E_SUB<7:0> outputted from the exponent adder 211B, thereby generating and outputting 2's complement data E_SUB_2C<7:0>. The 2's complement data E_SUB_2C<7:0> of the 8-bit low-order data E_SUB<7:0> may have an absolute value of a difference value between the first exponent data E1<7:0> and the second exponent data E2<7:0>. The 2's complement circuit 213 may transmit the 2's complement data E_SUB_2C<7:0> of the 8-bit low-order data E_SUB<7:0> to a first input terminal IN1 of the second selector 215.

The first selector 214 may receive a datum of “0” through a first input terminal IN1 of the first selector 214. In addition, the first selector 214 may receive the 8-bit low-order data E_SUB<7:0> from the delay circuit 212 through the second input terminal IN2 of the first selector 214. The second selector 215 may receive the 2's complement data E_SUB_2C<7:0> from the 2's complement circuit 213 through the first input terminal IN1 of the second selector 215. In addition, the second selector 215 may receive a datum of “0” through a second input terminal IN2 of the second selector 215. Each of the first and second selectors 214 and 215 may output one of two sets of input data according to the sign signal SIGN<0> inputted to the selection terminal S thereof. Hereinafter, data, which are outputted from the first selector 214 through an output terminal O of the first selector 214, will be referred to as the first shift data SF1<7:0>. In addition, data, which are outputted from the second selector 215 through an output terminal O of the second selector 215, will be referred to as the second shift data SF2<7:0>.

When the sign signal SIGN<0> has a datum of “0” (i.e., when the second mantissa data M2<23:0> has to be shifted), each of the first selector 214 and the second selector 215 may selectively output the data inputted through the first input terminal IN1. That is, the first selector 214 may selectively output the datum of “0” as the first shift data SF1<7:0> through the output terminal O of the first selector 214, and the second selector 215 may selectively output the 2's complement data E_SUB_2C<7:0> as the second shift data SF2<7:0> through the output terminal O of the second selector 215. When the sign signal SIGN<0> has a datum of “1” (i.e., when the first mantissa data M1<28:0> has to be shifted), each of the first selector 214 and the second selector 215 may selectively output the data inputted through the second input terminal IN2. That is, the first selector 214 may selectively output the 8-bit low-order data E_SUB<7:0> as the first shift data SF1<7:0> through the output terminal O of the first selector 214, and the second selector 215 may selectively output the datum of “0” as the second shift data SF2<7:0> through the output terminal O of the second selector 215. The first shift data SF1<7:0> and the second shift data SF2<7:0> outputted from respective ones of the first and second selectors 214 and 215 may be transmitted to the mantissa operation circuit 220.

The third selector 216 may receive the first exponent data E1<7:0> of the odd-numbered multiplication/addition result data D_MA(ODD) through a first input terminal IN1 of the third selector 216 and may also receive the second exponent data E2<7:0> of the left latched data D_LATCH(L) through a second input terminal IN2 of the third selector 216. The third selector 216 may selectively output one set of data having a larger value out of the first exponent data E1<7:0> and the second exponent data E2<7:0> through an output terminal O of the third selector 216 according to the sign signal SIGN<0> inputted through a selection terminal S of the third selector 216. Hereinafter, data, which are outputted from the third selector 216 through the output terminal O of the third selector 216, will be referred to as the maximum exponent data E_MAX<7:0>. When the sign signal SIGN<0> has a datum of “0” which denotes a positive number, it may correspond to a case that a value of the first exponent data E1<7:0> is greater than a value of the second exponent data E2<7:0>. In such a case, the third selector 216 may output the first exponent data E1<7:0> as the maximum exponent data E_MAX<7:0>. In contrast, when the sign signal SIGN<0> has a datum of “1” which denotes a negative number, it may correspond to a case that a value of the second exponent data E2<7:0> is greater than a value of the first exponent data E1<7:0>. In such a case, the third selector 216 may output the second exponent data E2<7:0> as the maximum exponent data E_MAX<7:0>. The third selector 216 may transmit the maximum exponent data E_MAX<7:0> to the normalizer 230.

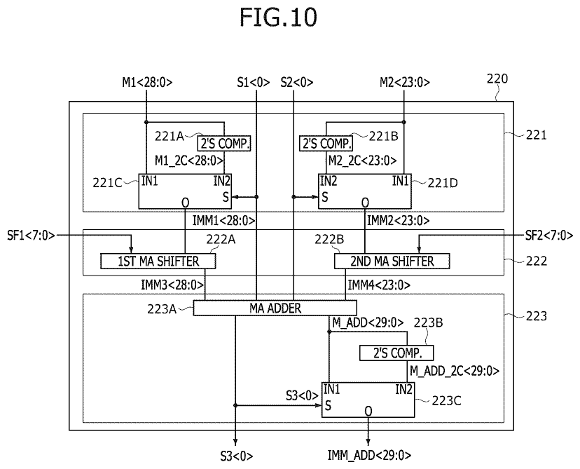

FIG. 10 is a block diagram illustrating an example of a configuration of the mantissa operation circuit 220 included in the left accumulative adder 143(L) of FIG. 8. Referring to FIG. 10, the mantissa operation circuit 220 may include a negative number processing circuit 221, a mantissa shift circuit 222, and a mantissa addition circuit 223. The negative number processing circuit 221 may include a first 2's complement circuit 221A, a second 2's complement circuit 221B, a first selector 221C, and a second selector 221D. The mantissa shift circuit 222 may include a first mantissa shifter 222A and a second mantissa shifter 222B. The mantissa addition circuit 223 may include a mantissa adder 223A, a third 2's complement circuit 223B, and a third selector 223C.

The first 2's complement circuit 221A of the negative number processing circuit 221 may receive the first mantissa data M1<28:0> of the odd-numbered multiplication/addition result data D_MA(ODD). The first 2's complement circuit 221A may calculate a 2's complement value of the first mantissa data M1<28:0> to generate and output 2's complement data M1_2C<28:0> of the first mantissa data M1<28:0>. The first selector 221C may receive the first mantissa data M1<28:0> of the odd-numbered multiplication/addition result data D_MA(ODD) through a first input terminal IN1 of the first selector 221C. The first selector 221C may also receive the 2's complement data M1_2C<28:0> from the first 2's complement circuit 221A through a second input terminal IN2 of the first selector 221C. In addition, the first selector 221C may receive the first sign datum S1<0> of the odd-numbered multiplication/addition result data D_MA(ODD) through a selection terminal S of the first selector 221C. When the first sign datum S1<0> has a binary number of “0” denoting a positive number, the first selector 221C may output the first mantissa data M1<28:0> inputted through the first input terminal IN1 through the output terminal O of the first selector 221C. In contrast, when the first sign datum S1<0> has a binary number of “1” denoting a negative number, the first selector 221C may output the 2's complement data M1_2C<28:0> inputted through the second input terminal IN2 through the output terminal O of the first selector 221C. Hereinafter, the output data of the first selector 221C will be referred to as first interim mantissa data IMM1<28:0>.

The second 2's complement circuit 221B of the negative number processing circuit 221 may receive the second mantissa data M2<23:0> of the left latched data D_LATCH(L). The second 2's complement circuit 221B may calculate a 2's complement value of the second mantissa data M2<23:0> to generate and output 2's complement data M2_2C<23:0> of the second mantissa data M2<23:0>. The second selector 221D may receive the second mantissa data M2<23:0> of the second mantissa data M2<23:0> of the left latched data D_LATCH(L) through a first input terminal IN1 of the second selector 221D. The first selector 221C may also receive) the 2's complement data M2_2C<23:0> from the second 2's complement circuit 221B through a second input terminal IN2 of the second selector 221D. In addition, the second selector 221D may receive the second sign datum S2<0> of the left latched data D_LATCH(L) through a selection terminal S of the second selector 221D. When the second sign datum S2<0> has a binary number of “O” denoting a positive number, the second selector 221D may output the second mantissa data M2<23:0> inputted through the first input terminal IN1 through the output terminal O of the second selector 221D. In contrast, when the second sign datum S2<0> has a binary number of “1” denoting a negative number, the second selector 221D may output the 2's complement data M2_2C<23:0> inputted through the second input terminal IN2 through the output terminal O of the second selector 221D. Hereinafter, the output data of the second selector 221D will be referred to as second interim mantissa data IMM2<23:0>.

The first mantissa shifter 222A of the mantissa shift circuit 222 may receive the first interim mantissa data IMM1<28:0> from the first selector 221C of the negative number processing circuit 221. In addition, the first mantissa shifter 222A may receive the first shift data SF1<7:0> from the first selector 214 of the exponent operation circuit 210. The first mantissa shifter 222A may shift the first interim mantissa data IMM1<28:0> by the number of bits corresponding to an absolute value of the first shift data SF1<7:0> to output the shifted data of the first interim mantissa data IMM1<28:0>. Hereinafter, the output data of the first mantissa shifter 222A will be referred to as third interim mantissa data IMM3<28:0>. When the first shift data SF1<7:0> have a value of “0”, the third interim mantissa data IMM3<28:0> may be equal to the first interim mantissa data IMM1<28:0>. In contrast, when the first shift data SF1<7:0> are the 8-bit low-order data E_SUB<7:0> of the exponent subtraction data E_SUB<8:0>, the third interim mantissa data IMM3<28:0> may be generated by shifting the first interim mantissa data IMM1<28:0> by the number of bits corresponding to an absolute value of the 8-bit low-order data E_SUB<7:0> of the exponent subtraction data E_SUB<8:0>. The third interim mantissa data IMM3<28:0> outputted from the first mantissa shifter 222A may be transmitted to the mantissa addition circuit 223.

The second mantissa shifter 222B of the mantissa shift circuit 222 may receive the second interim mantissa data IMM2<23:0> from the second selector 221D of the negative number processing circuit 221. In addition, the second mantissa shifter 222B may receive the second shift data SF2<7:0> from the second selector 215 of the exponent operation circuit 210. The second mantissa shifter 222B may shift the second interim mantissa data IMM2<23:0> by the number of bits corresponding to an absolute value of the second shift data SF2<7:0> to output the shifted data of the second interim mantissa data IMM2<23:0>. Hereinafter, the output data of the second mantissa shifter 222B will be referred to as fourth interim mantissa data IMM4<23:0>. When the second shift data SF2<7:0> have a value of “0”, the fourth interim mantissa data IMM4<23:0> may be equal to the second interim mantissa data IMM2<23:0>. In contrast, when the second shift data SF2<7:0> are the 2's complement data E_SUB_2C<7:0> of the 8-bit low-order data E_SUB<7:0>, the fourth interim mantissa data IMM4<23:0> may be generated by shifting the second interim mantissa data IMM2<23:0> by the number of bits corresponding to an absolute value of the 2's complement data E_SUB_2C<7:0> of the 8-bit low-order data E_SUB<7:0>. The fourth interim mantissa data IMM4<23:0> outputted from the second mantissa shifter 222B may be transmitted to the mantissa addition circuit 223.

The mantissa adder 223A of the mantissa addition circuit 223 may receive the third interim mantissa data IMM3<28:0> from the first mantissa shifter 222A of the mantissa shift circuit 222 and may also receive the fourth interim mantissa data IMM4<23:0> from the second mantissa shifter 222B of the mantissa shift circuit 222. In addition, the mantissa adder 223A may receive the first sign datum S1<0> and the second sign datum S2<0>. The mantissa adder 223A may generate and output a third sign datum S3<0>. In addition, the mantissa adder 223A may add the third interim mantissa data IMM3<28:0> to the fourth interim mantissa data IMM4<23:0> to generate and output mantissa addition data M_ADD<29:0>. When both of the first sign datum S1<0> and the second sign datum S2<0> have a binary number of “0” denoting a positive number, the mantissa adder 223A may output a binary number of “0” as the third sign datum S3<0>. When both of the first sign datum S1<0> and the second sign datum S2<0> have a binary number of “1” denoting a negative number, the mantissa adder 223A may output a binary number of “1” as the third sign datum S3<0>. When one of the first and second sign data S1<0> and S2<0> has a binary number of “0” and the other has a binary number of “1”, the mantissa adder 223A may output a binary number of “0” as the third sign datum S3<0> if roundup occurs during the adding calculation on the third and fourth interim mantissa data IMM3<28:0> and IMM4<23:0> and may output a binary number of “1” as the third sign datum S3<0> if no roundup occurs during the adding calculation on the third and fourth interim mantissa data IMM3<28:0> and IMM4<23:0>. The third sign datum S3<0> outputted from the mantissa adder 223A may correspond to a sign datum of the odd-numbered accumulated data D_ACC(ODD). The third sign datum S3<0> outputted from the mantissa adder 223A may also be transmitted to a selection terminal S of the third selector 223C. The mantissa addition data M_ADD<29:0> outputted from the mantissa adder 223A may be transmitted to the third 2's complement circuit 223B and the third selector 223C.

The third 2's complement circuit 223B of the mantissa addition circuit 223 may receive the mantissa addition data M_ADD<29:0> from the mantissa adder 223A. The third 2's complement circuit 223B may calculate a 2's complement value of the mantissa addition data M_ADD<29:0> to generate and output 2's complement data M_ADD_2C<29:0> of the mantissa addition data M_ADD<29:0>. The third selector 223C may receive the mantissa addition data M_ADD<29:0> from the mantissa adder 223A through a first input terminal IN1 of the third selector 223C and may also receive the 2's complement data M_ADD_2C<29:0> from the third 2's complement circuit 223B through a second input terminal IN2 of the third selector 223C. In addition, the third selector 223C may receive the third sign datum S3<0> from the mantissa adder 223A through a selection terminal S of the third selector 223C. When the third sign datum S3<0> has a binary number of “0” denoting a positive number, the third selector 223C may output the mantissa addition data M_ADD<29:0> through an output terminal O of the third selector 223C. In contrast, when the third sign datum S3<0> has a binary number of “1” denoting a negative number, the third selector 223C may output the 2's complement data M_ADD_2C<29:0> through the output terminal O of the third selector 223C. hereinafter, the output data of the third selector 223C will be referred to as interim mantissa addition data IMM_ADD<29:0>.

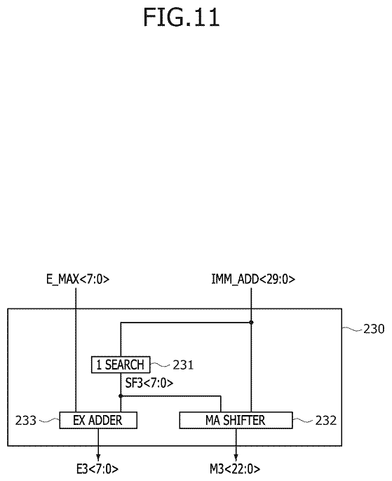

FIG. 11 is a block diagram illustrating an example of a configuration of the normalizer 230 included in the left accumulative adder 143(L) of FIG. 8. Referring to FIG. 11, the normalizer 230 may include a “1” search circuit 231, a mantissa shifter 232, and an exponent adder 233. The “1” search circuit 231 of the normalizer 230 may receive the interim mantissa addition data IMM_ADD<29:0> from the third selector (223C of FIG. 10) of the mantissa addition circuit (223 of FIG. 10). The “1” search circuit 231 may search a position where a binary number of “1” is first located in a right direction from a leftmost bit of the interim mantissa addition data IMM_ADD<29:0> and may generate third shift data SF3<7:0> as the search result. The third shift data SF3<7:0> may have a value corresponding to the number of bits for shifting the interim mantissa addition data IMM_ADD<29:0> such that the interim mantissa addition data IMM_ADD<29:0> have a standard form of “1.mantissa”. In an embodiment, the number of bits included in the third shift data may be arbitrarily set. In the present embodiment, it may be assumed that the third shift data SF3<7:0> are set to have 8 bits. The third shift data SF3<7:0> outputted from the “1” search circuit 231 may be transmitted to the mantissa shifter 232 and the exponent adder 233.

The mantissa shifter 232 of the normalizer 230 may perform a shifting operation on the interim mantissa addition data IMM_ADD<29:0> such that the interim mantissa addition data IMM_ADD<29:0> have a standard form of “1.mantissa”. The mantissa shifter 232 may receive the third shift data SF3<7:0> from the “1” search circuit 231 and may also receive the interim mantissa addition data IMM_ADD<29:0> from the third selector (223C of FIG. 10) of the mantissa addition circuit (223 of FIG. 10). The mantissa shifter 232 may shift the interim mantissa addition data IMM_ADD<29:0> by the number of bits corresponding to a value of the third shift data SF3<7:0>, thereby generating the third mantissa data M3<22:0> of the odd-numbered accumulated data D_ACC(ODD) outputted from the left accumulative adder 143(L). Although not illustrated in FIG. 11, a rounding process may be performed during the shifting operation of the mantissa shifter 232.

The exponent adder 233 of the normalizer 230 may change a value of the maximum exponent data E_MAX<7:0> to compensate for variation of the interim mantissa addition data IMM_ADD<29:0> which is due to the shifting operation for shifting the interim mantissa addition data IMM_ADD<29:0> by the number of bits corresponding to a value of the third shift data SF3<7:0>. The exponent adder 233 may receive the maximum exponent data E_MAX<7:0> from the third selector (216 of FIG. 9) of the exponent operation circuit (210 of FIG. 9) and may also receive the third shift data SF3<7:0> from the “1” search circuit 231. The exponent adder 233 may perform an adding calculation on the maximum exponent data E_MAX<7:0> and the third shift data SF3<7:0> to generate the third exponent data E3<7:0> of the odd-numbered accumulated data D_ACC(ODD) outputted from the left accumulative adder 143(L).

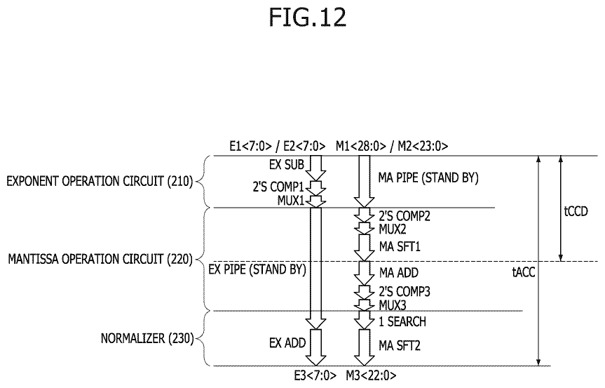

FIG. 12 illustrates an operation of processing the exponent data and the mantissa data during an accumulative adding calculation of the left accumulative adder 143(L) described with reference to FIGS. 8 to 11. Referring to FIGS. 8 to 11 and 12, the exponent operation circuit 210 may sequentially perform an exponent subtraction operation EX_SUB on the first exponent data E1<7:0> and the second exponent data E2<7:0>, a first 2's complement calculation operation 2'S_COMP1, and a first selection operation MUX1. As described with reference to FIG. 9, the exponent subtraction operation EX_SUB may correspond to an operation which is performed by the exponent subtraction circuit 211 to generate the sign signal SIGN<0> and the 8-bit low-order data E_SUB<7:0> of the exponent subtraction data E_SUB<8:0>. The first 2's complement calculation operation 2'S_COMP1 may correspond to an operation which is performed by the 2's complement circuit 213 calculating a 2's complement value of the 8-bit low-order data E_SUB<7:0> to generate the 2's complement data E_SUB_2C<7:0>. The first selection operation MUX1 may correspond to an operation which is performed by the first and second selectors 214 and 215 to generate the first shift data SF1<7:0> and the second shift data SF2<7:0>. While the operations of the exponent operation circuit 210 are performed, the first mantissa data M1<28:0> and the second mantissa data M2<23:0> may be on standby in a mantissa pipe MA_PIPE.

After all of the operations of the exponent operation circuit 210 terminate, the mantissa operation circuit 220 may sequentially perform a second 2's complement calculation operation 2'S_COMP2 on the first mantissa data M1<28:0> and the second mantissa data M2<23:0>, a second selection operation MUX2, a first mantissa shift operation MA_SFT1, a mantissa addition operation MA_ADD, a third 2's complement calculation operation 2'S_COMP3, and a third selection operation MUX3. As described with reference to FIG. 10, the second 2's complement calculation operation 2'S_COMP2 may correspond to an operation which is performed by the first and second 2's complement circuits 221A and 221B of the negative number processing circuit 221 to generate the 2's complement data M1_2C<28:0> of the first mantissa data M1<28:0> and the 2's complement data M2_2C<23:0> of the second mantissa data M2<23:0>. The second selection operation MUX2 may correspond to an operation which is performed by the first and second selectors 221C and 221D of the negative number processing circuit 221 to generate the first interim mantissa data IMM1<28:0> and the second interim mantissa data IMM2<23:0>. The first mantissa shift operation MA_SFT1 may correspond to an operation which is performed by the first and second mantissa shifters 222A and 222B of the mantissa shift circuit 222 to generate the third interim mantissa data IMM3<28:0> and the fourth interim mantissa data IMM4<23:0>. The mantissa addition operation MA_ADD may correspond to an operation which is performed by the mantissa adder 223A of the mantissa addition circuit 223 to generate the third sign datum S3<0> and the mantissa addition data M_ADD<29:0>. The third 2's complement calculation operation 2'S_COMP3 may correspond to an operation which is performed by the third 2's complement circuit 223B of the mantissa addition circuit 223 to generate the 2's complement data M_ADD_2C<29:0> of the mantissa addition data M_ADD<29:0>. The third selection operation MUX3 may correspond to an operation which is performed by the third selector 223C of the mantissa addition circuit 223 to generate the interim mantissa addition data IMM_ADD<29:0>. While the operations of the mantissa operation circuit 220 are performed, no exponent processing operation is performed and the maximum exponent data E_MAX<7:0> generated by the exponent operation circuit (210 of FIG. 8) may be on standby in an exponent pipe EX_PIPE.

After all of the operations of the mantissa operation circuit 220 terminate, the normalizer 230 may sequentially perform a “1” searching operation 1_SEARCH, an exponent addition operation EX_ADD, and a second mantissa shift operation MA_SFT2. As described with reference to FIG. 11, the “1” searching operation 1_SEARCH may correspond to an operation which is performed by the “1” search circuit 231 of the normalizer 230 to generate the third shift data SF3<7:0>. The exponent addition operation EX_ADD may correspond to an operation which is performed by the exponent adder 233 of the normalizer 230 to generate the third exponent data E3<7:0> of the odd-numbered accumulated data D_ACC(ODD). The second mantissa shift operation MA_SFT2 may correspond to an operation which is performed by the mantissa shifter 232 of the normalizer 230 to generate the third mantissa data M3<22:0> of the odd-numbered accumulated data D_ACC(ODD). The exponent addition operation EX_ADD and the second mantissa shift operation MA_SFT2 may be performed independently. Meanwhile, the maximum exponent data E_MAX<7:0> generated by the exponent operation circuit (210 of FIG. 8) may be on standby in the exponent pipe EX_PIPE until the “1” searching operation 1_SEARCH terminates.

As described above, while the exponent data are processed by the exponent operation circuit 210, the mantissa data may be on standby. In contrast, while the mantissa data are processed by the mantissa operation circuit 220, the exponent data may be on standby. The exponent data may be on standby until the normalizer 230 terminates the “1” searching operation 1_SEARCH. The exponent addition operation EX_ADD and the second mantissa shift operation MA_SFT2 may be performed independently. A time (i.e., an accumulative addition time “tACC”) it takes the left accumulative adder (143(L) of FIG. 7) of the left accumulator (140(L) of FIG. 7) to generate and output the odd-numbered accumulated data D_ACC(ODD) using the odd-numbered multiplication/addition result data D_MA(ODD) and the left latched data D_LATCH(L) as input data may correspond to a time it takes to perform all of the operations of the exponent operation circuit 210, the mantissa operation circuit 220, and the normalizer 230. That is, after the accumulative addition time “tACC” elapses from a point in time when the odd-numbered multiplication/addition result data D_MA(ODD) and the left latched data D_LATCH(L) are inputted to the left accumulative adder 143(L), the odd-numbered accumulated data D_ACC(ODD) may be outputted from the left accumulative adder 143(L). The odd-numbered accumulated data D_ACC(ODD) may be used as the left latched data D_LATCH(L) which are accumulatively added to the odd-numbered multiplication/addition result data D_MA(ODD) inputted to the left accumulative adder 143(L) in a next step. This means that the left latched data D_LATCH(L) are able to be inputted to the left accumulative adder 143(L) at an interval time of the accumulative addition time “tACC”. In contrast, the odd-numbered multiplication/addition result data D_MA(ODD) may be inputted to the left accumulative adder 143(L) at an interval time of the CAS to CAS delay time “tCCD”. That is, in the event that the odd-numbered multiplication/addition result data D_MA(ODD) are inputted to the left accumulative adder 143(L) at an interval time of the CAS to CAS delay time “tCCD”, the left latched data D_LATCH(L) cannot be inputted to the left accumulative adder 143(L) with the odd-numbered multiplication/addition result data D_MA(ODD) due to a previous accumulative adding calculation which has not terminated yet. Thus, the AI accelerator 100 according to the present embodiment may be configured such that each of the left accumulative adder 143(L) and the right accumulative adder 143(R) receives the multiplication/addition result data at an interval time of twice the CAS to CAS delay time “tCCD”. In such a case, if the accumulative addition time “tACC” is not longer than twice the CAS to CAS delay time “tCCD”, the multiplication/addition result data and the latched data may be inputted to each of the left accumulative adder 143(L) and the right accumulative adder 143(R) together.

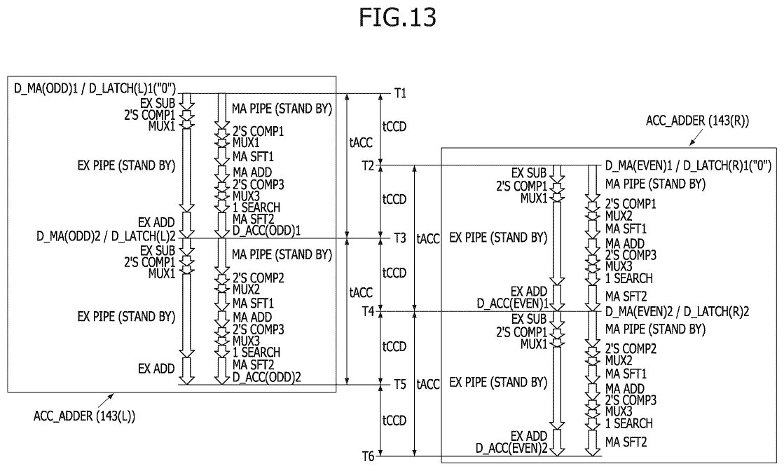

FIG. 13 illustrates operation timings of the left accumulative adder 143(L) and the right accumulative adder 143(R) shown in FIG. 7. In the present embodiment, it may be assumed that the accumulative addition time “tACC” is set to be twice the CAS to CAS delay time “tCCD” (i.e., “2×tCCD”) which corresponds to a maximum value. Referring to FIGS. 7 and 13, the left accumulative adder 143(L) may receive first odd-numbered multiplication/addition result data D_MA(ODD) 1 and first left latched data D_LATCH(L) 1 at a first point in time “T1”. The first odd-numbered multiplication/addition result data D_MA(ODD) 1 may correspond to first multiplication/addition result data outputted from the multiplication circuit/adder tree (130 of FIG. 1). The first point in time “T1” may be a moment when a first pulse of the odd clock signal CK_ODD occurs, as described with reference to FIG. 2. The left latch circuit 144(L) may have a reset state at the first point in time “T1” because the present accumulative adding calculation is a first accumulative adding calculation of the left accumulator 140(L). Thus, the first left latched data D_LATCH(L) 1 having a reset value of “0” may be inputted to the left accumulative adder 143(L). At the first point in time “T1”, the left accumulative adder 143(L) may commence to perform an accumulative adding calculation on the first odd-numbered multiplication/addition result data D_MA(ODD) 1 and the first left latched data D_LATCH(L) 1. At a third point in time “T3” when the accumulative addition time “tACC” (i.e., “2×tCCD”) elapses from the first point in time “T1”, the left accumulative adder 143(L) may output first odd-numbered accumulated data D_ACC(ODD) 1. The first odd-numbered accumulated data D_ACC(ODD) 1 may be used as second left latched data D_LATCH(L) 2 during a next accumulative adding calculation of the left accumulative adder 143(L).

At a second point in time “T2” when the CAS to CAS delay time “tCCD” elapses from the first point in time “T1”, the right accumulative adder 143(R) may receive first even-numbered multiplication/addition result data D_MA(EVEN) 1 and first right latched data D_LATCH(R) 1. The first even-numbered multiplication/addition result data D_MA(EVEN) 1 may correspond to second multiplication/addition result data outputted from the multiplication circuit/adder tree (130 of FIG. 1). The second point in time “T2” may be a moment when a first pulse of the even clock signal CK_EVEN occurs, as described with reference to FIG. 2. The right latch circuit 144(R) may have a reset state at the second point in time “T2” because the present accumulative adding calculation is a first accumulative adding calculation of the right accumulator 140(R). Thus, the first right latched data D_LATCH(R) 1 having a reset value of “0” may be inputted to the right accumulative adder 143(R). At the second point in time “T2”, the right accumulative adder 143(R) may commence to perform an accumulative adding calculation on the first even-numbered multiplication/addition result data D_MA(EVEN) 1 and the first right latched data D_LATCH(R) 1. At a fourth point in time “T4” when the accumulative addition time “tACC” (i.e., “2×tCCD”) elapses from the second point in time “T2”, the right accumulative adder 143(R) may output first even-numbered accumulated data D_ACC(EVEN) 1. The first even-numbered accumulated data D_ACC(EVEN) 1 may be used as second right latched data D_LATCH(R) 2 during a next accumulative adding calculation of the right accumulative adder 143(R).

At the third point in time “T3” when the CAS to CAS delay time “tCCD” elapses from the second point in time “T2”, the left accumulative adder 143(L) may receive second odd-numbered multiplication/addition result data D_MA(ODD) 2 and the second left latched data D_LATCH(L) 2. The second odd-numbered multiplication/addition result data D_MA(ODD) 2 may correspond to third multiplication/addition result data outputted from the multiplication circuit/adder tree (130 of FIG. 1). The third point in time “T3” may be a moment when a second pulse of the odd clock signal CK_ODD occurs, as described with reference to FIG. 2. Because the first odd-numbered accumulated data D_ACC(ODD) 1 are latched in the left latch circuit 144(L) by a previous step, the first odd-numbered accumulated data D_ACC(ODD) 1 corresponding to the second left latched data D_LATCH(L) 2 may be inputted to the left accumulative adder 143(L). At the third point in time “T3”, the left accumulative adder 143(L) may commence to perform an accumulative adding calculation on the second odd-numbered multiplication/addition result data D_MA(ODD) 2 and the second left latched data D_LATCH(L) 2. At a fifth point in time “T5” when the accumulative addition time “tACC” (i.e., “2×tCCD”) elapses from the third point in time “T3”, the left accumulative adder 143(L) may output second odd-numbered accumulated data D_ACC(ODD) 2. The second odd-numbered accumulated data D_ACC(ODD) 2 may be used as third left latched data (not shown) during a next accumulative adding calculation of the left accumulative adder 143(L).

At the fourth point in time “T4” when the CAS to CAS delay time “tCCD” elapses from the third point in time “T3”, the right accumulative adder 143(R) may receive second even-numbered multiplication/addition result data D_MA(EVEN) 2 and the second right latched data D_LATCH(R) 2. The second even-numbered multiplication/addition result data D_MA(EVEN) 2 may correspond to fourth multiplication/addition result data outputted from the multiplication circuit/adder tree (130 of FIG. 1). The fourth point in time “T4” may be a moment when a second pulse of the even clock signal CK_EVEN occurs, as described with reference to FIG. 2. Because the first even-numbered accumulated data D_ACC(EVEN) 1 are latched in the right latch circuit 144(R) by a previous step, the first even-numbered accumulated data D_ACC(EVEN) 1 corresponding to the second right latched data D_LATCH(R) 2 may be inputted to the right accumulative adder 143(R). At the fourth point in time “T4”, the right accumulative adder 143(R) may commence to perform an accumulative adding calculation on the second even-numbered multiplication/addition result data D_MA(EVEN) 2 and the second right latched data D_LATCH(R) 2. At a sixth point in time “T6” when the accumulative addition time “tACC” (i.e., “2×tCCD”) elapses from the fourth point in time “T4”, the right accumulative adder 143(R) may output second even-numbered accumulated data D_ACC(EVEN) 2. The second even-numbered accumulated data D_ACC(EVEN) 2 may be used as third right latched data (not shown) during a next accumulative adding calculation of the right accumulative adder 143(R).

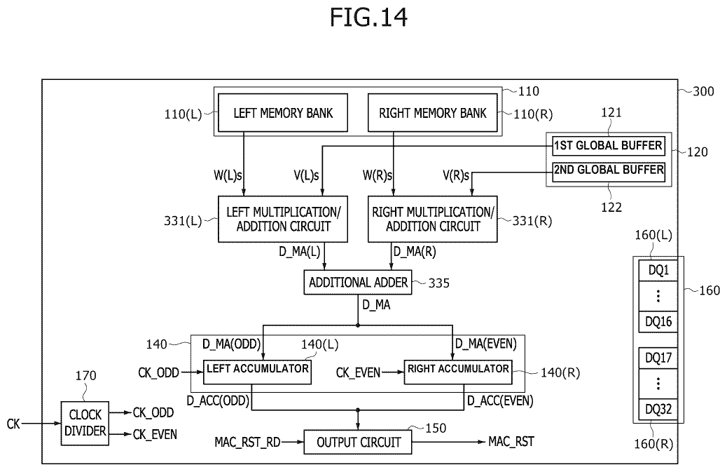

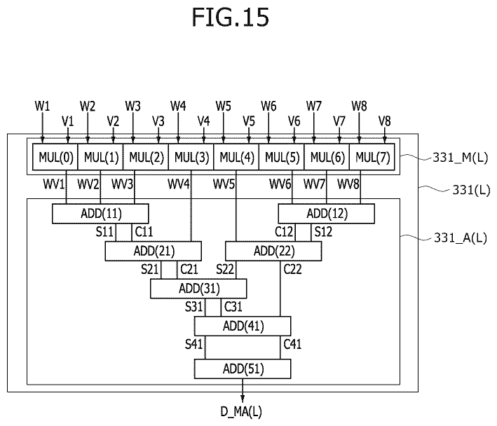

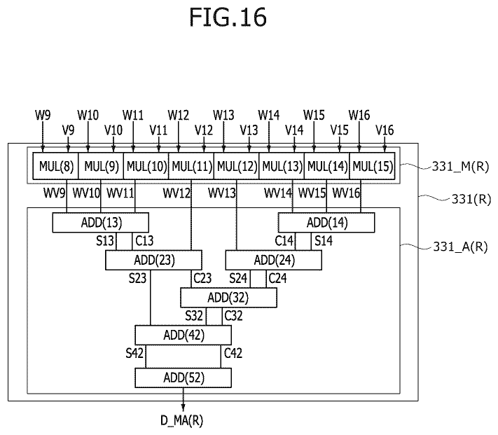

FIG. 14 is a block diagram illustrating an AI accelerator 300 according to another embodiment of the present disclosure. FIGS. 15 and 16 are block diagrams illustrating configurations of a left multiplication/addition circuit 331(L) and a right multiplication/addition circuit 331(R) included in the AI accelerator 300 of FIG. 14, respectively. In FIG. 14, the same reference numerals or symbols as used in FIG. 1 may denote the same elements. Thus, descriptions of the same elements as set forth in the embodiment of FIG. 1 will be omitted in the present embodiment. First, referring to FIG. 14, the AI accelerator 300 may include the first memory circuit 110, the second memory circuit 120, the left multiplication/addition circuit 331(L), the right multiplication/addition circuit 331(R), an additional adder 335, the accumulative addition circuit 140, the output circuit 150, the data I/O circuit 160, and the clock divider 170. The AI accelerator 300 may be different from the AI accelerator 100 described with reference to FIG. 1 in terms of a point that the AI accelerator 300 includes the left multiplication/addition circuit 331(L), the right multiplication/addition circuit 331(R), and the additional adder 335.

Specifically, the left multiplication/addition circuit 331(L) may include a left multiplication circuit 331_M(L) and a left adder tree 331_A(L), as illustrated in FIG. 15. The left multiplication circuit 331_M(L) may include a plurality of multipliers, for example, first to eighth multipliers MUL(0)˜MUL(7). The first to eighth multipliers MUL(0)˜MUL(7) may receive first to eighth weight data W1˜W8 from a left memory bank 110(L) of the first memory circuit 110, respectively. In addition, the first to eighth multipliers MUL(0)˜MUL(7) may receive first to eighth vector data V1˜V8 from a first global buffer 121 of the second memory circuit 120, respectively. The first to eighth weight data W1˜W8 may constitute the left weight data W(L)s described with reference to FIG. 1, and the first to eighth vector data V1˜V8 may constitute the left vector data V(L)s described with reference to FIG. 1. The first to eighth multipliers MUL(0)˜MUL(7) may perform multiplying calculations on the first to eighth weight data W1˜W8 and the first to eighth vector data V1˜V8 to generate first to eighth multiplication result data WV1˜WV8, respectively. The first to eighth multiplication result data WV1˜WV8 may be transmitted to the left adder tree 331_A(L).

The left adder tree 331_A(L) may perform an adding calculation on the first to eighth multiplication result data WV1˜WV8 outputted from the left multiplication circuit 331_M(L). The left adder tree 331_A(L) may generate and output left multiplication/addition result data D_MA(L) as a result of the adding calculation. The left adder tree 331_A(L) may include a plurality of adders ADDs which are arrayed to have a hierarchical structure such as a tree structure. In the present embodiment, the left adder tree 331_A(L) may be comprised of a plurality of full-adders and a half-adder. However, the present embodiment is merely an example of the present disclosure. Accordingly, in some other embodiment, the left adder tree 331_A(L) may be comprised of only a plurality of half-adders. In the present embodiment, two full-adders ADD(11) and ADD(12) may be disposed in a first stage located at a highest level of the left adder tree 331_A(L), and two full-adders ADD(21) and ADD(22) may also be disposed in a second stage located at a second highest level of the left adder tree 331_A(L). In addition, one full-adder ADD(31) may be disposed in a third stage located at a third highest level of the left adder tree 331_A(L), and one full-adder ADD(41) may also be disposed in a fourth stage located at a fourth highest level of the left adder tree 331_A(L). Moreover, one half-adder ADD(51) may be disposed in a fifth stage located at a lowest level of the left adder tree 331_A(L).

The first full-adder ADD(11) in the first stage may perform an adding calculation on the first to third multiplication result data WV1˜WV3 outputted from the first to third multipliers MUL(0)˜MUL(2) of the left multiplication circuit 331_M(L), thereby generating and outputting added data S11 and a carry C11. The second full-adder ADD(12) in the first stage may perform an adding calculation on the sixth to eighth multiplication result data WV6˜WV8 outputted from the sixth to eighth multipliers MUL(5)˜MUL(7) of the left multiplication circuit 331_M(L), thereby generating and outputting added data S12 and a carry C12. The first full-adder ADD(21) in the second stage may perform an adding calculation on the added data S11 and the carry C11 outputted from the first full-adder ADD(11) in the first stage and the fourth multiplication result data WV4 outputted from the fourth multiplier MUL(3) of the left multiplication circuit 331_M(L), thereby generating and outputting added data S21 and a carry C21. The second full-adder ADD(22) in the second stage may perform an adding calculation on the added data S12 and the carry C12 outputted from the second full-adder ADD(12) in the first stage and the fifth multiplication result data WV5 outputted from the fifth multiplier MUL(4) of the left multiplication circuit 331_M(L), thereby generating and outputting added data S22 and a carry C22.

The full-adder ADD(31) in the third stage may perform an adding calculation on the added data S21 and the carry C21 outputted from the first full-adder ADD(21) in the second stage and the added data S22 outputted from the second full-adder ADD(22) in the second stage, thereby generating and outputting added data S31 and a carry C31. The full-adder ADD(41) in the fourth stage may perform an adding calculation on the added data S31 and the carry C31 outputted from the full-adder ADD(31) in the third stage and the carry C(22) outputted from the second full-adder ADD(22) in the second stage, thereby generating and outputting added data S41 and a carry C41. The half-adder ADD(51) in the fifth stage may perform an adding calculation on the added data S41 and the carry C41 outputted from the full-adder ADD(41) in the fourth stage, thereby generating and outputting the left multiplication/addition result data D_MA(L). The left multiplication/addition result data D_MA(L) outputted from the half-adder ADD(51) in the fifth stage of the left multiplication circuit 331_M(L) may be transmitted to the additional adder 335.

The right multiplication/addition circuit 331(R) may include a right multiplication circuit 331_M(R) and a right adder tree 331_A(R), as illustrated in FIG. 16. The right multiplication circuit 331_M(R) may include a plurality of multipliers, for example, ninth to sixteenth multipliers MUL(8)˜MUL(15). The ninth to sixteenth multipliers MUL(8)˜MUL(15) may receive ninth to sixteenth weight data W9˜W16 from a right memory bank 110(R) of the first memory circuit 110, respectively. In addition, the ninth to sixteenth multipliers MUL(8)˜MUL(15) may receive ninth to sixteenth vector data V9˜V16 from a second global buffer 122 of the second memory circuit 120, respectively. The ninth to sixteenth weight data W9˜W16 may constitute the right weight data W(R)s described with reference to FIG. 1, and the ninth to sixteenth vector data V9˜V16 may constitute the right vector data V(R)s described with reference to FIG. 1. The ninth to sixteenth multipliers MUL(8)˜MUL(15) of the right multiplication circuit 331_M(R) may perform multiplying calculations on the ninth to sixteenth weight data W9˜W16 and the ninth to sixteenth vector data V9˜V16 to generate ninth to sixteenth multiplication result data WV9˜WV16, respectively. The ninth to sixteenth multiplication result data WV9˜WV16 may be transmitted to the right adder tree 331_A(R).

The right adder tree 331_A(R) may perform an adding calculation on the ninth to sixteenth multiplication result data WV9˜WV16 outputted from the right multiplication circuit 331_M(R). The right adder tree 331_A(R) may generate and output right multiplication/addition result data D_MA(R) as a result of the adding calculation. The right adder tree 331_A(R) may include a plurality of adders ADDs which are arrayed to have a hierarchical structure such as a tree structure. In the present embodiment, the right adder tree 331_A(R) may be comprised of a plurality of full-adders and a half-adder. However, the present embodiment is merely an example of the present disclosure. Accordingly, in some other embodiment, the right adder tree 331_A(R) may be comprised of only a plurality of half-adders. In the present embodiment, two full-adders ADD(13) and ADD(14) may be disposed in a first stage located at a highest level of the right adder tree 331_A(R), and two full-adders ADD(23) and ADD(24) may also be disposed in a second stage located at a second highest level of the right adder tree 331_A(R). In addition, one full-adder ADD(32) may be disposed in a third stage located at a third highest level of the right adder tree 331_A(R), and one full-adder ADD(42) may also be disposed in a fourth stage located at a fourth highest level of the right adder tree 331_A(R). Moreover, one half-adder ADD(52) may be disposed in a fifth stage located at a lowest level of the right adder tree 331_A(R).

The first full-adder ADD(13) in the first stage may perform an adding calculation on the ninth to eleventh multiplication result data WV9˜WV11 outputted from the ninth to eleventh multipliers MUL(8)˜MUL(10) of the right multiplication circuit 331_M(R), thereby generating and outputting added data S13 and a carry C13. The second full-adder ADD(14) in the first stage may perform an adding calculation on the fourteenth to sixteenth multiplication result data WV14˜WV16 outputted from the fourteenth to sixteenth multipliers MUL(13)˜MUL(15) of the right multiplication circuit 331_M(R), thereby generating and outputting added data S14 and a carry C14. The first full-adder ADD(23) in the second stage may perform an adding calculation on the added data S13 and the carry C13 outputted from the first full-adder ADD(13) in the first stage and the twelfth multiplication result data WV12 outputted from the twelfth multiplier MUL(11) of the right multiplication circuit 331_M(R), thereby generating and outputting added data S23 and a carry C23. The second full-adder ADD(24) in the second stage may perform an adding calculation on the added data S14 and the carry C14 outputted from the second full-adder ADD(14) in the first stage and the thirteenth multiplication result data WV13 outputted from the thirteenth multiplier MUL(12) of the right multiplication circuit 331_M(R), thereby generating and outputting added data S24 and a carry C24.

The full-adder ADD(32) in the third stage may perform an adding calculation on the carry 23 outputted from the first full-adder ADD(23) in the second stage and the added data S24 and the carry C24 outputted from the second full-adder ADD(24) in the second stage, thereby generating and outputting added data S32 and a carry C32. The full-adder ADD(42) in the fourth stage may perform an adding calculation on the added data S32 and the carry C32 outputted from the full-adder ADD(32) in the third stage and the added data S(23) outputted from the first full-adder ADD(23) in the second stage, thereby generating and outputting added data S42 and a carry C42. The half-adder ADD(52) in the fifth stage may perform an adding calculation on the added data S42 and the carry C42 outputted from the full-adder ADD(42) in the fourth stage, thereby generating and outputting the right multiplication/addition result data D_MA(R). The right multiplication/addition result data D_MA(R) outputted from the half-adder ADD(52) in the fifth stage of the right multiplication circuit 331_M(R) may be transmitted to the additional adder 335.

Referring again to FIG. 14, the first accumulative addition time “tACC1” it takes the left accumulator 140(L) of the AI accelerator 300 to perform the accumulative adding calculation may be longer than the CAS to CAS delay time “tCCD” and may be shorter than twice the CAS to CAS delay time “tCCD”, like the AI accelerator 100 described with reference to FIG. 1. Similarly, the second accumulative addition time “tACC2” it takes the right accumulator 140(R) of the AI accelerator 300 to perform the accumulative adding calculation may also be longer than the CAS to CAS delay time “tCCD” and may be shorter than twice the CAS to CAS delay time “tCCD”. As such, the left accumulator 140(L) and the right accumulator 140(R) may perform an accumulative adding calculation within the first accumulative addition time “tACC1” and the second accumulative addition time “tACC2”, which are shorter than twice the CAS to CAS delay time “tCCD”, respectively. Thus, it may be unnecessary to adjust the CAS to CAS delay time “tCCD” during the MAC operation. In addition, in the event that each memory bank is divided into the left memory bank 110(L) and the right memory bank 110(R), the left accumulator 140(L) may be realized using an accumulator included in a left MAC operator and the right accumulator 140(R) may be realized using an accumulator included in a right MAC operator. Thus, it may be unnecessary to additionally dispose accumulators occupying a relatively large area in the AI accelerator 300. Accordingly, it may be possible to realize compact AI accelerators.

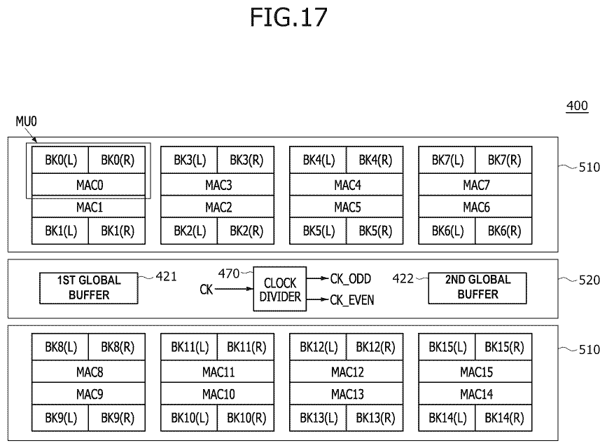

FIG. 17 is a block diagram illustrating an AI accelerator 400 according to yet another embodiment of the present disclosure. Referring to FIG. 17, the AI accelerator 400 may include a memory/arithmetic region 510 and a peripheral region 520. The memory/arithmetic region 510 may include a plurality of memory banks BKs and a plurality of MAC operators MACs. The peripheral region 520 may include a first global buffer 421, a second global buffer 422, and a clock divider 470. Although not shown in FIG. 17, a data I/O circuit may be disposed in the peripheral region 520, and the data I/O circuit disposed in the peripheral region 520 may include left data I/O terminals and right data I/O terminals, like the data I/O circuit 160 described with reference to FIG. 1. In the present embodiment, it may be assumed that the plurality of memory banks BKs include first to sixteenth memory banks BK0˜BK15. In addition, it may be assumed that the plurality of MAC operators MACs include first to sixteenth MAC operators MAC0˜MAC15.

Each of the first to sixteenth memory banks BK0˜BK15 may be divided into a left memory bank disposed in a left region and a right memory bank disposed in a right region. Accordingly, the first to sixteenth memory banks BK0˜BK15 may include first to sixteenth left memory banks BK0(L)˜BK15(L) and first to sixteenth right memory banks BK0(R)˜BK15(R). For example, the first memory bank BK0 may include the first left memory bank BK0(L) disposed in the left region and the first right memory bank BK0(R) disposed in the right region, and the second memory bank BK1 may include the second left memory bank BK1(L) disposed in the left region and the second right memory bank BK1(R) disposed in the right region. Similarly, the sixteenth memory bank BK15 may include the sixteenth left memory bank BK15(L) disposed in the left region and the sixteenth right memory bank BK15(R) disposed in the right region. In the present embodiment, the first to sixteenth left memory banks BK0(L)˜BK15(L) may be disposed to be adjacent to the first to sixteenth right memory banks BK0(R)˜BK15(R), respectively. For example, the first left memory bank BK0(L) and the first right memory bank BK0(R) may be disposed to be adjacent to each other and to share a row decoder with each other. The second left memory bank BK1(L) and the second right memory bank BK1(R) may also be disposed to be adjacent to each other. In the same way, the sixteenth left memory bank BK15(L) and the sixteenth right memory bank BK15(R) may also be disposed to be adjacent to each other.

The first to sixteenth MAC operators MAC0˜MAC15 may be disposed to be allocated to the first to sixteenth memory banks BK0˜BK15, respectively. For example, the first MAC operator MAC0 may be allocated to both of the first left memory bank BK0(L) and the first right memory bank BK0(R). In addition, the second MAC operator MAC1 may be allocated to both of the second left memory bank BK1(L) and the second right memory bank BK1(R). Similarly, the sixteenth MAC operator MAC15 may be allocated to both of the sixteenth left memory bank BK15(L) and the sixteenth right memory bank BK15(R). Each of the first to sixteenth MAC operators MAC0˜MAC15 and one of the first to sixteenth memory banks may constitute one MAC unit MU. For example, as illustrated in FIG. 17, the first left memory bank BK0(L), the first right memory bank BK0(R), and the first MAC operator MAC0 may constitute a first MAC unit MU0. Although not indicated in FIG. 17, each of second to sixteenth MAC units may also be configured in the same way as described above. A MAC operator included in a certain MAC unit may receive left weight data from a left memory bank included in the certain MAC unit and may receive right weight data from a right memory bank included in the certain MAC unit. Thus, the first MAC operator MAC0 may receive left weight data from the first left memory bank BK0(L) and may receive right weight data from the first right memory bank BK0(R).

The first global buffer 421 may transmit left vector data to each of the first to sixteenth MAC operators MAC0˜MAC15. The second global buffer 422 may transmit right vector data to each of the first to sixteenth MAC operators MAC0˜MAC15. The clock divider 470 may divide a clock signal CK, which is inputted to the AI accelerator 400, to generate and output an odd clock signal CK_ODD and an even clock signal CK_EVEN. The odd clock signal CK_ODD may be transmitted to a left accumulator in each of the first to sixteenth MAC operators MAC0˜MAC15. The even clock signal CK_ODD may be transmitted to a right accumulator in each of the first to sixteenth MAC operators MAC0˜MAC15. The first global buffer 421, the second global buffer 422, and the clock divider 470 may have substantially the same configurations as the first global buffer 121, the second global buffer 122, and the clock divider 170 of the AI accelerator 100 described with reference to FIG. 1, respectively.

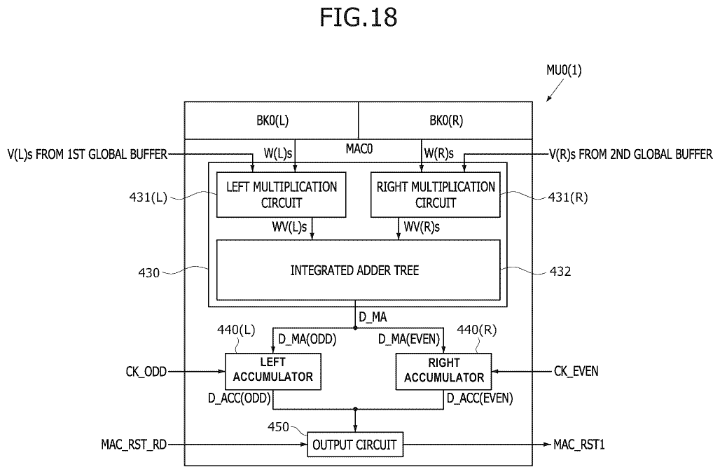

FIG. 18 is a block diagram illustrating a first MAC unit MU0(1) corresponding to an example of the first MAC unit MU0 included in the AI accelerator 400 of FIG. 17. The following descriptions for the first MAC unit MU0(1) may be equally applied to each of the remaining MAC units. Referring to FIG. 18, the first MAC unit MU0(1) may be comprised of the first left memory bank BK0(L), the first right memory bank BK0(R), and the first MAC operator MAC0, as described with reference to FIG. 17. The first left memory bank BK0(L) and the first right memory bank BK0(R) may have substantially the same configurations as the left memory bank 110(L) and the right memory bank 110(R) included in the AI accelerator 100 described with reference to FIG. 1, respectively. The first MAC operator MAC0 may include a multiplication circuit/adder tree 430, a left accumulator 440(L), a right accumulator 440(R), and an output circuit 450. The multiplication circuit/adder tree 430 may include a left multiplication circuit 431(L), a right multiplication circuit 431(R), and an integrated adder tree 432. The left multiplication circuit 431(L), the right multiplication circuit 431(R), the integrated adder tree 432, the left accumulator 440(L), the right accumulator 440(R), and the output circuit 450 constituting the first MAC operator MAC0 may have substantially the same configurations as the left multiplication circuit 131(L), the right multiplication circuit 131(R), the integrated adder tree 132, the left accumulator 140(L), the right accumulator 140(R), and the output circuit 150 constituting the AI accelerator 100 illustrated in FIG. 1, respectively. Accordingly, the left multiplication circuit 431(L), the right multiplication circuit 431(R), the integrated adder tree 432, the left accumulator 440(L), the right accumulator 440(R), and the output circuit 450 constituting the first MAC operator MAC0 may perform substantially the same operations as the left multiplication circuit 131(L), the right multiplication circuit 131(R), the integrated adder tree 132, the left accumulator 140(L), the right accumulator 140(R), and the output circuit 150 constituting the AI accelerator 100 illustrated in FIG. 1, respectively.

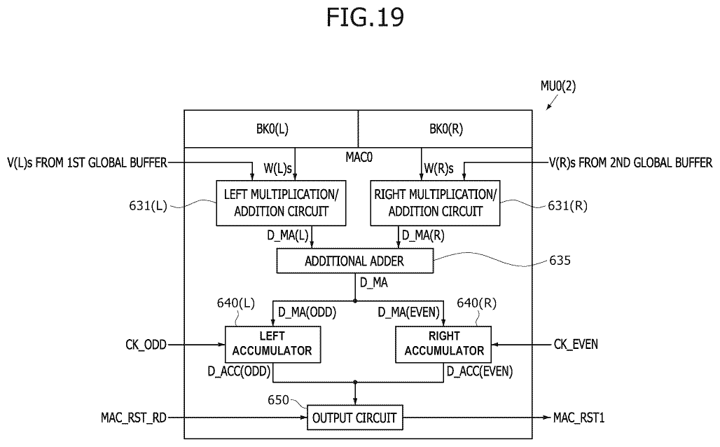

FIG. 19 is a block diagram illustrating a first MAC unit MU0(2) corresponding to another example of the first MAC unit MU0 included in the AI accelerator 400 of FIG. 17. The following descriptions for the first MAC unit MU0(2) may be equally applied to each of the remaining MAC units. Referring to FIG. 19, the first MAC unit MU0(2) may be comprised of the first left memory bank BK0(L), the first right memory bank BK0(R), and the first MAC operator MAC0, as described with reference to FIG. 17. The first left memory bank BK0(L) and the first right memory bank BK0(R) may have substantially the same configurations as the left memory bank 110(L) and the right memory bank 110(R) included in the AI accelerator 100 described with reference to FIG. 1, respectively. The first MAC operator MAC0 may include a left multiplication/addition circuit 631(L), a right multiplication/addition circuit 631(R), an additional adder 635, a left accumulator 640(L), a right accumulator 640(R), and an output circuit 650. The left multiplication/addition circuit 631(L), the right multiplication/addition circuit 631(R), the additional adder 635, the left accumulator 640(L), the right accumulator 640(R), and the output circuit 650 constituting the first MAC operator MAC0 may have substantially the same configurations as the left multiplication/addition circuit 331(L), the right multiplication/addition circuit 331(R), the additional adder 335, the left accumulator 140(L), the right accumulator 140(R), and the output circuit 150 constituting the AI accelerator 300 illustrated in FIG. 14, respectively. Accordingly, the left multiplication/addition circuit 631(L), the right multiplication/addition circuit 631(R), the additional adder 635, the left accumulator 640(L), the right accumulator 640(R), and the output circuit 650 constituting the first MAC operator MAC0 may perform substantially the same operations as the left multiplication/addition circuit 331(L), the right multiplication/addition circuit 331(R), the additional adder 335, the left accumulator 140(L), the right accumulator 140(R), and the output circuit 150 constituting the AI accelerator 300 illustrated in FIG. 14, respectively.

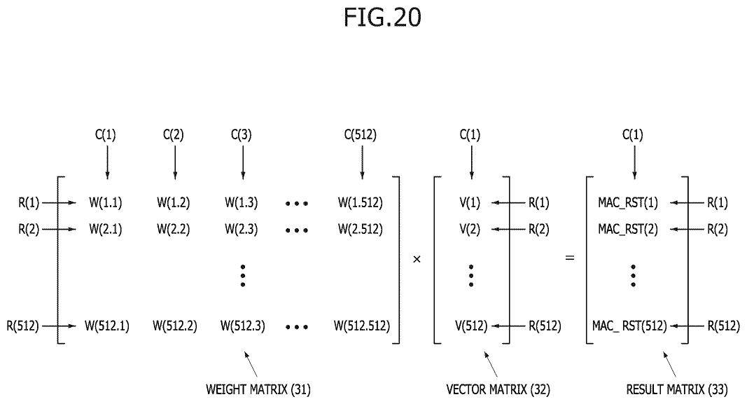

FIG. 20 illustrates a matrix multiplying calculation executed by a MAC operation of the AI accelerator 400 of FIG. 17. Referring to FIG. 20, the AI accelerator 400 may perform a MAC operation which is executed by a matrix multiplying calculation for multiplying a ‘M×N’ weight matrix 31 by a ‘N×1’ vector matrix 32 (where, “M” and “N” are natural numbers which are equal to or greater than two). The term “matrix multiplying calculation” may be construed as having the same meaning as the term “MAC operation”. The AI accelerator 400 may generate and output a ‘M×1’ result matrix 33 as a result of the MAC operation on the ‘M×N’ weight matrix 31 and the ‘N×1’ vector matrix 32. Hereinafter, it may be assumed that the weight matrix 31 has 512 rows (i.e., first to 512^{th} rows R(1)˜R(512)) and 512 columns (i.e., first to 512^{th} columns C(1)˜C(512)) and the vector matrix 32 has 512 rows (i.e., first to 512^{th} rows R(1)˜R(512)) and one column (i.e., a first column C(1)). Accordingly, the result matrix 33 generated by the matrix multiplying calculation on the weight matrix 31 and the vector matrix 32 may have 512 rows (i.e., first to 512^{th} rows R(1)˜R(512)) and one column (i.e., a first column C(1)). The weight matrix 31 may have 262,144 sets of weight data W(1.1)˜W(1.512), . . . , and W(512.1)˜W(512.512) as elements. The vector matrix 32 may have 512 sets of vector data V(1)˜V(512) as elements. The result matrix 33 generated by the MAC operation may have 512 sets of MAC result data MAC_RST(1)˜MAC_RST(512) as elements.

The AI accelerator 400 according to the present embodiment may have a plurality of memory banks BKs and a plurality of MAC operators MACs. Thus, a plurality of MAC operations may be simultaneously performed by the plurality of MAC operators MACs. Specifically, the first to sixteenth MAC operators MAC0˜MAC15 of the AI accelerator 400 may perform a first MAC operation on the weight data W(1.1)˜W(1.512), . . . , and W(16.1)˜W(16.512) arrayed in the first to sixteenth rows R(1)˜R(16) of the weight matrix 31 and the vector data V(1)˜V(512) arrayed in the first to sixteenth rows R(1)˜R(512) of the vector matrix 32, thereby generating and output sixteen sets of MAC result data (i.e., first to sixteenth MAC result data MAC_RST(1)˜MAC_RST(16)), respectively. Subsequently, the first to sixteenth MAC operators MAC0˜MAC15 of the AI accelerator 400 may perform a second MAC operation on the weight data W(17.1)˜W(17.512), . . . , and W(32.1)˜W(32.512) arrayed in the seventeenth to 32^{nd} rows R(17)˜R(32) of the weight matrix 31 and the vector data V(1)˜V(512) arrayed in the first to sixteenth rows R(1)˜R(512) of the vector matrix 32, thereby generating sixteen sets of MAC result data (i.e., seventeenth to 32^{nd} MAC result data MAC_RST(17)˜MAC_RST(32)), respectively. In the same way, the first to sixteenth MAC operators MAC0˜MAC15 of the AI accelerator 400 may perform third to 32^{nd} MAC operations to generate 33^{rd} to 512^{th} MAC result data MAC_RST(33)˜MAC_RST(512).

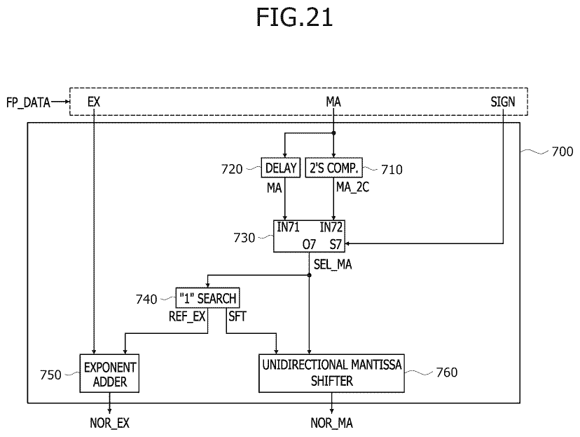

FIG. 21 is a block diagram illustrating a normalizer according to an embodiment of the present disclosure. A normalizer according to this example may be applied to normalizers used in various examples of artificial intelligence accelerators described with reference to FIGS. 1 to 20.

Referring to FIG. 21, a normalizer 700 receives floating-point data FP_DATA as input data. The normalizer 700 performs a normalization operation on the floating-point data FP_DATA to output normalized exponent data NOR_EX and normalized mantissa data NOR_MA. The floating-point data FP_DATA includes sign data SIGN, exponent data EX, and mantissa data MA. The mantissa data MA of the floating-point data FP_DATA may have a denormalized format. In an embodiment, the mantissa data MA of the floating-point data FP_DATA employing a FP32 format has a 24-bit normalized format in the form of “1.xxxx . . . ” where “x” is the binary number “0” or “1”, and the “1” to the left of the binary point represents a hidden bit (also called implicit bit). The normalizer 700 receives the floating-point data FP_DATA in a denormalized format and outputs normalized exponent data NOR_EX and normalized mantissa data NOR_MA in a normalized format. In an embodiment, the normalized exponent data NOR_EX is in the form of an 8-bit binary stream, and the normalized mantissa data NOR_MA is in the form of a 24-bit binary stream of “1.xxxx . . . ” including a hidden bit. In an embodiment, when the normalizer 700 is used in an accumulator, the normalized exponent data NOR_EX may be in the form of a binary stream of more bits than 8 bits, such as 10 bits. In an embodiment, as used herein a first binary value may refer to a high voltage value or a binary symbol of one (i.e., “1”) and a second binary value may refer to a low voltage value or a binary symbol of zero (i.e., “0”).

The normalizer 700 performs a 2's complement operation, a delay process, a select output process, a “1” search process, an exponent addition process, and mantissa shift process. The normalizer 700 may include a 2's complement circuit (2'S COMP) 710, a delay circuit (DELAY) 720, a multiplexer 730, a “1” search circuit (“1” SEARCH) 740, also referred to herein as a search circuit, an exponent adder 750, and a unidirectional mantissa shifter 760. The 2's complement circuit 710 performs the 2's complement operation. The delay circuit 720 performs the delay process. The multiplexer 730 performs the select output process. The “1” search circuit 740 performs the “1” search process. The exponent adder 750 performs the exponent addition process. The unidirectional mantissa shifter 760 performs the mantissa shift process.

The 2's complement circuit 710 and the delay circuit 720 of the normalizer 700 receive the mantissa data MA of the floating-point data FP_DATA as input data. The 2's complement circuit 710 generates and outputs 2's complement data MA_2C of the mantissa data. The delay circuit 720 delays the mantissa data MA for a delay time and then outputs the mantissa data MA. The delay time in the delay circuit 720 may be set to the time it takes for the 2's complement data MA_2C of the mantissa data to be generated in the 2's complement circuit 710. Accordingly, the time at which the 2's complement data MA_2C of the mantissa data is output from the 2's complement circuit 710 and the time at which the mantissa data MA is output from the delay circuit 720 may be substantially the same.

The multiplexer 730 of the normalizer 700 may be, for example, a 2:1 multiplexer. The multiplexer 730 has a first input terminal IN71, a second input terminal IN72, a selection terminal S7, and an output terminal 07. The multiplexer 730 receives the mantissa data MA, which is output from the delay circuit 720, through the first input terminal IN71. The multiplexer 730 receives the 2's complement data MA_2C of the mantissa data, which is output from the 2's complement circuit 710, through the second input terminal IN72. The multiplexer 730 receives the sign data SIGN of the floating-point data FP_DATA through the selection terminal S7. The multiplexer 730 outputs the mantissa data MA or the 2's complement data MA_2C of the mantissa data through the output terminal 07 based on the binary value of the sign data SIGN. In an embodiment, when the sign data SIGN having a value of “0” is input to the select terminal S7, that is, when the mantissa data MA is positive, the multiplexer 730 outputs the mantissa data MA through the output terminal 07. In other embodiments, when the sign data SIGN having a value of “1” is input to the selection terminal S7, that is, when the mantissa data MA is negative, the multiplexer 730 outputs the 2's complement data MA_2C of the mantissa data through the output terminal 07. Hereinafter, the data that is output from the multiplexer 730 will be referred to as “selected mantissa data SEL_MA”.

The “1” search circuit 740 of the normalizer 700 receives the selected mantissa data SEL_MA that is output from the multiplexer 730. The “1” search circuit 740 generates and outputs reference exponent data REF_EX and shift data SFT, respectively. In an embodiment, the “1” search circuit 740 performs a leading “1” search operation to detect a bit position of “leading 1” for the selected mantissa data SEL_MA to generate the reference exponent data REF_EX and preliminary shift data. The “1” search circuit 740 also generates the shift data SFT based on the preliminary shift data and the reference exponent data REF_EX.

In an embodiment, the leading “1” search operation refers to an operation in which the circuit performs a search operation for a leading first binary value (i.e., “1”). The leading “1” search operation, also referred to herein as a search operation for a leading first binary value, in the “1” search circuit 740 may be performed by detecting a position where the bit with a value of “1” is located first among values of bits of the selected mantissa data SEL_MA in the leftmost to rightmost direction (i.e., from a most significant bit (MSB) to a least significant bit (LSB)). Here, the leading “1” means a first positioned “1”, i.e., “1” for the highest binary weight, and represents a hidden bit in the normalized mantissa data. In the process of performing the leading “1” search operation, the leading “1” search circuit 740 generates the reference exponent data REF_EX, which is a binary number corresponding to a number of bits present between the MSB of the selected mantissa data SEL_MA and the binary point. In an embodiment, when the selected mantissa data SEL_MA is a format of “1 yyyyy.xxx . . . ” (“x” and “y” are binary number “0” or “1”), five bits (i.e., “yyyyy”) exist between the MSB (i.e., a binary value of “1”) of the selected mantissa data SEL_MA and the binary point. Therefore, in this case, the reference exponent data REF_EX generated by the “1” search circuit 740 is a binary stream of “0000 0001 01”, which is a binary number corresponding to a decimal number “5”. In other embodiment, when the selected mantissa data SEL_MA is a format of “0y.xxx . . . ”, one bit (i.e., “y”) exists between the MSB (i.e., a binary value of “0”) of the selected mantissa data SEL_MA and the binary point. Therefore, in this case, the reference exponent data REF_EX generated by the “1” search circuit 740 is a binary stream of “0000 0000 01”, which is a binary number corresponding to a decimal number “1”.

Although not shown in the FIG. 21, the “1” search circuit 740 generates the preliminary shift data by performing the leading “1” search operation. In an embodiment, the preliminary shift data may be generated based on a number of bits by which the selected mantissa data SEL_MA is to be shifted so that the binary point is positioned to the immediate right of the leading “1” (i.e., in the normalized form of “1.xxxx . . . ”). In this case, the preliminary shift data is a binary number corresponding to the number of bits by which the selected mantissa data SEL_MA is to be shifted. In other embodiments, the preliminary shift data may be generated based on a number of bits present between the binary point and the leading “1”. In this case, the preliminary shift data is a binary number corresponding to the number of bits present between the binary point and the leading “1”.

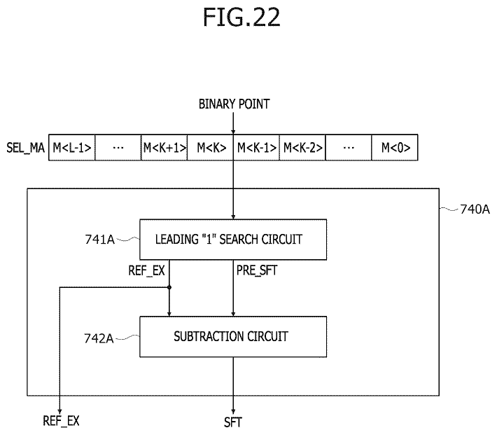

In an embodiment, the operation of generating the shift data SFT in the “1” search circuit 740 may be performed by subtracting the reference exponent data REF_EX from the preliminary shift data. The reference exponent data REF_EX generated by the “1” search circuit 740 is transferred to the exponent adder 750 of the normalizer 700 and is added to the exponent data EX of the floating-point data FP_DATA in the exponent adder 750. The shift data SFT generated by the “1” search circuit 740 is transferred to the unidirectional mantissa shifter 760 of the normalizer 700. The shift data SFT provides a number of bits by which the selected mantissa data SEL_MA is shifted to the unidirectional mantissa shifter 760. As such, the shift data SFT may be generated by subtracting the reference exponent data REF_EX from the preliminary shift data, as the reference exponent data REF_EX is added to the exponent data EX. The process by which the “1” search circuit 740 generates the preliminary shift data and the shift data SFT will be described in more detail below with reference to FIG. 22.

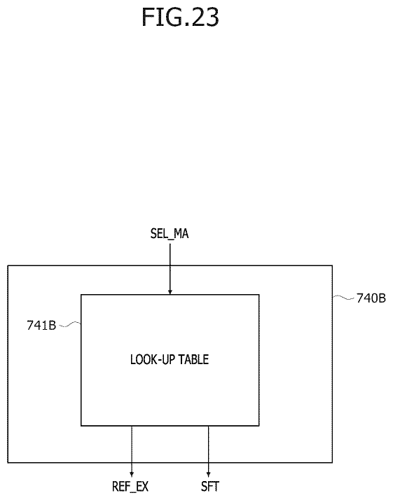

In other embodiments, the “1” search circuit 740 of the normalizer 700 may include a look-up table. The look-up table may store the reference exponent data REF_EX and the shift data SFT corresponding to the selected mantissa data SEL_MA. Accordingly, the “1” search circuit 740 outputs the reference exponent data REF_EX and the shift data SFT corresponding to the selected mantissa data SEL_MA, which is input to the “1” search circuit 740, by the look-up table. When the “1” search circuit 740 is configured as the look-up table, the reference exponent data REF_EX and the shift data SFT are output from the “1” search circuit 740 at substantially the same time. The process by which the “1” search circuit 740 outputs the reference exponent data REF_EX and the shift data SFT using the look-up table will be described below with reference to FIGS. 23 through 25.

The exponent adder 750 of the normalizer 700 receives the exponent data EX of the floating-point data FP_DATA. Also, the exponent adder 750 receives the reference exponent data REF_EX that is output from the “1” search circuit 740. The exponent adder 750 performs an addition operation on the exponent data EX and the reference exponent data REF_EX, and outputs the result of the addition operation as normalized exponent data NOR_EX. The unidirectional mantissa shifter 760 receives the selected mantissa data SEL_MA, which is output from the multiplexer 730, and the shift data SFT, which is output from the “1” search circuit 740. The unidirectional mantissa shifter 760 performs a shift operation on the selected mantissa data SEL_MA based on the shift data SFT to generate the normalized mantissa data NOR_MA. In an embodiment, as the shift data SFT is generated by subtracting the reference exponent data REF_EX from the preliminary shift data, the shift operation on the selected mantissa data SEL_MA in the unidirectional mantissa shifter 760 is always performed in one direction only. In an embodiment, this can reduce the circuit area of the mantissa shifter required to implement the normalizer 700. In an embodiment, the unidirectional mantissa shifter 760 may comprise a plurality of 2:1 multiplexers.

FIG. 22 is a block diagram illustrating an example of a “1” search circuit included in a normalizer of FIG. 21.

Referring to FIG. 22, a “1” search circuit 740A may include a leading “1” search circuit 741A, and a subtraction circuit 742A. The leading “1” search circuit 741A of the “1” search circuit 740A receives the selected mantissa data SEL_MA, which may be in the form of a binary stream of “L” bits (where “L” is a natural number greater than or equal to 6). In the selected mantissa data SEL_MA, the binary point is located between a “K”th bit M<K−1> (where “K” is a natural number less than “L−1”) and a “K+1”th bit M<K>. In the selected mantissa data SEL_MA, binary digits to the left of the binary point have “L−K+1” bits. On the other hand, in the selected mantissa data SEL_MA, binary digits to the right of the binary point have “K” bits. The leading “1” search circuit 741A detects a bit position of the left-most “1” (i.e., the leading “1”) among the “L” bits from a “L”th bit M<L−1>, which is the MSB, to a first bit M<0>, which is the LSB, of the selected mantissa data SEL_MA. In the process, the leading “1” search circuit 741A generates and outputs the reference exponent data REF_EX. As described with reference to FIG. 21, the reference exponent data REF_EX is a binary number corresponding to the number of bits present between the MSB M<L−1> of the selected mantissa data SEL_MA and the binary point. Accordingly, the reference exponent data REF_EX for the selected mantissa data SEL_MA is a binary number corresponding to the decimal number “L−K”. The leading “1” search circuit 741A generates and outputs a binary number corresponding to the number of bits that the selected mantissa data SEL_MA is to be shifted for positioning the binary point to the immediate right of the leading “1” detected by the leading “1” search process as the preliminary shift data PRE_SFT.

In an embodiment, when the leading “1” is located at the “K+2”th bit M<K+1>, the number of bits by which the selected mantissa data SEL_MA is to be shifted to the right direction is a decimal number “+1” (“+” indicates a shift to the “right direction”), in order for the binary point to be located to the right of the “K+2”th bit M<K+1>, i.e., between the “K+2”th bit M<K+1> and the “K+1”th bit M<K>. Therefore, in this case, the preliminary shift data PRE_SFT is “0000 0000 01”, which is the binary number corresponding to the decimal number “+1”. In other embodiment, when the leading “1” is located at the “K”th bit M<K−1>, the binary point is positioned to the right of the “K” bit M<K−1>, i.e., between the “K” bit M<K−1> and the “K−1” bit M<K−2>, the number of bits by which the selected mantissa data SEL_MA is to be shifted to the left direction is a decimal number “−1” (“−” indicates a shift to the “left direction”), in order for the binary point to be located to the right of the “K”th bit M<K−1>, i.e., between the “K”th bit M<K−1> and the “K−1”th bit M<K−2>. Therefore, in this case, the preliminary shift data PRE_SFT is “1111 1111 11”, which is the binary number corresponding to the decimal number “−1”.

The subtraction circuit 742A of the “1” search circuit 740A receives the reference exponent data REF_EX and the preliminary shift data PRE_SFT from the leading “1” search circuit 741A. The subtraction circuit 742A subtracts the reference exponent data REF_EX from the preliminary shift data PRE_SFT and outputs the resulting data as the shift data SFT. In an embodiment, the subtraction circuit 742A may include a 2's complement circuit and an adder for subtraction operation.

FIG. 23 is a block diagram illustrating another example of a “1” search circuit included in a normalizer of FIG. 21.

Referring to FIG. 23, the “1” search circuit 740B includes a look-up table 741B. The look-up table 741B receives the selected mantissa data SEL_MA as an input value (or index). As outputs, the look-up table 741B outputs the reference exponent data REF_EX and the shift data SFT. For this purpose, the look-up table 741B may be configured by storing the reference exponent data REF_EX and the shift data SFT corresponding to the selected mantissa data SEL_MA with different positions of the leading “1” in a table format.

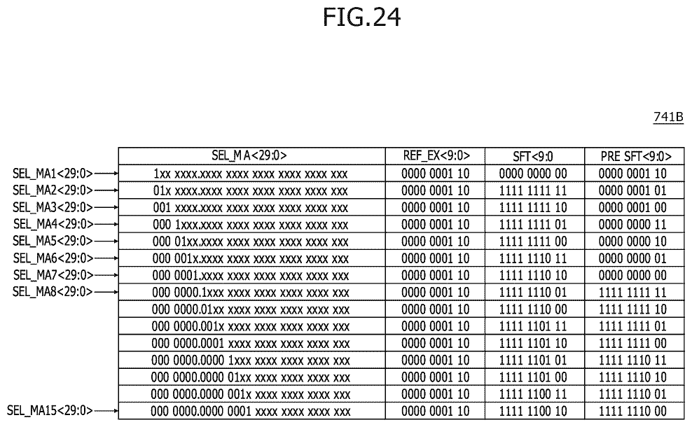

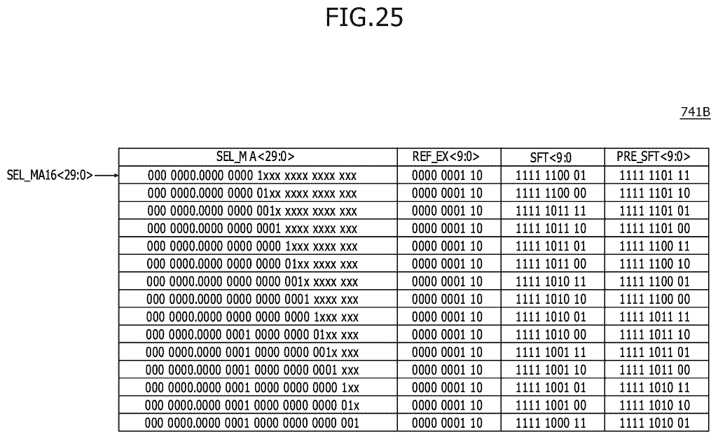

FIGS. 24 and 25 are block diagrams illustrating an example of a look-up table included in a “1” search circuit of FIG. 23. In FIGS. 24 and 25, it is assumed that the selected mantissa data SEL_MA<29:0> input to the “1” search circuit has a size of 30 bits, and the reference exponent data REF_EX<9:0> and the shift data SFT<9:0> output from the “1” search circuit each have a size of 10 bits. Since the selected mantissa data SEL_MA<29:0> is 30 bits in size, the look-up table stores 30 indices and 30 shift data SFT<9:0> corresponding to the 30 indices. Also, it is assumed that the preliminary shift data PRE_SFT<9:0> generated by the “1” search circuit is also 10 bits in size. Among the 10 bits of the shift data SFT<9:0> and the preliminary shift data PRE_SFT<9:0>, the lower 5 bits indicate the number of shift bits, the upper 2 bits are sign extension bits, and the 3 bits in between the lower 5 bits and the upper 2 bits indicate whether an overflow occurs. For example, when the sign is “0” and the upper 3 bits of the lower 5 bits include “1”, it is an overflow. Also, since the selected mantissa data SEL_MA<29:0> has a size of 30 bits, when the decimal value of the lower 5 bits of the shift data <SFT<9:0> and the 10 bits of the preliminary shift data PRE_SFT<9:0> is greater than “29”, it is also overflowed. In FIGS. 24 and 25, the preliminary shift data REE_SFT<9:0> is shown for reference only and is not included in the look-up table. In FIGS. 24 and 25, “x” represents the binary value “0” or “1”.

Referring to FIGS. 24 and 25, a look-up table 741B stores reference exponent data REF_EX<9:0> and shift data FT<9:0> consisting of a binary number determined by the leading “1” position of selected mantissa data SEL_MA<29:0> of size 30 bits. In this example, the selected mantissa data SEL_MA<29:0> is a binary number with 7 bits to the left of the binary point and 23 bits to the right of the binary point. Because there are 6 bits between the MSB SEL_MA<28> and the binary point in the selected mantissa data SEL_MA<29:0>, the reference exponent data REF_EX<9:0> in this example is “0000 0001 10”, which is the binary equivalent of the decimal number “+6”. The reference exponent data REF_EX<9:0>, “0000 0001 10”, is output from the “1” search circuit 740B in FIG. 23 as common to all selected mantissa data SEL_MA<29:0>, regardless of the position of the leading “1”.

As exemplified in FIG. 24, the first selected mantissa data SEL_MA1<29:0> is a binary stream of “1xx xxxx.xxxx xxxx xxxx xxxx xxxx xxx”, wherein the leading “1” is located in the 30^{th} bit SEL_MA1<29>, which is the MSB of the first selected mantissa data SEL_MA1<29:0>. To make the first selected mantissa data SEL_MA1<29:0>, “1xxxxxx.xxxxx xxxx xxxx xxx”, into the normalized form of “1.xxxx . . . ”, a shift operation of 6 bits in the right direction must be performed on the first selected mantissa data SEL_MA1<29:0>. In other words, the preliminary shift data PRE_SFT<9:0> for the first selected mantissa data SEL_MA1<29:0> becomes “0000 0001 10”, which is the binary equivalent of the decimal number “+6” (“+” indicates a shift to the right). The shift data SFT<9:0> as the output for the first selected mantissa data SEL_MA1<29:0> is “0000 0000 00”, which is the preliminary shift data PRE_SFT<9:0> of “0000 0001 10” minus the reference exponent data REF<9:0> of “0000 0001 10”, as described with reference to FIG. 22. As described with reference to FIG. 21, the reference exponent data REF_EX<9:0>, “0000 0001 10”, is input to the exponent adder 750 of the normalizer 700. And the shift data SFT<9:0>, “0000 0000 00”, is input to the unidirectional mantissa shifter 760 of the normalizer 700.

The second selected mantissa data SEL_MA2<29:0> is a binary stream of “01x xxxx.xxxx xxxx xxxx xxxx xxxx xxx”, where the leading “1” is located in the 29^{th} bit SEL_MA2<28> of the second selected mantissa data SEL_MA2<29:0>. To make the second selected mantissa data SEL_MA2<29:0>, “01x xxxx.xxxx xxxx xxxx xxxx xxxx xxxx xxx”, into the normalized form of “1.xxxx . . . ”, a shift operation of 5 bits in the right direction must be performed on the second selected mantissa data SEL_MA2<29:0>. In other words, the preliminary shift data PRE_SFT<9:0> of the second selected mantissa data SEL_MA2<29:0> becomes “0000 0001 01”, which is the binary equivalent of the decimal number “+5” (“+” indicates a shift to the right). The shift data SFT<9:0> as output for the second selected mantissa data SEL_MA2<29:0> will be the preliminary shift data PRE_SFT<9:0>, “0000 0001 01”, minus the reference exponent data REF<9:0>, “0000 0001 10”, becomes “1111 1111 11” (decimal “−1” (“−” indicates a shift to the left)). In this case, the shift operation on the second selected mantissa data SEL_MA2<29:0>, “01x xxxx.xxxx xxxx xxxx xxxx xxxx xxxx xxx”, in the unidirectional mantissa shifter 760 of the normalizer 700, is performed by 1 bit in the left direction.

The third selected mantissa data SEL_MA3<29:0> is a binary stream of “001 xxxx.xxxx xxxx xxxx xxxx xxxx xxx”, where the leading “1” is located in the 28^{th} bit SEL_MA3<27> of the third selected mantissa data SEL_MA3<29:0>. To make the third selected mantissa data SEL_MA3<29:0>, “001 xxxx.xxxx xxxx xxxx xxxx xxxx xxxx xxx”, into the normalized form of “1.xxxx . . . ”, a shift operation of 4 bits in the right direction must be performed on the third selected mantissa data SEL_MA3<29:0>. In other words, the preliminary shift data PRE_SFT<9:0> of the third selected mantissa data SEL_MA3<29:0> becomes “0000 0001 00”, which is the binary equivalent of the decimal number “+4”. The shift data SFT<9:0> as output for the third selected mantissa data SEL_MA3<29:0> is “1111 1111 10” (decimal “−2”), which is the preliminary shift data PRE_SFT<9:0> of “0000 0001 00” minus the reference exponent data REF<9:0> of “0000 0001 10”. In this case, the shift operation on the third selected mantissa data SEL_MA3<29:0>, “001 xxxx.xxxx xxxx xxxx xxxx xxxx xxxx xxx”, in the unidirectional mantissa shifter 760 of the normalizer 700, is performed by 2 bits in the left direction.

The seventh selected mantissa data SEL_MA7<29:0> is a binary stream of “000 0001.xxxx xxxx xxxx xxxx xxxx xxx”, where the leading “1” is located in the 24^{th} bit SEL_MA7<23> of the seventh selected mantissa data SEL_MA7<29:0>. To make the seventh selected mantissa data SEL_MA7<29:0>, “000 0001.xxxx xxxx xxxx xxxx xxxx xxxx xxx”, into the normalized form of “1.xxxx . . . ”, the seventh selected mantissa data SEL_MA7<29:0> does not need to be shifted. Therefore, the preliminary shift data PRE_SFT<9:0> of the seventh selected mantissa data SEL_MA7<29:0> becomes the binary number “0000 0000 00”. The shift data SFT<9:0> as output for the seventh selected mantissa data SEL_MA7<29:0> is “1111 1110 10” (decimal “−6”), which is the preliminary shift data PRE_SFT<9:0> of “0000 0000 00” minus the reference exponent data REF<9:0> of “0000 0001 10”. In this case, the shift operation on the seventh selected mantissa data SEL_MA7<29:0>, “000 0001.xxxx xxxx xxxx xxxx xxxx xxxx xxx” in the unidirectional mantissa shifter 760 of the normalizer 700, is performed by 6 bits in the left direction.

As shown above, the first through seventh selected mantissa data SEL_MA1<29:0>-SEL_MA7<29:0> all have a leading “1” to the left of the binary point. Therefore, to create the normalized mantissa data format of “1.xxx . . . ”, the first to sixth selected mantissa data SEL_MA1>29:0>-SEL_MA6<29:0>) must be shifted to the right. The seventh selected mantissa data SEL_MA7<29:0> is not shifted. More specifically, the first selected mantissa data SEL_MA1<29:0> should be shifted rightward by 6 bits. The second selected mantissa data SEL_MA2<29:0> should be shifted 5 bits to the right. The third selected mantissa data SEL_MA3<29:0> should be shifted 4 bits to the right. The fourth selected mantissa data SEL_MA4<29:0> should be shifted 3 bits to the right. The fifth selected mantissa data SEL_MA5<29:0> should be shifted 2 bits to the right. The sixth selected mantissa data SEL_MA6<29:0> should be shifted 1 bit to the right.

However, the shift data SFT (9:0>) transmitted to the unidirectional mantissa shifter 760 from the “1” search circuit 700 of FIG. 21 in the normalizer 700 of FIG. 21 is generated by an operation in which the reference exponent data REF<9:0>, “0000 0001 10” (decimal “6”), is subtracted from the preliminary shift data PRE_SFT<9:0>. Accordingly, only for the first selected mantissa data SEL_MA1<29:0>, “1xx xxxx.xxxx xxxx xxxx xxxx xxxx xxxx xxx”, no shift is performed within the unidirectional mantissa shifter 760, and for the remaining second through seventh selected mantissa data SEL_MA2<29:0>-SEL_MA7<29:0>, all shift operations are performed within the unidirectional mantissa shifter 760 in the left direction instead of the right direction. More specifically, the second selected mantissa data SEL_MA2<29:0> is shifted by 1 bit in the left direction. The third selected mantissa data SEL_MA3<29:0> is shifted by 2 bits in the left direction. The fourth selected mantissa data SEL_MA4<29:0> is shifted 3 bits in the left direction. The fifth selected mantissa data 5SEL_MA5<29:0> is shifted by 4 bits in the left direction. The sixth selected mantissa data SEL_MA6<29:0> is shifted by 5 bits in the left direction. The seventh selected mantissa data SEL_MA7<29:0> is shifted by 6 bits in the left direction.

The eighth selected mantissa data SEL_MA8<29:0> is a binary stream of “000 0000.1xxx xxxx xxxx xxxx xxxx xxxx XXX”, where the leading “1” is located at the right bit of the binary point, i.e., the 23rd bit SEL_MA8<22> of the eighth selected mantissa data SEL_MA8<29:0>. To make the eighth selected mantissa data SEL_MA8<29:0>, “000 0000.1xxx xxxx xxxx xxxx xxxx xxxx XXX”, into the normalized form of “1.xxxx . . . ”, the eighth selected mantissa data SEL_MA8<29:0> must be shifted by one bit in the left direction. This means that the preliminary shift data PRE_SFT<9:0> of the eighth selected mantissa data SEL_MA8<29:0> will be the binary number “1111 1111 11” (decimal number “−1” (“−” indicates a leftward shift). The shift data SFT<9:0> as output for the eighth selected mantissa data SEL_MA8<29:0> becomes “1111 1111 11” (decimal “−7”), which is the preliminary shift data PRE_SFT<9:0> minus the reference exponent data REF<9:0>, which is “0000 0001 10”. In this case, the shift operation on the eighth selected mantissa data SEL_MA8<29:0>, “000 0000.1xxx xxxx xxxx xxxx xxxx xxxx xxx” in the unidirectional mantissa shifter 760 of the normalizer 700, is performed by 7 bits in the left direction.

The 15th selected mantissa data SEL_MA15<29:0> is a binary stream of “000 0000.0000 0001 xxxx xxxx xxxx xxxx XXX”, where the leading “1” is located in the high 16 bits SEL_MA15<15> of the 15th selected mantissa data SEL_MA15<29:0>. To make the 15th selected mantissa data SEL_MA15<29:0>, “000 0000.0000 0001 xxxx xxxx xxx xxxx xxx”, into the normalized form of “1.xxxx . . . ”, the 15th selected mantissa data SEL_MA15<29:0> must be shifted by 8 bits in the left direction. In other words, the preliminary shift data PRE_SFT<9:0) of the 15^{th} selected mantissa data SEL_MA15<29:0> becomes the binary number “1111 1110 00” (decimal “−8”). The shift data SFT<9:0> as output for the 15^{th} selected mantissa data SEL_MA15<29:0> is the preliminary shift data PRE_SFT<9:0>, “1111 1110 00”, minus the reference exponent data REF<9:0>, “0000 0001 10”, which is “1111 1100 10” (decimal “−15”). In this case, the shift operation on the 15th selected mantissa data SEL_MA15<29:0>, “000 0000.0000 0001 xxxx xxxx xxxx xxxx xxx”, in the unidirectional mantissa shifter 760 of the normalizer 700, is performed by 15 bits in the left direction.

Similarly, as exemplified in FIG. 25, the 16th selected mantissa data SEL_MA16<29:0> is a binary stream of “000 0000.0000 0000 1xxx xxxx xxxx xxx”, where the leading “1” is located in the 15th bit SEL_MA16<14> of the 16th selected mantissa data SEL_MA16<29:0>. To make the 16th selected mantissa data SEL_MA16<29:0>, “000 0000.0000 0000 1xxx xxxx xxxx xxx”, into the normalized form of “1.xxxx . . . ”, the 16th selected mantissa data SEL_MA16<29:0> must be shifted by 9 bits in the left direction. In other words, the preliminary shift data PRE_SFT<9:0> of the 16th selected mantissa data SEL_MA16<29:0> becomes the binary number “1111 1101 11” (decimal “−9”). The shift data SFT<9:0> as output for the 16th selected mantissa data SEL_MA16<29:0> is the preliminary shift data PRE_SFT<9:0>, “1111 1101 11”, minus the reference exponent data REF<9:0>, “0000 0001 10”, which is “1111 1100 01” (decimal “−16”). In this case, the shift operation on the 16^{th} selected mantissa data SEL_MA16<29:0>, “000 0000.0000 0000 1xxx xxxx xxxx xxx” in the unidirectional mantissa shifter 760 of the normalizer 700, is performed by 16 bits in the left direction.

As shown above, the eighth through 30^{th} selected mantissa data SEL_MA8<29:0>-SEL_MA30<29:0> all have a leading “1” to the right of the binary point. Therefore, in order to generate the normalized mantissa data format of “1.xxx . . . ”, the eighth to 30th selected mantissa data SEL_MA8<29:0>-SEL_MA30<29:0> must be shifted to the right. However, as the reference exponent data REF_EX<9:0> is added to the exponent data EX, the bits in which the eighth to 30th selected mantissa data SEL_MA8<29:0>-SEL_MA30<29:0> are shifted, the number of bits is further increased from the original number of bits (i.e., the decimal value of the preliminary shift data) by a number of bits corresponding to the decimal value of the reference exponent data REF_EX<9:0>. As a result, no shift is performed only for the first selected mantissa data SEL_MA1<29:0>, and for all other selected mantissa data SEL_MA2<29:0>-SEL_MA30<29:0>, only a leftward shift operation is performed within the unidirectional mantissa shifter 760.

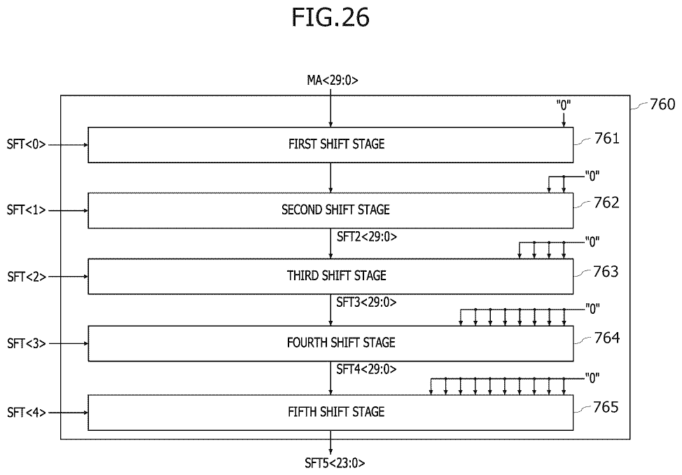

FIG. 26 is a block diagram illustrating an example of a unidirectional mantissa shifter included in a normalizer of FIG. 21. In the following, the unidirectional mantissa shifter that is capable of shifting 30 bits of mantissa data in the left direction will be described as an example.

Referring to FIG. 26, a unidirectional mantissa shifter 760 receives input of shift data SFT<4:0> and mantissa data MA<29:0>. As described with reference to FIG. 21, the shift data SFT<4:0> is input to the unidirectional mantissa shifter 760 from the “1” search circuit 740 in FIG. 21 in the normalizer 700 in FIG. 21. And the mantissa data MA<29:0> may be the selected mantissa data SEL_MA in FIG. 21 that is output from the multiplexer 730 in FIG. 21. In this example, mantissa data MA<29:0> corresponds to target data being shifted by the unidirectional mantissa shifter 760. The shift data SFT<4:0> provides the total number of shifted bits to the unidirectional mantissa shifter 760. Here, “total number of shifted bits” means the number of bit positions at which bits of mantissa data MA<29:0> are shifted by the shift operation of the unidirectional mantissa shifter 760. In other words, the unidirectional mantissa shifter 760 shifts mantissa data MA<29:0> by the total number of shifted bits. The unidirectional mantissa shifter 760 outputs fifth shift data SFT5<23:0>.

The unidirectional mantissa shifter 760 may include a plurality of shift stages, such as first through fifth shift stages 761-765. The number of shift stages may be determined by the number of bits of mantissa data to be shifted. When the mantissa data to be shifted MA<29:0> is “M” bits (where “M” is a natural number greater than 2), then the number of shift stages is determined to be “K” satisfying the condition “2^{K}≥M” (where “K” is a natural number). As in this example, when the mantissa data to be shifted (MA<29:0>) is 30 bits, the number of shift stages is 5. The first through fifth shift stages 761-765 each comprise a plurality of 2:1 multiplexers.

The first shift stage 761 receives input of the mantissa data MA<29:0>, the least significant bit (LSB) SFT<0> of the shift data SFT<4:0>, and “0”. The first shift stage 761 performs a shift operation on the mantissa data MA<29:0> based on the value of the LSB SFT<0> of the shift data SFT<4:0>, and outputs the first shift data SFT1<29:0>. In an embodiment, when the LSB SFT<0> of the shift data SFT<4:0> is “0”, the first shift stage 761 does not shift the mantissa data MA<29:0> and outputs the mantissa data MA<29:0> as the first shift data SFT1<29:0>. On the other hand, when the LSB SFT<0> of the shift data SFT<4:0> is “1”, the first shift stage 761 shifts the mantissa data MA<29:0> to the left by 1 bit corresponding to “20”, which is the binary weight of the LSB SFT<0> of the shift data SFT<4:0>, and the shifted resultant data is output as the first shift data SFT1<29:0>. In this case, the LSB of the first shift data SFT1<29:0> has the binary value of “0”.

The second shift stage 762 receives the first shift data SFT1<29:0> that is output from the first shift stage 761, the second bit SFT<1> of the shift data SFT<4:0>, and “0” as input. The second shift stage 762 performs a shift operation on the first shift data SFT1<29:0> based on the value of the second bit SFT<1> of the shift data SFT<4:0> to output the second shift data SFT2<29:0>. In an embodiment, when the second bit SFT<1> of the shift data SFT<4:0>) is “0”, the second shift stage 762 does not shift the first shift data SFT1<29:0> and outputs the first shift data SFT1<29:0> as the second shift data SFT2<29:0>. On the other hand, when the second bit SFT<1> of the shift data SFT<4:0> is “1”, the second shift stage 762 shifts the first shift data SFT1<29:0> to the left by 2 bits corresponding to “21”, which is the binary weight of the second bit SFT<1> of the shift data SFT<4:0>, and outputs the shifted resultant data as the second shift data SFT2<29:0>. In this case, the lower two bits of the second shift data SFT2<29:0> have the binary value of “0”.

The third shift stage 763 receives the second shift data SFT2<29:0> that is output from the second shift stage 762, the third bit SFT<2> of the shift data SFT<4:0>, and “0” as input. The third shift stage 763 performs a shift operation on the second shift data SFT2<29:0> based on the value of the third bit SFT<2> of the shift data SFT<4:0>, and outputs the third shift data SFT3<29:0>. In an embodiment, when the third bit SFT<2> of the shift data SFT<4:0> is “0”, the third shift stage 763 does not shift the second shift data SFT2<29:0> and outputs the second shift data SFT2<29:0> as the third shift data SFT3<29:0>. On the other hand, when the third bit SFT<2> of the shift data SFT<4:0> is “1”, the third shift stage 763 shifts the second shift data SFT2<29:0> to the left by 4 bits corresponding to the binary weight of the third bit SFT<2> of the shift data SFT<4:0>, “22”, and outputs the shifted resultant data as the third shift data SFT3<29:0>. In this case, the lower four bits of the third shift data SFT3<29:0> have the binary value of “0”.

The fourth shift stage 764 receives the third shift data SFT3<29:0> that is output from the third shift stage 763, the fourth bit SFT<3> of the shift data SFT<4:0>, and “0” as input. The fourth shift stage 764 performs a shift operation on the third shift data SFT3<29:0> based on the value of the fourth bit SFT<3> of the shift data SFT<4:0> to output the fourth shift data SFT4<29:0>. In an embodiment, when the fourth bit SFT<3> of the shift data SFT<4:0> is “0”, the fourth shift stage 764 does not shift the third shift data SFT3<29:0> and outputs the third shift data SFT3<29:0> as the fourth shift data SFT4<29:0>. On the other hand, when the fourth bit of the shift data SFT<3> is “1”, the fourth shift stage 764 shifts the third shift data SFT3<29:0> to the left by 8 bits corresponding to the binary weight of the fourth bit SFT<3> of the shift data SFT<4:0>, “23”, and outputs the shifted resultant data as the fourth shift data SFT4<29:0>. In this case, the lower eight bits of the fourth shift data SFT4<29:0> have the binary value of “0”.

The fifth shift stage 765 receives the fourth shift data SFT4<29:0> that is output from the fourth shift stage 764, the fifth bit SFT<4> of the shift data SFT<4:0>, and “0” as input. The fifth shift stage 765 performs a shift operation on the fourth shift data SFT4<29:0> based on the value of the fifth bit SFT<4> of the shift data SFT<4:0>, and outputs the fifth shift data SFT5<23:0>. Because the unidirectional mantissa shifter 760 is for normalization operation on the mantissa data, the fifth shift data SFT5<23:0> output from the fifth shift stage 765 has a size of 24 bits. In an embodiment, when the fifth bit SFT<4> of the shift data SFT<4:0> is “0”, the fifth shift stage 765 does not shift the fourth shift data SFT4<29:0> and outputs the upper 24 bits of the fourth shift data SFT4<29:0> as the fifth shift data SFT5<23:0>. On the other hand, when the fifth bit SFT<4> of the shift data SFT<4:0> is “1”, the fifth shift stage 765 shifts the fourth shift data SFT4<29:0> to the left by 16 bits corresponding to “24”, which is the binary weight of the fifth bit of the shift data SFT<4>, and the upper 24 bits of the shifted resultant data are output as the fifth shift data SFT5<23:0>. In this case, the lower ten bits of the fifth shift data SFT5<23:0> have the binary value of “0”.

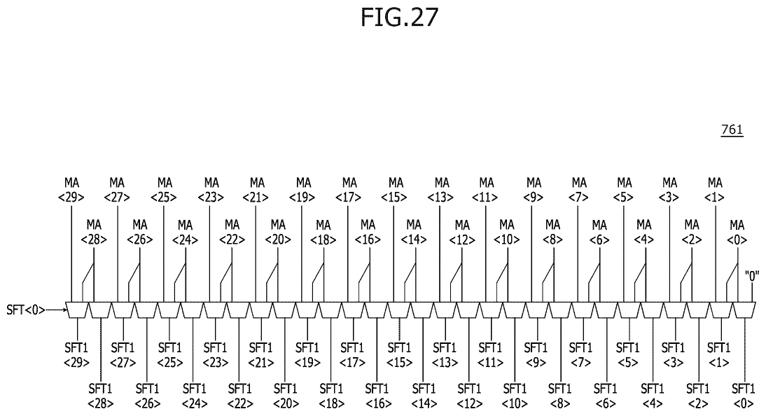

FIG. 27 is a circuit diagram illustrating an example of a first shift stage included in a unidirectional mantissa shifter of FIG. 26.

Referring to FIG. 27, a first shift stage 761 includes a plurality of 2:1 multiplexers. The number of 2:1 multiplexers comprising the first shift stage 761 is equal to the number of bits of the first shift data SFT1<29:0> that is output from the first shift stage 761. Accordingly, the first shift stage 761 includes first to 30th 2:1 multiplexers. The first to 30th 2:1 multiplexers each have a first input terminal, a second input terminal, a selection terminal, and an output terminal. The first to 30th 2:1 multiplexers output first shift data SFT1<29:0> via the output terminals. Hereinafter, a 2:1 multiplexer that outputs the “T” th (“T” being a natural number from 1 to 30) bit SFT1<T−1> of the first shift data SFT1<29:0> will be referred to as a “T”th 2:1 multiplexer. For example, the first 2:1 multiplexer outputs the LSB SFT1<0> of the first shift data SFT1<29:0>. The second 2:1 multiplexer outputs the second bit SFT1<1> of the first shift data SFT1<29:0>. Similarly, the 30th 2:1 multiplexer outputs the MSB SFT1<29> of the first shift data SFT1<29:0>.

The “T”th 2:1 multiplexer receives the “T”th bit MA<T−1> of the mantissa data MA<29:0> through a first input terminal of the “T”th 2:2 multiplexer. For example, the first 2:1 multiplexer receives the LSB MA<0> of the mantissa data MA<29:0> through a first input terminal of the first 2:1 multiplexer. The second 2:1 multiplexer receives the second bit MA<1> of the mantissa data MA<29:0> through a first input terminal of the second 2:1 multiplexer. The third 2:1 multiplexer receives the third bit MA<2> of the mantissa data MA<29:0> through a first input terminal of the third 2:1 multiplexer. In the same manner, the fourth to 30th 2:1 multiplexer receives the fourth bit MA<3> to the MSB MA<29> of the mantissa data MA<29:0> through a first input terminal of corresponding 2:1 multiplexer, respectively. In the second to 30^{th} 2:1 multiplexers other than the first 2:1 multiplexer, the “T”th 2:1 multiplexer receives the “T−1” first bit MA<T−2> of the mantissa data MA<29:0> through a second input terminal of corresponding 2:1 multiplexer. For example, the first 2:1 multiplexer receives a “0” through a second input terminal of the first 2:1 multiplexer. The second 2:1 multiplexer receives the LSB MA<0> of the mantissa data MA<29:0> through a second input terminal of the second 2:1 multiplexer. The third 2:1 multiplexer receives the second bit MA<1> of the mantissa data MA<29:0> through a second input terminal of the third 2:1 multiplexer. In the same manner, the fourth to 30th 2:1 multiplexer receives the third bit MA<2> to the 24th bit MA<28> of the mantissa data MA<29:0> through a second input terminal of corresponding 2:2 multiplexer, respectively. The first to 30th 2:1 multiplexers receive the LSB of the shift data SFT<0> in common through the select terminals.

When the value of the LSB SFT<0> of the shift data is “0”, the first to 30th 2:1 multiplexers output the LSB MA<0> to MSB MA<29> of the mantissa data MA<29:0> that are input through the first input terminal as the first shift data SFT1<29:0>. When the value of the LSB SFT<0> of the shift data is “1”, the first 2:1 multiplexer outputs the “0” that is input through the second input terminal as the LSB SFT1<0> of the first shift data SFT1<29:0>. And the second to 30th 2:1 multiplexers output the LSB MA<0> to the 29th bit MA<28> of the mantissa data MA<29:0> that are input through the second input terminal as the second bit SFT1<1> to the MSB SFT1<29> of the first shift data SFT1<29:0>.

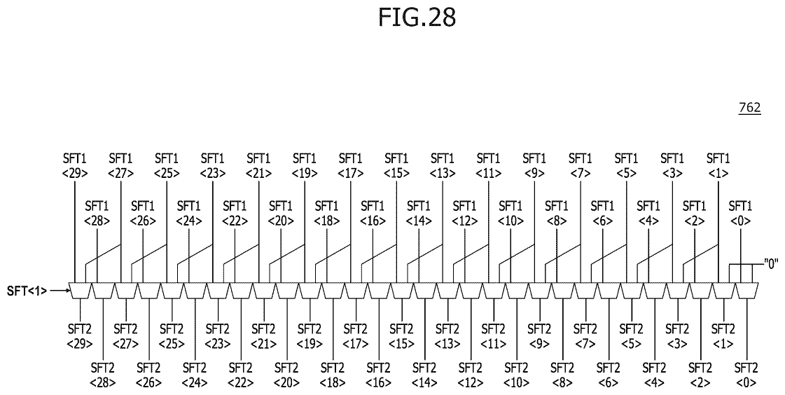

FIG. 28 is a circuit diagram illustrating an example of a second shift stage included in a unidirectional mantissa shifter of FIG. 26.

Referring to FIG. 28, a second shift stage 762, like the first shift stage 761 in FIG. 28, includes a number of first to 30^{th} 2:1 multiplexers equal to the number of bits of second shift data SFT2<29:0> that is output from the second shift stage 762. The first to 30th 2:1 multiplexers of the second shift stage 762 output the second shift data SFT2<29:0> through output terminals. Hereinafter, a 2:1 multiplexer that outputs the “T” th (“T” being a natural number from 1 to 30) bit SFT2<T−1> of the second shift data SFT2<29:0> will be referred to as a first “T”th 2:1 multiplexer. For example, the first 2:1 multiplexer of the second shift stage 762 outputs LSB SFT2<0> of the second shift data SFT2<29:0>. The second 2:1 multiplexer of the second shift stage 762 outputs a second bit SFT2<1> of the second shift data SFT2<29:0>. Similarly, the 30th 2:1 multiplexer of the second shift stage 762 outputs MSB SFT2<29> of the second shift data SFT2<29:0>.

The “T”th 2:1 multiplexer of the second shift stage 762 receives the “T”th bit SFT1<T−1> of the first shift data SFT1<29:0> through a first input terminal of the “T”th 2:1 multiplexer. For example, the first 2:1 multiplexer of the second shift stage 762 receives the LSB SFT1<0> of the first shift data SFT1<29:0> through a first input terminal of the first 2:1 multiplexer. The second 2:1 multiplexer of the second shift stage 762 receives the second bit SFT1<1> of the first shift data SFT1<29:0> through a first input terminal of the second 2:1 multiplexer. The third 2:1 multiplexer of the second shift stage 762 receives the third bit SFT1<2> of the first shift data SFT1<29:0> through a first input terminal of the third 2:1 multiplexer. In the same manner, the fourth to 30th 2:1 multiplexers of the second shift stage 762 receives the fourth bit SFT1<3> to the MSB SFT1<29> of the first shift data SFT1<29:0> through a first input terminal of corresponding 2:1 multiplexer, respectively.

Of the third to 30th 2:1 multiplexers of the second shift stage 762, other than the first and second 2:1 multiplexers of the second shift stage 762, the “T”th 2:1 multiplexer receives a “T−2”th bit SFT1<T−3> of the first shift data SFT1<29:0> through a second input terminal of “T”th 2:1 multiplexer. For example, the first 2:1 multiplexer of the second shift stage 762 receives a “0” input through a second input terminal of the first 2:1 multiplexer. Also, the second 2:1 multiplexer of the second shift stage 762 receive a “0” input through a second input terminal of the second 2:1 multiplexer. The third 2:1 multiplexer of the second shift stage 762 receives the LSB SFT1<0> of the first shift data SFT1<29:0> through a second input terminal of the third 2:1 multiplexer. The fourth 2:1 multiplexer of the second shift stage 762 receives the second bit SFT1<1> of the first shift data SFT1<29:0> through a second input terminal of the fourth 2:1 multiplexer. In the same manner, the fifth to 30th 2:1 multiplexer of the second shift stage 762 receive the third bit SFT1<2> to the 28th bit SFT1<27> of the first shift data SFT1<29:0>, respectively, through a second input terminal of corresponding 2:1 multiplexer. The first to 30th 2:1 multiplexer of the second shift stage 762 receives the second bit SFT<1> of the shift data in common through a select terminal of corresponding 2:1 multiplexer.

When the value of the second bit SFT<1> of the shift data is “0”, the first to 30th 2:1 multiplexers output the LSB SFT1<0> to MSB SFT1<29> of the first shift data SFT1<29:0> that are input through the first input terminal as the second shift data SFT2<29:0>. When the value of the second bit SFT<1> of the shift data is “1”, the first 2:1 multiplexer of the second shift stage 762 outputs the “0” that is input through the second input terminal of the first 2:1 multiplexer as the LSB SFT2<0> of the second shift data SFT2<29:0>. Also, the second 2:1 multiplexer of the second shift stage 762 outputs the “0” that is input through the second input terminal of the second 2:1 multiplexer as the second bit SFT2<1> of the second shift data SFT2<29:0>. Then, the third to 30th 2:1 multiplexers of the second shift stage 762 output the LSB SFT1<29:0> to the 28th bit SFT1<27> of the first shift data SFT1<0> as the third bit SFT2<2> to the MSB SFT2<29> of the second shift data SFT2<29:0>.

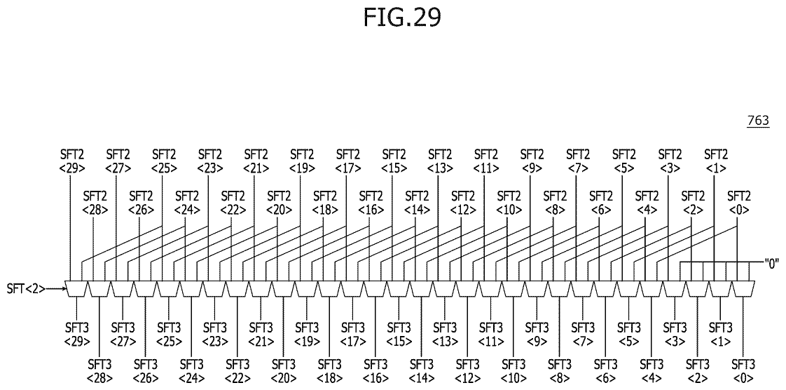

FIG. 29 is a circuit diagram illustrating an example of a third shift stage included in a unidirectional mantissa shifter of FIG. 26.

Referring to FIG. 29, a third shift stage 763, like the first shift stage 761 in FIG. 27 and the second shift stage 762 in FIG. 28, includes a number of first to 30th 2:1 multiplexers equal to the number of bits of third shift data SFT3<29:0> that are output from the third shift stage 763. The first to 30th 2:1 multiplexers of the third shift stage 763 output the third shift data SFT3<29:0> through output terminals of the first to 30th 2:1 multiplexers. Hereinafter, a 2:1 multiplexer that outputs a “T”th (“T” being a natural number from 1 to 30) bit SFT3<T−1> of the third shift data SFT3<29:0> will be referred to as a “T”th 2:1 multiplexer. For example, the first 2:1 multiplexer of the third shift stage 763 outputs a LSB SFT3<0> of the third shift data SFT3<29:0>. The second 2:1 multiplexer of the third shift stage 763 outputs a second bit SFT3<1> of the third shift data SFT3<29:0>. Similarly, the 30th 2:1 multiplexer of the third shift stage 763 outputs MSB SFT3<29> of the third shift data SFT3<29:0>.

The “T”th 2:1 multiplexer of the third shift stage 763 receives the “T”th bit SFT2<T−1> of the second shift data SFT2<29:0> through a first input terminal. For example, the first 2:1 multiplexer of the third shift stage 763 receives the LSB SFT2<0> of the second shift data SFT2<29:0> through a first input terminal. The second 2:1 multiplexer of the third shift stage 763 receives the second bit SFT2<1> of the second shift data SFT2<29:0> through a first input terminal. The third 2:1 multiplexer of the third shift stage 763 receives the third bit SFT2<2> of the second shift data SFT2<29:0> through a first input terminal. In the same manner, the fourth to 30th 2:1 multiplexers of the third shift stage 763 receive the fourth bit SFT2<3> to the MSB SFT2<29> of the second shift data SFT2<29:0>, respectively, through a first input terminal of corresponding 2:1 multiplexer.

Of the fifth to 30th 2:1 multiplexers of the third shift stage 763, other than the first to fourth 2:1 multiplexers of the third shift stage 763, the “T”th 2:1 multiplexer receives the “T−4”th bit SFT2<T−5> of the second shift data SFT2<29:0> through a second input terminal of the “T”th 2:1 multiplexer. For example, the first to fourth 2:1 multiplexers of the third shift stage 763 receive a “0” input through second input terminals of the first to fourth 2:1 multiplexers. The fifth 2:1 multiplexer of the third shift stage 763 receives the LSB SFT2<0> of the second shift data SFT2<29:0> through a second input terminal of the fifth 2:1 multiplexer. The sixth 2:1 multiplexer of the third shift stage 763 receives the second bit SFT2<1> of the second shift data SFT2<29:0> through a second input terminal of the sixth 2:1 multiplexer. In the same manner, the seventh to 30th 2:1 multiplexers of the third shift stage 763 receive the third bit SFT2<2> to 26th bit SFT2<25> of the second shift data SFT2<29:0>, respectively, through a second input terminal of corresponding 2:1 multiplexer. The first to 30th 2:1 multiplexers of the third shift stage 763 receive the third bit SFT<2> of the shift data in common through select terminals of the first to 30th 2:1 multiplexers.

When the value of the third bit SFT<2> of the shift data is “0”, the first to 30th 2:1 multiplexers output the LSB SFT2<0> to the MSB SFT2<29> of the second shift data SFT2<29:0> that are input through the first input terminals as the third shift data SFT3<29:0>. When the value of the third bit of the shift data SFT<2> is “1”, the first 2:1 multiplexer, the second 2:1 multiplexer, the third 2:1 multiplexer, and the fourth 2:1 multiplexer, respectively, output the “0” as a LSB SFT3<0>, a second bit SFT3<1>, a third bit SFT3<2>, and a fourth bit SFT3<3> of the third shift data SFT3<29:0>. Then, the fifth to 30th 2:1 multiplexers of the third shift stage 763 output the LSB SFT2<29:0> to the 26th bit SFT2<25> of the second shift data SFT2<29:0> as a fifth bit SFT3<4> to a MSB SFT3<29> of the third shift data SFT3<29:0>.

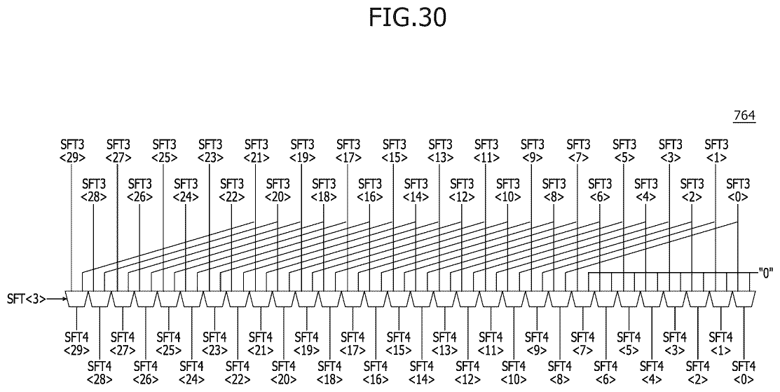

FIG. 30 is a circuit diagram illustrating an example of a fourth shift stage included in a unidirectional mantissa shifter of FIG. 26.

Referring to FIG. 30, the fourth shift stage 764, like the first through third shift stages 761-763, includes a number of first through 30th 2:1 multiplexers equal to the number of bits of fourth shift data SFT4<29:0> that are output from the fourth shift stage 764. The first to 30th 2:1 multiplexers of the fourth shift stage 764 output the fourth shift data SFT4<29:0> through the output terminals of the first to 30th 2:1 multiplexers. Hereinafter, a 2:1 multiplexer that outputs the “T”th (“T” being a natural number from 1 to 30) bit SFT4<T−1> of the fourth shift data SFT4<29:0> will be referred to as a “T”th 2:1 multiplexer. For example, the first 2:1 multiplexer of the fourth shift stage 764 outputs a LSB SFT4<0> of the fourth shift data SFT4<29:0>. The second 2:1 multiplexer of the fourth shift stage 764 outputs a second bit SFT4<1> of the fourth shift data SFT4<29:0>. Similarly, the 30th 2:1 multiplexer of the fourth shift stage 764 outputs a MSB SFT4<29> of the fourth shift data SFT4<29:0>.

The “T”th 2:1 multiplexer of the fourth shift stage 764 receives the “T”th bit SFT3<T−1> of the third shift data SFT3<29:0> through a first input terminal of the “T”th 2:1 multiplexer. For example, the first 2:1 multiplexer of the fourth shift stage 764 receives the LSB SFT3<0> of the third shift data SFT3<29:0> through a first input terminal of the first 2:1 multiplexer. The second 2:1 multiplexer of the fourth shift stage 764 receives the second bit SFT3<1> of the third shift data SFT3<29:0> through a first input terminal of the second 2:1 multiplexer. The third 2:1 multiplexer of the fourth shift stage 764 receives the third bit SFT3<2> of the third shift data SFT3<29:0> through a first input terminal of the third 2:1 multiplexer. In the same manner, the fourth to 30th 2:1 multiplexers of the fourth shift stage 764 receives the fourth bit SFT3<3> to the MSB SFT3<29> of the third shift data SFT3<29:0> via first input terminals of the fourth to 30th 2:1 multiplexers, respectively.

Of the ninth through 30th 2:1 multiplexers of the fourth shift stage 764, other than the first through eighth 2:1 multiplexers of the fourth shift stage 764, the “T”th 2:1 multiplexer receives a “T−8”th bit SFT3<T−9> of the third shift data SFT3<29:0> through a second input terminal of the “T”th 2:1 multiplexer. For example, the first through eighth 2:1 multiplexers of the fourth shift stage 764 receive a “0” through second input terminals of the first through eighth 2:1 multiplexers. The ninth 2:1 multiplexer of the fourth shift stage 764 receives the LSB SFT3<0> of the third shift data SFT3<29:0> through a second input terminal of the ninth 2:1 multiplexer. The sixth 2:1 multiplexer of the fourth shift stage 764 receives the second bit SFT3<1> of the third shift data SFT3<29:0> through a second input terminal of the sixth 2:1 multiplexer. In the same manner, the 11th to 30th 2:1 multiplexer of the fourth shift stage 764 receive the third bit SFT3<2> to the 22nd bit SFT3<21> of the third shift data SFT3<29:0>, respectively, through second input terminals of the 11th to 30th 2:1 multiplexer. The first through 30th 2:1 multiplexers of the fourth shift stage 764 receive the fourth bit SFT<3> of the shift data in common through select terminals of the first through 30th 2:1 multiplexers.

When the value of the fourth bit SFT<3> of the shift data is “0”, the first to 30th 2:1 multiplexers output the LSB SFT3<0> to MSB SFT3<29> of the third shift data SFT3<29:0> as the fourth shift data SFT4<29:0>. When the value of the fourth bit SFT<3> of the shift data is “1”, the first to eighth 2:1 multiplexers of the fourth shift stage 764 output the “0” as a LSB SFT4<0> to a eighth bit SFT4<7> of the fourth shift data SFT4<29:0>, respectively. Then, the ninth to 30th 2:1 multiplexers of the fourth shift stage 764 output the LSB SFT3<0> to the 22th bit SFT3<7> of the third shift data SFT3<29:0> as a ninth bit SFT4<8> to a MSB SFT4<29> of the fourth shift data SFT4<29:0>.

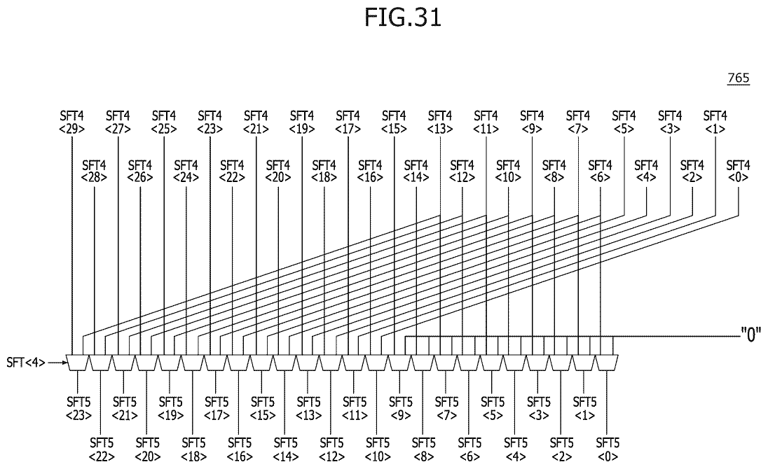

FIG. 31 is a circuit diagram illustrating an example of a fifth shift stage included in a unidirectional mantissa shifter of FIG. 26.

Referring to FIG. 31, a fifth shift stage 765 includes a first to 24th 2:1 multiplexers having a number of bits equal to the number of bits of the fifth shift data SFT5<23:0> that are output from the fifth shift stage 765. The first to 24th 2:1 multiplexers of the fifth shift stage 765 output the fifth shift data SFT5<23:0>, which is the output data from the unidirectional mantissa shifter 760 of FIG. 26, through output terminals of the first to 24th 2:1 multiplexers. Hereinafter, a 2:1 multiplexer that outputs a “T”th (“T” being a natural number from 1 to 24) bit SFT5<T−1> of the fifth shift data SFT5<23:0> will be referred to as a “T”th 2:1 multiplexer. For example, the first 2:1 multiplexer of the fifth shift stage 765 outputs the LSBs SFT5<0> of the fifth shift data SFT5<23:0>. The second 2:1 multiplexer of the fifth shift stage 765 outputs the second bit SFT5<1> of the fifth shift data SFT5<23:0>. Similarly, the 24th 2:1 multiplexer of the fifth shift stage 765 outputs the MSB SFT5<23> of the fifth shift data SFT5<23:0>.

The “T”th 2:1 multiplexer of the fifth shift stage 765 receives the “T+6”th bit SFT4<T+5> of the fourth shift data SFT4<29:0> through a first input terminal of the “T”th 2:1 multiplexer. For example, the first 2:1 multiplexer of the fifth shift stage 765 receives the seventh bit SFT4<6> of the fourth shift data SFT4<29:0> through a first input terminal of the first 2:1 multiplexer. The second 2:1 multiplexer of the fifth shift stage 765 receives the eighth bit SFT4<7> of the fourth shift data SFT4<29:0> through a first input terminal of the second 2:1 multiplexer. The third 2:1 multiplexer of the fifth shift stage 765 receives the ninth bit SFT4<8> of the fourth shift data SFT4<29:0> through a first input terminal of the third 2:1 multiplexer. In the same manner, the fourth to 24th 2:1 multiplexers of the fifth shift stage 765 receive the 10th bit SFT4<9> to the MSB SFT4<29> of the fourth shift data (SFT4<29:0>) through first input terminals of the fourth to 24th 2:1 multiplexers.

Of the 11th to 23rd 2:1 multiplexers of the fifth shift stage 765, other than the first to 10th 2:1 multiplexers of the fifth shift stage 765, the “T”th (where “T” is a natural number from 11 through 24) 2:1 multiplexer receives the “T−10”th bit SFT3<T−11> of the fourth shift data SFT4<29:0> through a second input terminal of the “T”th 2:1 multiplexer. For example, the first to 10th 2:1 multiplexers of the fifth shift stage 765 receive a “0” input through second input terminals of the first to 10th 2:1 multiplexers. The 11th 2:1 multiplexer of the fifth shift stage 765 receives the LSB SFT4<0> of the fourth shift data SFT4<29:0> through a second input terminal of the 11th 2:1 multiplexer. The 12th 2:1 multiplexer of the fifth shift stage 765 receives the second bit SFT4<1> of the fourth shift data SFT4<29:0> through a second input terminal of the 12th 2:1 multiplexer. In the same manner, the 13th to 24th 2:1 multiplexers of the fifth shift stage 765 receive the third bit SFT4<2> to the 14th bit SFT4<13> of the fourth shift data SFT4<29:0>, respectively, through second input terminals of the 13th to 24th 2:1 multiplexers. The first to 24th 2:1 multiplexers of the fifth shift stage 765 receive the fifth bit of the shift data SFT<4> in common through select terminals of the first to 24th 2:1 multiplexers.

When the value of the fifth bit SFT<4> of the shift data is “0”, the first to 24th 2:1 multiplexers output the seventh bit SFT4<6> to the MSB SFT4<29> of the fourth shift data SFT4<29:0> as the fifth shift data SFT5<23:0>. When the value of the fifth bit SFT<4> of the shift data is “1”, the first to 10th 2:1 multiplexers of the fifth shift stage 765 output the “0” as a LSB SFT5<0> to a tenth bit SFT5<9> of the fifth shift data SFT5<23:0>. Then, the 11th to 24th 2:1 multiplexers of the fifth shift stage 765 output the LSB SFT4<29:0> to the 14th bit SFT4<13> of the fourth shift data SFT4<23:0> as a 11th bit SFT5<10> to a MSB SFT5<23> of the fifth shift data SFT5<23:0>.

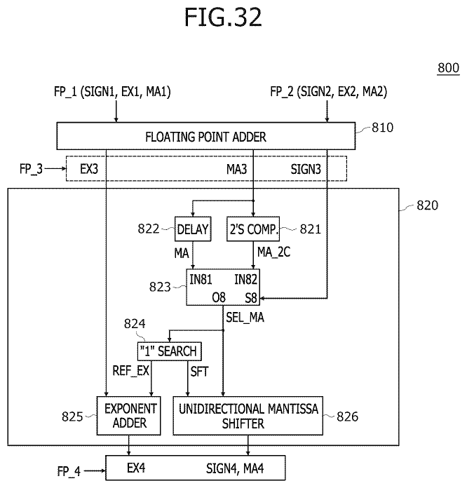

FIG. 32 is a block diagram illustrating a floating-point addition circuit including a normalizer according to an embodiment of the present disclosure.

Referring to FIG. 32, a floating-point addition circuit 800 includes a floating-point adder 810 and a normalizer 820. The floating-point adder 810 receives first floating-point data FP_1 and second floating-point data FP_2 as first operands and second operands, respectively. The first floating-point data FP_1 has first sign data SIGN1, first exponent data EX1, and first mantissa data MA1. The second floating-point data FP_2 has second sign data SIGN2, second exponent data EX2, and second mantissa data MA2. In an embodiment, the first floating-point data FP_1 and the second floating-point data FP_2 may each be in a normalized format, such as IEEE 754 32-bit single precision (FP32) format. In this case, the number of bits of the first sign data SIGN1, the number of bits of the first exponent data EX1, and the number of bits of the first mantissa data MA1 of the first floating-point data FP_1 are the same as the number of bits of the second sign data SIGN2, the number of bits of the second exponent data EX2, and the number of bits of the second mantissa data MA2 of the second floating-point data FP_2, respectively. Thus, the first floating-point data FP_1 consists of the first sign data SIGN1 of 1 bit, the first exponent data EX1 of 8 bits, and the first mantissa data MA1 (including a hidden bit) of 24 bits. Similarly, the second floating-point data FP_2 consists of the second sign data SIGN2 of 1 bit, the second exponent data EX2 of 8 bits, and the second mantissa data MA2 of 24 bits (including a hidden bit).

In another embodiment, the number of bits of the first exponent data EX1 and the number of bits of the first mantissa data MA1 of the first floating-point data FP_1 may be different from the number of bits of the second exponent data EX2 and the number of bits of the second mantissa data MA2 of the second floating-point data FP_2, respectively. For example, when the floating-point adder circuit 800 is used as an accumulator in a multiplication-accumulation (MAC) circuit, the first floating-point data FP_1 may be generated by multiplication operations in a multiplication circuit and addition operations in an adder tree, and the second floating-point data FP_2 may be in a latched floating-point format that is output from the normalizer 820. In this case, the first floating-point data FP_1 may comprise the first sign data SIGN1 of 1 bit, the first exponent data EX1 of 8 bits, and the first mantissa data MA1 of bit numbers greater than 24 bits. The bit numbers of the first mantissa data MA1 of the first floating-point data FP_1 may be increased by the carry bits generated by the addition operations on the adders included in the adder tree. The second floating-point data FP_2 that is output from the normalizer 820, latched and fed back to the floating-point adder 810, may comprise the second sign data SIGN2 of 1 bit, the second exponent data EX2 of bit numbers greater than 8 bits, and the second mantissa data MA2 of 24 bits (including hidden bits). In other words, the number of bits of the second exponent data EX2 of the second floating-point data FP_2 may be increased by an addition operation in an exponent adder 825 of the normalizer 820.

The floating-point adder 810 performs an addition operation on the first floating-point data FP_1 and the second floating-point data FP_2 and outputs third floating-point data FP_3. The third floating-point data FP_3 has third sign data SIGN3, third exponent data EX3, and third mantissa data MA3. The third floating-point data FP_3 is transferred from the floating-point adder 810 to the normalizer 820. When the first floating-point data FP_1 and the second floating-point data FP_2 have the same number of bits of sign data, exponent data, and mantissa data, the number of bits of the third exponent data EX3 of the third floating-point data FP_3 may be the same as the number of bits of the first exponent data EX1 of the first floating-point data FP_1 (and the number of bits of the second exponent data EX2 of the second floating-point data FP_2). And the number of bits of the third mantissa data MA3 of the third floating-point data FP_3 may be one more than the number of bits of the first mantissa data MA1 of the first floating-point data FP_1 (and the number of bits of the second mantissa data MA2 of the second floating-point data FP_2). When the first floating-point data FP_1 and the second floating-point data FP_2 have different bit numbers of exponent data and mantissa data, the number of bits of the third exponent data EX3 of the third floating-point data FP_3 may be the same as the number of bits of the second exponent data EX2 of the second floating-point data FP_2. And the number of bits of the third mantissa data MA3 of the third floating-point data FP_3 may be one more than the number of bits of the first mantissa data MA1 of the first floating-point data FP_1.

The normalizer 820 of the floating-point adder circuit 800 may be configured similarly to a normalizer 700 of FIG. 21 described with reference to FIG. 21. Accordingly, the normalizer 820 may include a 2's complement circuit 821, a delay circuit 822, a multiplexer 823, a “1” search circuit 824, an exponent adder 825, and a unidirectional mantissa shifter 826. The descriptions of the 2's complement circuit 710 of FIG. 21, the delay circuit 720 of FIG. 21, the multiplexer 730 of FIG. 21, the “1” search circuit 740 of FIG. 21, the exponent adder 750 of FIG. 21, and the unidirectional mantissa shifter 760 of FIG. 21 of the normalizer 700 of FIG. 21 may be equally applied to the 2's complement circuit 821, the delay circuit 822, the multiplexer 823, the “1” search circuit 824, the exponent adder 825, and the unidirectional mantissa shifter 826 of the normalizer 820, respectively. Similarly, the configuration and operation of the “1” search circuit 740A of FIG. 22 and the “1” search circuit 740B of FIG. 23 described with reference to FIG. 22 may be equally applied to the “1” search circuit 824 of the normalizer 820. The third sign data SIGN3, the third exponent data EX3, and the third mantissa data MA3 of the third floating-point data FP_3 that are input to the normalizer 820 correspond to the sign data SIGN, the exponent data EX, and the mantissa data MA of the floating-point data FP_DATA described with reference to FIG. 21, respectively. The normalizer 820 outputs fourth floating-point data FP_4 by performing the normalization operation described with reference to FIG. 21. The fourth floating-point data FP_4 has fourth sign data SIGN4, fourth exponent data EX4, and fourth mantissa data MA4.

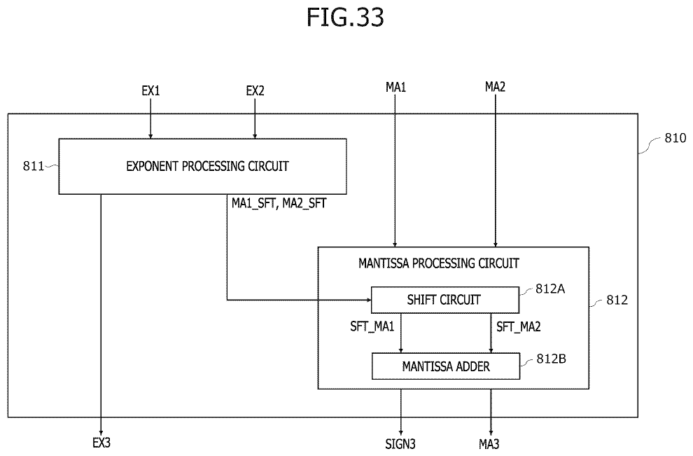

FIG. 33 is a block diagram illustrating an example of a floating-point adder included in a floating-point addition circuit of FIG.

Referring to FIG. 33, a floating-point adder 810 includes an exponent processing circuit 811 and a mantissa processing circuit 812. The exponent processing circuit 811 receives the first exponent data EX1 of the first floating-point data FP_1 of FIG. 32 and the second exponent data EX2 of the second floating-point data FP_2 of FIG. 32 as inputs. The exponent processing circuit 811 performs a subtraction operation and sign processing on the first exponent data EX1 and the second exponent data EX2, and outputs first mantissa shift data MA1_SFT and second mantissa shift data MA2_SFT. Further, the exponent processing circuit 811 performs a selection operation on the first exponent data EX1 and the second exponent data EX2, and outputs third exponent data EX3.

The mantissa processing circuit 812 includes a shift circuit 812A and a mantissa adder 812B. The shift circuit 812A of the mantissa processing circuit 812 receives the first mantissa data MA1 of the first floating-point data FP_1 in FIG. 32 and the second mantissa data MA2 of the second floating-point data FP_2 in FIG. 32 as inputs. The shift circuit 812A also receives the first mantissa shift data MA1_SFT and the second mantissa shift data MA2_SFT from the exponent processing circuit 811. The shift circuit 812A generates shifted first mantissa data SFT_MA1 by shifting the first mantissa data MA1<23:0> by a number of bits corresponding to the decimal number of the first mantissa shift data MA1_SFT. The shift circuit 812A also generates shifted second mantissa data SFT_MA2 by shifting the second mantissa data MA2 by a number of bits corresponding to the decimal number of the second mantissa shift data MA2_SFT. The mantissa adder 812B adds the shifted first mantissa data SFT_MA1 and the shifted second mantissa data SFT_MA2, and outputs the third sign data SIGN3 and the third mantissa data MA3.

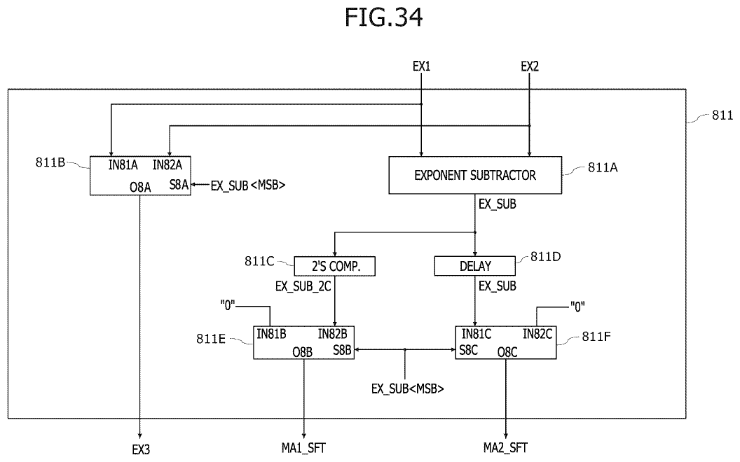

FIG. 34 is a block diagram illustrating an example of an exponent processing circuit included in a floating-point adder of FIG. 33.

Referring to FIG. 34, an exponent processing circuit 811 includes an exponent subtractor 811A, a first multiplexer 811B, a 2's complement circuit 811C, a delay circuit 811D, a second multiplexer 811E, and a third multiplexer 811F.

The exponent subtractor 811A receives the first exponent data EX1 and the second exponent data EX2. The exponent subtractor 811A performs a subtraction operation to subtract the second exponent data EX2 from the first exponent data EX1, and outputs the result of the subtraction operation as exponent subtraction data EX_SUB. The exponent subtractor 811A transmits the exponent subtraction data EX_SUB to the 2's complement circuit 811C and the delay circuit 811D. The exponent subtractor 811A transmits a most significant bit EX_SUB<MSB> of the exponent subtraction data EX_SUB to a selection terminal S8A of the first multiplexer 811B, a selection terminal S8B of the second multiplexer 811E, and a selection terminal S8C of the third multiplexer 811F. When the first exponent data EX1 has a value greater than the second exponent data EX2, the most significant bit EX_SUB<MSB> of the exponent subtraction data EX_SUB has a binary value of “0”. On the other hand, when the second exponent data EX2 has a value greater than the first exponent data EX1, the most significant bit EX_SUB<MSB> of the exponent subtraction data EX_SUB has a binary value of “1”.

The first multiplexer 811B receives the first exponent data EX1 and the second exponent data EX2 through a first input terminal IN81A and a second input terminal IN82A, respectively. The first multiplexer 811B receives the most significant bit EX_SUB<MSB> of the exponent subtraction data EX_SUB through the selection terminal S8A. The first multiplexer 811B outputs one of the first exponent data EX1 and the second exponent data EX2 as the third exponent data EX3 based on the most significant bit EX_SUB<MSB> of the exponent subtraction data EX_SUB through an output terminal 08A. In an embodiment, when the most significant bit EX_SUB<MSB> of the exponent subtraction data EX_SUB transmitted to the selection terminal S8A of the first multiplexer 811B is “0”, i.e., when the first exponent data EX1 is greater than the second exponent data EX2, the first multiplexer 811B outputs the first exponent data EX1 as the third exponent data EX3. On the other hand, when the most significant bit EX_SUB<MSB> of the exponent subtraction data EX_SUB transmitted to the selection terminal S8A of the first multiplexer 811B is “1”, i.e., when the second exponent data EX2 is greater than the first exponent data EX1, the first multiplexer 811B outputs the second exponent data EX2 as the third exponent data EX3.

The 2's complement circuit 811C generates and outputs 2's complement data EX_SUB_2C of the exponent subtraction data EX_SUB that is output from the exponent subtractor 811A. The 2's complement circuit 811C transmits the 2's complement data EX_SUB_2C of the exponent subtraction data to the second multiplexer 811E. The delay circuit 811D outputs the exponent subtraction data EX_SUB that is output from the exponent subtractor 811A after a certain time delay, and transmits the exponent subtraction data EX_SUB to the third multiplexer 811F. The delay time in the delay circuit 811D may be set to the time required to generate the 2's complement data EX_SUB_2C of the exponent subtraction data in the 2's complement circuit 811C.

The second multiplexer 811E receives “0” through a first input terminal IN81B, and receives the 2's complement data EX_SUB_2C of the exponent subtraction data that is output from the 2's complement circuit 811C through a second input terminal IN82B. When the binary value of “0” as the most significant bit EX_SUB<MSB> of the exponent subtraction data EX_SUB is transmitted to the selection terminal S8B of the second multiplexer 811E, the second multiplexer 811E outputs the “0” that is transmitted to the first input terminal IN81B as first mantissa shift data MA1_SFT through an output terminal 08B. On the other hand, when the binary value of “1” as the most significant bit EX_SUB<MSB> of the exponent subtraction data EX_SUB is transmitted to the selection terminal S8B of the second multiplexer 811E, the second multiplexer 811E outputs the 2's complement data EX_SUB_2C of the exponent subtraction data that is transmitted to the second input terminal IN82B as the first mantissa shift data MA1_SFT through the output terminal 08B.

The third multiplexer 811F receives the exponent subtraction data EX_SUB that is output from the delay circuit 811D through a first input terminal IN81C, and receives “0” through a second input terminal IN82C. When the binary value of “0” as the most significant bit EX_SUB<MSB> of the exponent subtraction data EX_SUB is transmitted to the selection terminal (S8C) of the third multiplexer 811F, the third multiplexer 811F outputs the exponent subtraction data EX_SUB that is transmitted to the first input terminal IN81B as second mantissa shift data MA2_SFT through an output terminal 08C. On the other hand, when the binary value of “1” as the most significant bit EX_SUB<MSB> of the exponent subtraction data EX_SUB is transmitted to the selection terminal S8C of the third multiplexer 811F, the third multiplexer 811F outputs the “0” that is transmitted to the second input terminal IN82C as the second mantissa shift data MA2_SFT through the output terminal 08C.

As described above, when the first exponent data EX1 is greater than the second exponent data EX2, the first exponent data EX1 is output as the third exponent data EX3 through the first multiplexer 811B. Then, “0” is output as the first mantissa shift data MA1_SFT through the second multiplexer 811E, and the exponent subtraction data EX_SUB is output as the second mantissa shift data MA2_SFT through the third multiplexer 811F. On the other hand, when the second exponent data EX2 is greater than the first exponent data EX1, the second exponent data EX2 is output as the third exponent data EX3 through the first multiplexer 811B. Then, the 2's complement data EX_SUB_2C of the exponent subtraction data is output as the first mantissa shift data MA1_SFT through the second multiplexer 811E, and “0” is output as the second mantissa shift data MA2_SFT through the third multiplexer 811F.

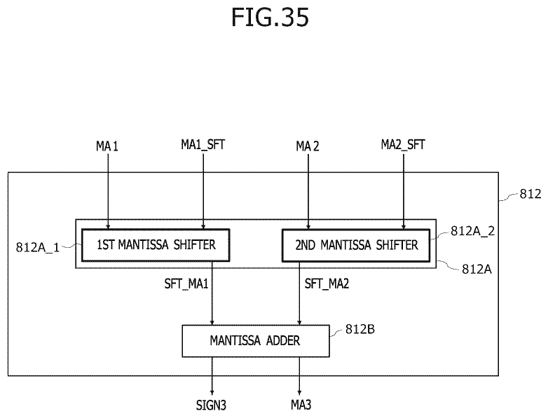

FIG. 35 is a block diagram illustrating an example of a mantissa processing circuit included in a floating-point adder of FIG. 33.

Referring to FIG. 35, a mantissa processing circuit 812 includes a mantissa shift circuit 812A and a mantissa adder 812B. The mantissa shift circuit 812A includes a first mantissa shifter 812A_1, and a second mantissa shifter 812A_2.

The first mantissa shifter 812A_1 of the mantissa shift circuit 812A receives the first mantissa data MA1 of the first floating-point data FP_1 of FIG. 32 and the first mantissa shift data MA1_SFT that is output from the second multiplexer 811E of the exponent processing circuit 811 of FIG. 34. The first mantissa shifter 812A_1 shifts the first mantissa data MA1 by the number of first bits corresponding to the decimal value of the first mantissa shift data MA1_SFT, and outputs the shifted first mantissa data SFT_MA1. When the first mantissa shift data MA1_SFT is “0”, the shifted first mantissa data SFT_MA1 that is output from the first mantissa shifter 812A_1 is the same as the first mantissa data MA1. On the other hand, when the first mantissa shift data MA1_SFT is the 2's complement data EX_SUB_2C in FIG. 34 of the exponent subtraction data, the shifted first mantissa data SFT_MA1 that is output from the first mantissa shifter 812A_1 is generated by shifting the first mantissa data MA1 in the right direction by the number of first bits corresponding to the decimal value of the 2's complement data EX_SUB_2C in FIG. 34.

The second mantissa shifter 812A_2 of the mantissa shift circuit 812A receives the second mantissa data MA2 of the second floating-point data FP_2 of FIG. 32 and the second mantissa shift data MA2_SFT that is output from the third multiplexer 811F of the exponent processing circuit 811 of FIG. 34. The second mantissa shifter 812A_2 shifts the second mantissa data MA2 by the number of second bits corresponding to the decimal value of the second mantissa shift data MA2_SFT, and outputs the shifted second mantissa data SFT_MA2. When the second mantissa shift data MA2_SFT is “0”, the shifted second mantissa data SFT_MA2 that is output from the second mantissa shifter 812A_2 is the same as the second mantissa data MA2. On the other hand, when the second mantissa shift data MA2_SFT is the exponent subtraction data EX_SUB in FIG. 34, the shifted second mantissa data SFT_MA2 that is output from the second mantissa shifter 812A_2 is generated by shifting the second mantissa data MA2 in the right direction by a number of two bits corresponding to the decimal value of the exponent subtraction data EX_SUB in FIG. 34.

The mantissa adder 812B of the mantissa processing circuit 812 receives the shifted first mantissa data SFT_MA1 that is output from the first mantissa shifter 812A_1 and the shifted second mantissa data SFT_MA2 that is output from the second mantissa shifter 812A_2. The mantissa adder 812B performs an addition operation on the shifted first mantissa data SFT_MA1 and the shifted second mantissa data SFT_MA2, and outputs the third mantissa data MA3. The number of bits in the third mantissa data MA3 is one more than the number of bits in the shifted first mantissa data SFT_MA1 (or the number of bits in the shifted second mantissa data SFT_MA2) due to the addition of a carry bit during the addition operation. Although not shown, the mantissa adder 812B may receive the first sign data SIGN1 in FIG. 32 of the first floating-point data FP_1 in FIG. 32 and the second sign data SIGN2 in FIG. 32 of the second floating-point data FP_2 in FIG. 32. The mantissa adder 812B generates and outputs the third sign data SIGN3 based on the first sign data SIGN1 of FIG. 32 and the second sign data SIGN2 of FIG. 32.

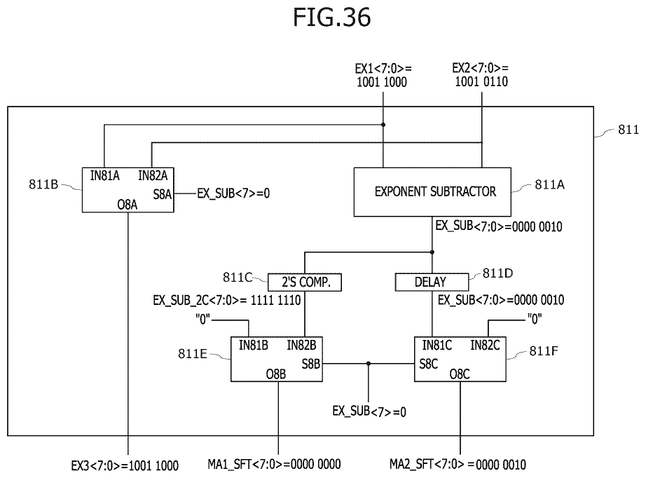

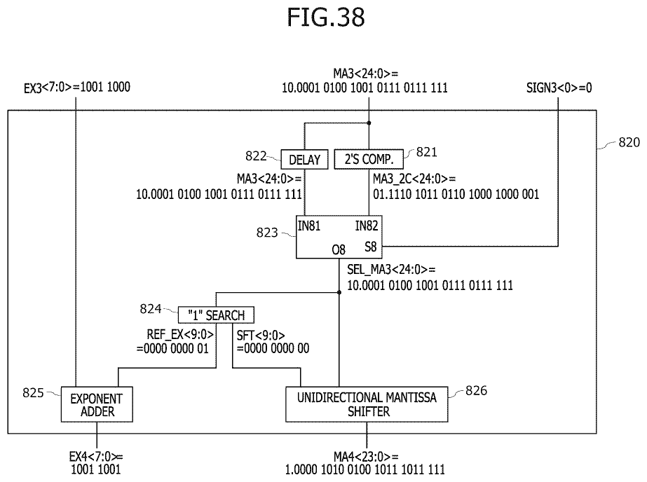

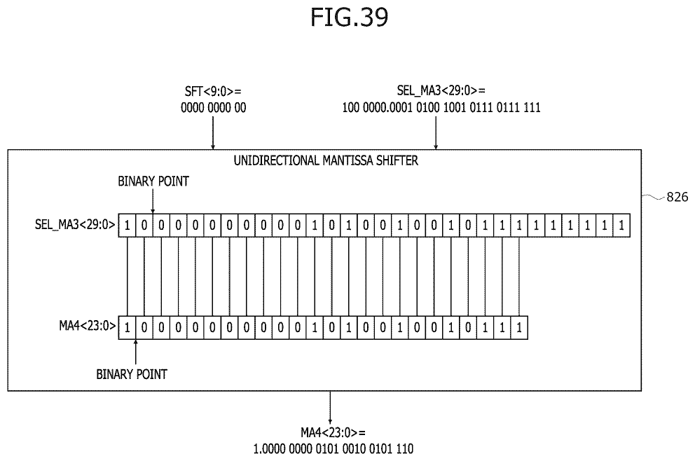

FIGS. 36 to 38 are block diagrams for explaining operations of a floating-point adder of FIG. 33. And FIG. 39 is a diagram illustrating an operation of a unidirectional mantissa shifter included in a normalizer of FIG. 38. In FIGS. 36 to 38, the same reference numerals as in FIGS. 32 to 35 refer to the same element, and redundant descriptions will be omitted. In the examples of FIGS. 36 to 39, it is assumed that the first floating-point data FP_1 of FIG. 32 and the second floating-point data FP_2 of FIG. 32 input to the floating-point adder 810 of FIG. 32 have the same number of bits of sign data, exponent data, and mantissa data. In the examples of FIGS. 36 to 39, the first floating-point data FP_1 of FIG. 32 comprises the first sign data SIGN1<0> of “0”, the first exponent data EX1<7:0> of “1001 1000”, and the mantissa data MA1<23:0>) of “1.1100 1011 0010 1000 0101 011” (including a hidden bit). Also, the second floating-point data FP_2 in FIG. 32 comprises the second sign data SIGN2<0> of “0”, the second exponent data EX2<7:0> of “1001 0110”, and the second mantissa data MA2<23:0> of “1.0010 0101 1011 1100 1010 000” (including a hidden bit).

Referring to FIG. 36, the exponent subtractor 811A of the exponent processing circuit 811 included in the floating-point adder 810 of FIG. 33 outputs “0000 0010” as the exponent subtraction data EX_SUB<7:0> that subtracts of the second exponent data EX2<7:0> from the first exponent data EX1<7:0>. The exponent subtraction data EX_SUB<7:0> of “0000 0010” that is output from the exponent subtractor 811A is transmitted to the 2's complement circuit 811C and the delay circuit 811D. And the most significant bit EX_SUB<7> “0” of the exponent subtraction data EX_SUB<7:0> is transmitted to the first multiplexer 811B, the second multiplexer 811E, and the third multiplexer 811F. Because the most significant bit EX_SUB<7> of the exponent subtraction data, “0” is input through the selection terminal S8A, the first multiplexer 811B outputs the first exponent data EX1<7:0> transmitted through the first input terminal IN81A as the third exponent data EX3<7:0>. Accordingly, the first multiplexer 811B outputs “1001 1000” as the third exponent data EX3<7:0>.

The 2's complement circuit 811C outputs “1111 1110”, which is the 2's complement of the exponent subtraction data EX_SUB<7:0> “0000 0010”, as the 2's complement data EX_SUB_2C<7:0> of the exponent subtraction data. The delay circuit 811D outputs the exponent subtraction data EX_SUB<7:0> “0000 0010”. Because the most significant bit EX_SUB<7> of the exponent subtraction data, “O” is input through the selection terminal S8B, the second multiplexer 811E outputs “0” that is input through the first input terminal IN81B. In other words, the second multiplexer 811E outputs “0000 0000” as the first mantissa shift data MA1_SFT<7:0>. Because the most significant bit EX_SUB<7> of the exponent subtraction data, “0” is input through the selection terminal S8C, the third multiplexer 811F outputs the exponent subtraction data EX_SUB<7:0> that is input through the first input terminal IN81C as the second mantissa shift data MA2_SFT<7:0>. In other words, the third multiplexer 811F outputs “0000 0010” as the second mantissa shift data MA2_SFT<7:0>.

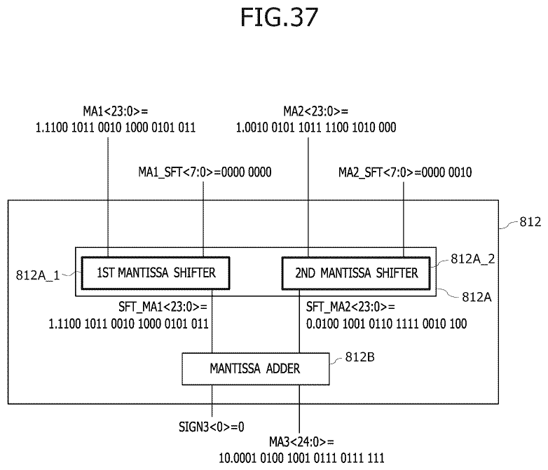

Referring next to FIG. 37, because the first mantissa shift data MA1_SFT<7:0> “0000 0000” has a decimal value of “0”, the first mantissa shifter 812A_1 of the mantissa processing circuit 812 outputs the first mantissa data MA1<23:0> “1.1100 1011 0010 1000 0101 011” as the shifted first mantissa data (SFT_MA1<23:0>) without shifting the first mantissa data MA1<23:0>. The second mantissa shifter 812A_1 generates and outputs the shifted second mantissa data SFT_MA2<23:0> by shifting the second mantissa data MA2<23:0> “1.0010 0101 1011 1100 1010 000” to the right by 2 bits corresponding to the decimal value “2” of the second mantissa shift data MA2_SFT<7:0> “0000 0010”. Accordingly, the second mantissa shifter 812A_2 outputs “0.0100 1001 0110 1111 0010 100” as the shifted second mantissa data SFT_MA2<23:0>.

The mantissa adder 812B adds the shifted first mantissa data SFT_MA1<23:0> “1.1100 1011 0010 1000 0101 011” transmitted from the first mantissa shifter 812A_1, and the shifted second mantissa data SFT_MA2<23:0> “0.0100 1001 0110 1111 0010 100”, and outputs the result “10.0001 0100 1001 0111 0111 111” as the third mantissa data MA3<24:0>. The mantissa adder 812B also outputs “0” as the third sign data SIGN3<0>. Because the shifted first mantissa data SFT_MA1<23:0> and the shifted second mantissa data SFT_MA2<23:0> are in the form of “x.xxxx . . . ”, the third mantissa data MA3<24:0> output from the mantissa adder 812B has the form of “xx.xxxx . . . ”.

Next, referring to FIG. 38, the third mantissa data MA3<24:0> “10.0001 0100 1001 0111 0111 111” output from the mantissa adder 812B of FIG. 37 is input to the 2's complement circuit 821 and the delay circuit 822 of the normalizer 820. The 2's complement circuit outputs “01.1110 1011 0110 1000 1000 001” as the 2's complement data MA3_2C<24:0> of the third mantissa data MA3<24:0> “10.0001 0100 1001 0111 0111 111”. The delay circuit 822 outputs “10.0001 0100 1001 0111 0111 0111 111” as the third mantissa data MA3<24:0>. The third mantissa data MA3<24:0> “10.0001 0100 1001 0111 0111 0111 111” output from the delay circuit 822 is transmitted to the first input terminal IN81 of the multiplexer 830. The 2's complement data MA3_2C<24:0> “01.1110 1011 0110 1000 1000 001” output from the 2's complement circuit 821 is transmitted to the second input terminal IN82 of the multiplexer 830.

As the third sign data SIGN3<0> “0” is input through the select terminal S8, the multiplexer 823 of the normalizer 820 outputs the third mantissa data MA3<24:0> “10.0001 0100 1001 0111 0111 111” input to the first input terminal IN81 as the selected third mantissa data SEL_MA3<24:0> through the output terminal 08. The selected third mantissa data SEL_MA3<24:0> “10.0001 0100 1001 0111 0111 0111 111” output from the multiplexer 823 is transmitted to the “1” search circuit 824 and the unidirectional mantissa shifter 826.

The “1” search circuit 824 of the normalizer 820 detects the position of the leading “1” in the selected third mantissa data SEL_MA3<24:0> “10.0001 0100 1001 0111 0111 0111 111”. In the selected third mantissa data SEL_MA3<24:0> “10.0001 0100 1001 0111 0111 0111 111”, the leading “1” is located in the second bit to the left of the binary point. Accordingly, the number of bits that the selected third mantissa data SEL_MA3<24:0> must be shifted so that the binary point is located to the right of the leading “1” is “1”, and the binary number corresponding to decimal number “1” is “0000 0000 01”. Accordingly, the “1” search circuit 824 outputs “0000 0000 01” as the preliminary shift data PRE_SFT<9:0>. As described with reference to FIG. 37, because the third mantissa data MA3<24:0> output from the mantissa processing circuit 812 of FIG. 37 has the format of “xx.xxxx . . . ”, the selected third mantissa data SEL_MA3<24:0> also has the format of “xx.xxxx . . . ”. Accordingly, there is one bit between the most significant bit and the binary point in the selected third mantissa data SEL_MA3<24:0>, and accordingly, the reference data is the binary number “0000 0000 01” corresponding to the decimal number “1”. In other words, in this example, the reference data for the selected third mantissa data SEL_MA3<24:0> “10.0001 0100 1001 0111 0111 111” is the binary number “0000 0000 01”. The “1” search circuit 824 outputs “0000 0000 00” as shift data SFT<9:0>, which is the result of subtracting the reference data “0000 0000 01” from the preliminary shift data PRE_SFT<9:0> “0000 0000 01”.

The exponent adder 825 of the normalizer 825 receives the third exponent data EX3<7:0> “1001 1000,” which is output from the first multiplexer 811B of FIG. 36 of the floating-point adder 811 of FIG. 36, and the preliminary shift data PRE_SFT<9:0> “0000 0000 01,” which is output from the “1” search circuit 824 of the normalizer 825. The exponent adder 825 performs an addition operation on the third exponent data EX3<7:0> “1001 1000” and the preliminary shift data PRE_SFT<9:0> “0000 0000 01”, and outputs the result, “1001 1001”, as the fourth exponent data EX4<7:0>.

The unidirectional mantissa shifter 826 of the normalizer 820 receives the selected third mantissa data SEL_MA3<24:0> “10.0001 0100 1001 0111 0111 111,” which is output from the multiplexer 823 of the normalizer 820, and the shift data SFT<9:0> “0000 0000 00,” which is output from the “1” search circuit 824 of the normalizer 820. The unidirectional mantissa shifter 826 performs a shift operation that shifts the selected third mantissa data SEL_MA3<24:0> “10.0001 0100 1001 0111 0111 111” by the decimal “0” corresponding to the shift data SFT<9:0> “0000 0000 00”, and outputs the fourth mantissa data MA4<23:0> “1.0000 1010 0100 1011 1011 111”.

More specifically, with reference to FIG. 39, the selected third mantissa data SEL_MA3<24:0> input to the unidirectional mantissa shifter 826 has a 25-bit size of “10.0001 0100 1001 0111 0111 111”. In the selected third mantissa data SEL_MA3<24:0>, the binary number to the left of the binary point is 2 bits, and the binary number to the right of the binary point is 23 bits. The fourth mantissa data MA4<23:0> output from the unidirectional mantissa shifter 826 has a size of 24 bits. The fourth mantissa data MA4<23:0> has a normalized format, so the binary number to the left of the binary point is the binary value “1” (i.e., a hidden bit), and the binary number to the right of the binary point is 23 bits. In this example, the shift data SFT<9:0> input to the unidirectional mantissa shifter 826 is “0000 0000 00”, so the selected third mantissa data SEL_MA3<24:0> is not shifted in the unidirectional mantissa shifter 826. The fourth mantissa data MA4<23:0> output from the unidirectional mantissa shifter 826 is generated by changing the binary number to the left of the binary point in the selected third mantissa data SEL_MA3<24:0> “10.0001 0100 1001 0111 0111 111” from “10” to “1” and deleting the least significant bit (LSB) of the selected third mantissa data SEL_MA3<24:0>.

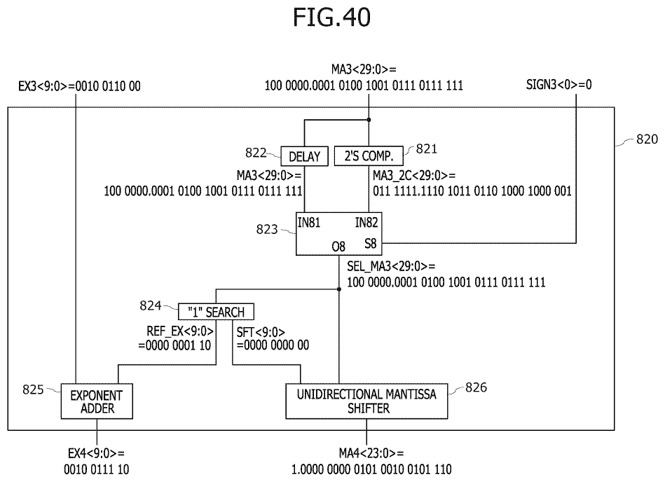

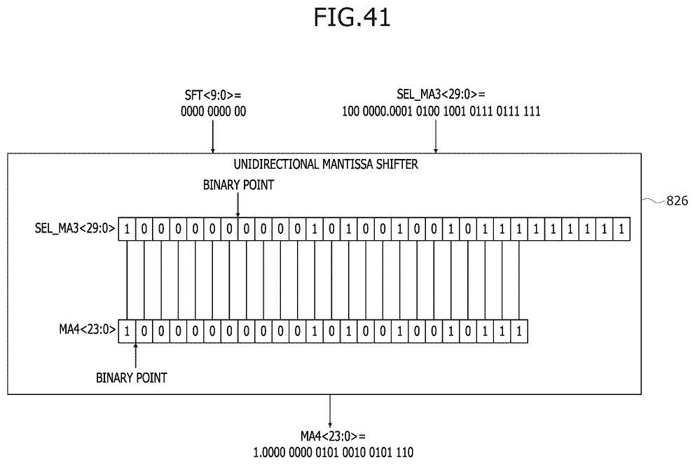

FIG. 40 is a diagram illustrating an example of operations of a normalizer included in a floating-point addition circuit of FIG. 32. And FIG. 41 is a diagram illustrating an operation of a unidirectional mantissa shifter included in a normalizer of FIG. 40. In FIG. 40, the same reference numerals as in FIG. 32 refer to the same element, and redundant descriptions will be omitted. In the example of FIG. 40, it is assumed that the first floating-point data FP_1 of FIG. 32 and the second floating-point data FP_2 of FIG. 32 input to the floating-point adder 810 of FIG. 32 have different numbers of bits of exponent data and mantissa data. Hereinafter, the normalizer of FIG. 40 is a normalizer included in an accumulator of a multiplication-accumulation (MAC) circuit. In this case, as described with reference to FIG. 7, the accumulator may include an accumulative adder and a latch circuit. The normalizer of FIG. 40 may be disposed between the accumulative adder and the latch circuit.

Referring to FIG. 40, the normalizer 820 receives input of a third sign data SIGN3<0>, a third exponent data EX3<9:0>, and a third mantissa data MA3<29:0>. The third sign data SIGN3<0>, the third exponent data EX3<9:0>, and the third mantissa data MA3<29:0> comprise a third floating-point data FP_3 output from the floating-point adder 810 of FIG. 32. As described with reference to FIG. 7, the first floating-point data FP_1 of FIG. 32 input to the floating-point adder 810 of FIG. 32, which functions as a accumulative adder of the accumulator, is multiplication/addition result data that is output from an adder tree. And the second floating-point data FP_2 in FIG. 32 input to the floating-point adder 810 is the latch data that is output from the normalizer. Therefore, the number of bits of the first exponent data EX1 of FIG. 32 of the first floating-point data FP_1 of FIG. 32 is smaller than the number of bits of the second exponent data EX2 of FIG. 32 of the second floating-point data FP_2 of FIG. 32. And the number of bits in the first mantissa data MA1 in FIG. 32 of the first floating-point data FP_1 of FIG. 32 is greater than the number of bits in the second mantissa data MA2 in FIG. 32 of the second floating-point data FP_2 in FIG. 32. Therefore, the third exponent data EX3 of FIG. 32 and the third mantissa data MA3 of FIG. 32 of the third floating-point data FP_3 of FIG. 32 output from the floating-point adder 810 of FIG. 32 have the same number of bits as the second exponent data EX2 of FIG. 32 of the second floating-point data FP_2 of FIG. 32 and the first mantissa data MA1 of FIG. 32 of the first floating-point data FP_1 of FIG. 32, respectively. Hereinafter, it is assumed that the third sign data SIGN3<0> output from the floating-point adder 810 of FIG. 32 and input to the normalizer 820 is “0”, the third exponent data EX3<9:0> is “0010 0110 00”, and the third mantissa data MA3<29:0> is “100 0000.0001 0100 1001 0111 0111 0111 111”.

The third mantissa data MA3<29:0> “100 0000.0001 0100 1001 0111 0111 0111 111” output from the floating-point adder 810 of FIG. 32 is input to the 2's complement circuit 821 and the delay circuit 822 of the normalizer 820. The 2's complement circuit 821 outputs “011 1111.1110 1011 0110 1000 1000 001” as the 2's complement data MA3_2C<29:0> of the third mantissa data MA3<29:0> “100 0000.0001 0100 1001 0111 0111 111”. The delay circuit 822 outputs “100 0000.0001 0100 1001 0111 0111 0111 111” as the third mantissa data MA3<29:0>. The third mantissa data MA3<29:0> “100 0000.0001 0100 1001 0111 0111 0111 111” output from the delay circuit 822 is transmitted to the first input terminal IN81 of the multiplexer 830. The 2's complement data MA3_2C<29:0> “011 1111.1110 1011 0110 1000 1000 001” output from the 2's complement circuit 821 is transmitted to the second input terminal IN82 of the multiplexer 830.

As the third sign data SIGN3<0> “0” is input through the select terminal S8, the multiplexer 823 of the normalizer 820 outputs the third mantissa data MA3<29:0> “100 0000.0001 0100 1001 0111 0111 111” input to the first input terminal IN81 as the selected third mantissa data SEL_MA9<29:0> through the output terminal 08. The selected third mantissa data SEL_MA3<29:0> “100 0000.0001 0100 1001 0111 0111 111” output from the multiplexer 823 is transmitted to the “1” search circuit 824 and the unidirectional mantissa shifter 826.

The “1” search circuit 824 of the normalizer 820 detects the position of the leading “1” in the selected third mantissa data SEL_MA3<29:0> “100 0000.0001 0100 1001 0111 0111 0111 111”. In the selected third mantissa data SEL_MA3<29:0> “100 0000.0001 0100 1001 0111 0111 0111 111”, the leading “1” is located in the seventh bit to the left of the binary point. Accordingly, the number of bits that the selected third mantissa data SEL_MA3<29:0> must be shifted so that the binary point is located to the right of the leading “1” is “+6” (“+” means right shift direction), and the binary number corresponding to the decimal number “+6” is “0000 0001 10”. Accordingly, the “1” search circuit 824 outputs “0000 0001 10” as the preliminary shift data PRE_SFT<9:0>. There is six bits between the MSB SEL_MA3<29> and the binary point in the selected third mantissa data SEL_MA3<29:0> “100 0000.0001 0100 1001 0111 0111 0111 111”, and accordingly, the reference data is the binary number “0000 0001 10” corresponding to the decimal number “6”. The “1” search circuit 824 outputs “0000 0000 00” as shift data SFT<9:0>, which is the result of subtracting the reference data “0000 0001 10” from the preliminary shift data PRE_SFT<9:0> “0000 0001 10”.

The exponent adder 825 of the normalizer 825 receives the third exponent data EX3<9:0> “0010 0110 00,” which is output from the “1” search circuit 824 of the normalizer 825, and the preliminary shift data PRE_SFT<9:0> “0010 0110 00,” which is output from the “1” search circuit 824 of the normalizer 825. The exponent adder 825 performs an addition operation on the third exponent data EX3<9:0> “1001 1000” and the preliminary shift data PRE_SFT<9:0> “0000 0001 10”, and outputs the result, “0010 0111 10”, as the fourth exponent data EX4<9:0>.

The unidirectional mantissa shifter 826 of the normalizer 820 receives the selected third mantissa data SEL_MA3<29:0> “100 0000.0001 0100 1001 0111 0111 0111 111,” which is output from the multiplexer 823 of the normalizer 820, and the shift data SFT<9:0> “0000 0000 00,” which is output from the “1” search circuit 824 of the normalizer 820. The unidirectional mantissa shifter 826 performs a shift operation that shifts the selected third mantissa data SEL_MA3<29:0> “100 0000.0001 0100 1001 0111 0111 111” by the decimal “0” corresponding to the shift data SFT<9:0> “0000 0000 00,” and outputs the fourth mantissa data MA4<23:0> “1.0000 0000 0101 0101 110.”

More specifically, with reference to FIG. 41, the selected third mantissa data SEL_MA3<29:0> input to the unidirectional mantissa shifter 826 has a 30-bit size of “100 0000.0001 0100 1001 0111 0111 111”. In the selected third mantissa data SEL_MA3<29:0>, the binary number to the left of the binary point is 7 bits, and the binary number to the right of the binary point is 23 bits. The fourth mantissa data MA4<23:0> output from the unidirectional mantissa shifter 826 has a size of 24 bits. The fourth mantissa data MA4<23:0> has a normalized format, so the binary number to the left of the binary point is the binary value “1” (i.e., a hidden bit), and the binary number to the right of the binary point is 23 bits. Within the unidirectional mantissa shifter 826, the MSB of the selected third mantissa data SEL_MA3<29:0> and the MSB of the fourth mantissa data MA4<23:0> are aligned to the same MSB position. Accordingly, the LSB of the fourth mantissa data MA4<23:0> is aligned to the seventh bit of the low order of the selected third mantissa data SEL_MA3<24:0>. Because the shift data SFT<9:0> input to the unidirectional mantissa shifter 826 is “0000 0000 00”, the selected third mantissa data SEL_MA3<29:0> is not shifted in the unidirectional mantissa shifter 826. Therefore, the fourth mantissa data MA4<23:0> output from the unidirectional mantissa shifter 826 is “1.0000 0000 0101 0010 0101 110.” In the process of shifting the selected third mantissa data SEL_MA3<29:0>, the low-order 6 bits of the selected third mantissa data SEL_MA3<29:0> are removed.

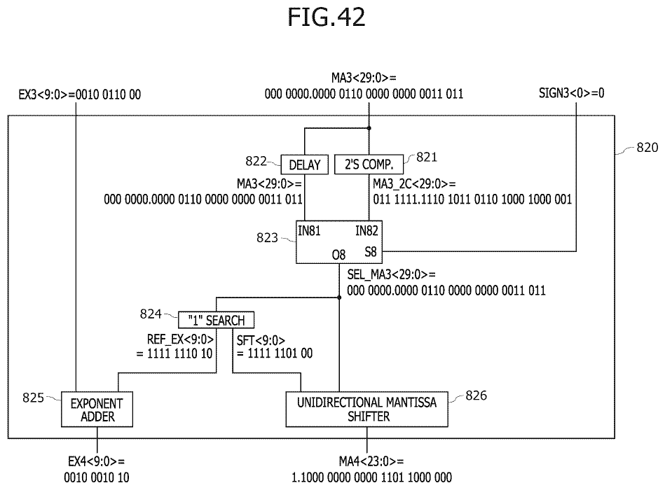

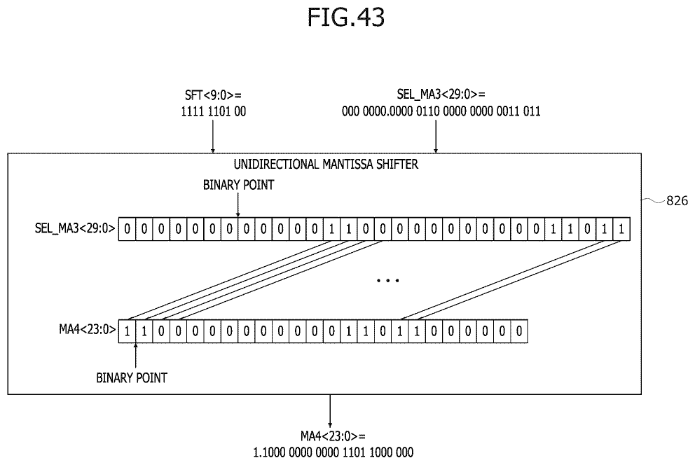

FIG. 42 is a diagram illustrating a further example of operations of a normalizer included in a floating-point addition circuit of FIG. 32. Also, FIG. 43 is a diagram illustrating an example of operation of a unidirectional mantissa shifter included in a normalizer of FIG. 42. In FIG. 42, the same reference numerals as in FIG. 32 refer to the same element, and redundant descriptions will be omitted. As in the example of FIG. 38, the example of FIG. 42 also has a first floating-point data FP_1 of FIG. 32 and a second floating-point data FP_2 of FIG. 32 having different bit numbers of exponent data and mantissa data input to the floating-point adder 810 of FIG. 32. Hereinafter, the normalizer of FIG. 42 is a normalizer included in an accumulator of a multiplication-accumulation (MAC) circuit.

Referring to FIG. 42, the normalizer 820 receives input of a third sign data SIGN3<0>, a third exponent data EX3<9:0>, and a third mantissa data MA3<29:0>. The third sign data SIGN3<0>, the third exponent data EX3<9:0>, and the third mantissa data MA3<29:0> comprise a third floating-point data FP_3 output from the floating-point adder 810 of FIG. 32. In this example, the third sign data SIGN3<0>, which is output from the floating-point adder circuit 810 of FIG. 32 and input to the normalizer 820, is “0”, the third exponent data EX3<9:0> is “0010 0110 00,” and the third mantissa data MA3<29:0> is “000 0000.0000 0110 0000 0000 0011 011.” In other words, in this example, the leading “1” in the third mantissa data MA3<29:0> is located to the right of the binary point.

The third mantissa data MA3<29:0> “000 0000.0000 0110 0000 0000 0011 011” output from the floating-point adder 810 of FIG. 32 is input to the 2's complement circuit 821 and the delay circuit 822 of the normalizer 820. The 2's complement circuit 821 outputs “011 1111.1110 1011 0110 1000 1000 001” as the 2's complement data MA3_2C<29:0> of the third mantissa data MA3<29:0> “000 0000.0000 0110 0000 0000 0011 011.” The delay circuit 822 outputs “000 0000.0000 0110 0000 0000 0000 0011 011” as the third mantissa data MA3<29:0>. The third mantissa data MA3<29:0> “000 0000.0000 0110 0000 0000 0000 0011 011” output from the delay circuit 822 is transmitted to the first input terminal IN81 of the multiplexer 830. The 2's complement data MA3_2C<29:0> “011 1111.1110 1011 0110 1000 1000 001” output from the 2's complement circuit 821 is transmitted to the second input terminal IN82 of the multiplexer 830.

As the third sign data SIGN3<0> “0” is input through the select terminal S8, the multiplexer 823 of the normalizer 820 outputs the third mantissa data MA3<29:0> “000 0000.0000 0110 0000 0000 0011 011” input to the first input terminal IN81 as the selected third mantissa data SEL_MA9<29:0> through the output terminal 08. The selected third mantissa data SEL_MA3<29:0> “000 0000.0000 0110 0000 0000 0011 011” output from the multiplexer 823 is transmitted to the “1” search circuit 824 and the unidirectional mantissa shifter 826.

The “1” search circuit 824 of the normalizer 820 detects the position of the leading “1” in the selected third mantissa data SEL_MA3<29:0> “000 0000.0000 0110 0000 0000 0011 011”. In the selected third mantissa data SEL_MA3<29:0> “000 0000.0000 0110 0000 0000 0011 011”, the leading “1” is located in the seventh bit to the right of the binary point. Accordingly, the number of bits that the selected third mantissa data SEL_MA3<29:0> must be shifted so that the binary point is located to the right of the leading “1” is “−6” (“−” means left shift direction), and the binary number corresponding to the decimal number “−6” is “1111 1110 10.” Accordingly, the “1” search circuit 824 outputs “1111 1110 10” as the preliminary shift data PRE_SFT<9:0>. In the selected third mantissa data SEL_MA3<29:0> “000 0000.0000 0110 0000 0000 0011 011,” the number of bits between the MSB SEL_MA3<29> and the binary point is six, so that the binary number “0000 0001 10” corresponding to the decimal number “6” becomes the reference data. The “1” search circuit 824 outputs “1111 1101 00” as shift data SFT<9:0>, which is the result of subtracting the reference data “0000 0001 10” from the preliminary shift data PRE_SFT<9:0> “1111 1110 10”.

The exponent adder 825 of the normalizer 825 receives the third exponent data EX3<9:0> “0010 0110 00,” which is output from the “1” search circuit 824 of the normalizer 825, and the preliminary shift data PRE_SFT<9:0> “1111 1110 10,” which is output from the “1” search circuit 824 of the normalizer 825. The exponent adder 825 performs an addition operation on the third exponent data EX3<9:0> “1001 1000” and the preliminary shift data PRE_SFT<9:0> “1111 1110 10,” and outputs the result, “0010 00100 10”, as the fourth exponent data EX4<9:0>.

The unidirectional mantissa shifter 826 of the normalizer 820 receives the selected third mantissa data SEL_MA3<29:0> “000 0000.0000 0110 0000 0000 0011 011,” which is output from the multiplexer 823 of the normalizer 820, and the shift data SFT<9:0> “1111 1101 00,” which is output from the “1” search circuit 824 of the normalizer 820. The unidirectional mantissa shifter 826 performs a shift operation that shifts the selected third mantissa data SEL_MA3<29:0> “000 0000.0000 0110 0000 0000 0011 011” by the number of bits corresponding to the decimal number “−12” (“−” means a shift in the left direction), and outputs the fourth mantissa data MA4<23:0> “1.1000 0000 0000 1101 1000 000.”

More specifically, with reference to FIG. 43, the selected third mantissa data SEL_MA3<29:0> input to the unidirectional mantissa shifter 826 has a 30-bit size of “000 0000.0000 0110 0000 0000 0011 011”. In the selected third mantissa data SEL_MA3<29:0>, the binary number to the left of the binary point is 7 bits, and the binary number to the right of the binary point is 23 bits. The fourth mantissa data MA4<23:0> output from the unidirectional mantissa shifter 826 has a size of 24 bits. The fourth mantissa data MA4<23:0> has a normalized format, so the binary number to the left of the binary point is the binary value “1” (i.e., a hidden bit), and the binary number to the right of the binary point is 23 bits. Within the unidirectional mantissa shifter 826, the MSB of the selected third mantissa data SEL_MA3<29:0> and the MSB of the fourth mantissa data MA4<23:0> are aligned to the same MSB position. Accordingly, the LSB of the fourth mantissa data MA4<23:0> is aligned to the seventh bit of the low order of the selected third mantissa data SEL_MA3<24:0>. Because the shift data SFT<9:0> input to the unidirectional mantissa shifter 826 is “1111 1101 00 (decimal “12”),” the unidirectional mantissa shifter 826 shifts the selected third mantissa data SEL_MA3<29:0> by 12 bits to the left. Thus, the fourth mantissa data MA4<23:0> output from the unidirectional mantissa shifter 826 is “1.1000 0000 0000 1101 1000 000”. In the process of shifting the selected third mantissa data SEL_MA3<29:0>, the low-order 6 bits of the fourth mantissa data MA4<23:0> are each filled with “0”.

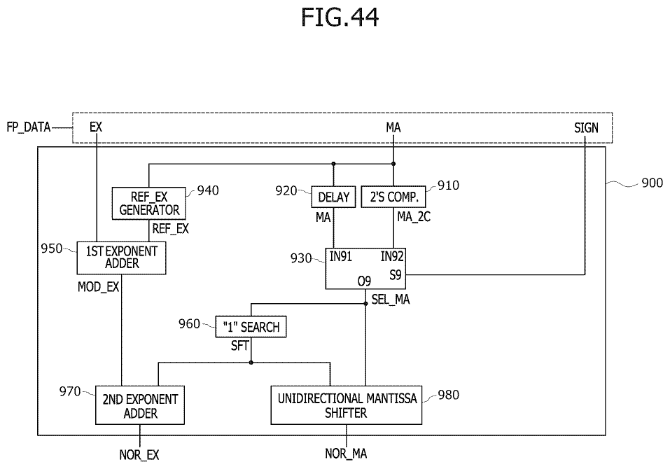

FIG. 44 is a block diagram illustrating a normalizer according to another embodiment of the present disclosure. The normalizer according to this example may be applied to the normalizers used in the various examples of artificial intelligence accelerators described with reference to FIGS. 1 to 20.

Referring to FIG. 44, the normalizer 900 receives floating-point data FP_DATA as input, performs a normalization operation on the floating-point data FP_DATA, and outputs normalized exponent data NOR_EX and normalized mantissa data NOR_MA. The Floating-point data FP_DATA includes sign data SIGN, exponent data EX, and mantissa data MA. The mantissa data MA of the floating-point data FP_DATA may have a denormalized form. For example, when the floating-point data FP_DATA is in FP32 format, the mantissa data MA does not have the normalized form of “1.xxxx . . . ” (where “x” is the binary number “0” or “1”). Here, the binary the “1” to the left of the binary point represents a hidden bit (also called implicit bit). The number of bits in the mantissa data MA may also exceed 24 bits, which is the normalized number of bits, including a hidden bit. The normalized mantissa data NOR_MA output from the normalizer 700 has the normalized format of “1.xxxx . . . ” (including a hidden bit).

The normalizer 900 performs a 2's complement operation process of the mantissa data, a delay processing process of the mantissa data, a selection output process, a reference exponent data REF_EX generation process, a first exponent addition process, a “1” search process, a second exponent addition process, and a mantissa shift process. For this purpose, the normalizer 900 includes a 2's complement circuit 910 that performs the 2's complement operation of the mantissa data, a delay circuit 920 that performs the delay processing of the mantissa data, a multiplexer 930 that performs the select output process, and a reference exponent data generator 940 that performs the reference exponent data REF_EX generation process, a first exponent adder 950 that performs the first exponent addition process, a “1” search circuit 960 that performs the “1” search process, a second exponent adder 970 that performs the second exponent addition process, and a unidirectional mantissa shifter 980 that performs the unidirectional mantissa shift process.

In an embodiment, the reference exponent data REF_EX generation process in the reference exponent data generator 940 and the first exponent addition process in the first exponent adder 950 may be performed in parallel with the 2's complement operation of the mantissa data in the 2's complement circuit 910 (or the delay processing of the mantissa data in the delay circuit 920) and the select output process in the multiplexer 930. Also, unlike in the case of the normalizer 700 of FIG. 21 described with reference to FIG. 21, the process of generating reference exponent data REF_EX in the “1” search circuit 960 does not need to be performed, so that the “1” search process in the “1” search circuit 960 may be performed quickly.

The 2's complement circuit 910, the delay circuit 920, and the reference exponent data generator 940 of the normalizer 900 receive the mantissa data MA of the floating-point data FP_DATA as input. The 2's complement circuit 910 generates and outputs the 2's complement data MA_2C of the mantissa data. The delay circuit 920 delays the mantissa data MA for a certain time and outputs the mantissa data MA. The delay time in the delay circuit 920 may be set to the time it takes for the 2's complement data MA_2C of the mantissa data to be generated in the 2's complement circuit 910. Accordingly, the time at which the 2's complement data MA_2C of the mantissa data is output from the 2's complement circuit 910 and the time at which the mantissa data MA is output from the delay circuit 920 may be substantially the same.

The multiplexer 930 of the normalizer 900 may be a 2:1 multiplexer. The multiplexer 930 has a first input terminal IN91, a second input terminal IN92, a selection terminal S9, and an output terminal O9. The multiplexer 930 receives mantissa data MA, which is output from the delay circuit 920, through the first input terminal IN91. The multiplexer 930 receives the 2's complement data MA_2C of the mantissa data, which is output from the 2's complement circuit 910, through the second input terminal IN92. The multiplexer 930 receives the sign data SIGN of the floating-point data FP_DATA through the selection terminal S9. The multiplexer 930 outputs the mantissa data MA or the 2's complement data MA_2C of the mantissa data through the output terminal O9 based on the value of the sign data SIGN. In an embodiment, when the sign data SIGN having a value of “O” is input to the select terminal S9 that is, when the mantissa data MA is positive, the multiplexer 930 outputs the mantissa data MA as the selected mantissa data SEL_MA through the selected output terminal O9. On the other hand, when the sign” data SIGN having a value of “1” is input to the select terminal S9, that is, when the mantissa data MA is negative, the multiplexer 930 outputs the 2's complement data MA_2C of the mantissa data as the selected mantissa data SEL_MA through the output terminal O9.

The reference exponent data generator 940 generates and outputs the reference exponent data REF_EX based on the mantissa data MA of the floating-point data FP_DATA. Similarly, as described with reference to FIG. 21, the reference exponent data REF_EX may be a binary number corresponding to the number of bits between the MSB of the mantissa data MA and the binary point. In an embodiment, when the mantissa data MA is “1yyyyy.xxx . . . ” (“x” and “y” are binary number “0” or “1”), there are five bits (i.e., “yyyyy”) between the binary value of “1”, the MSB of the mantissa dataMA, and the binary point. Therefore, in this case, the reference exponent data REF_EX generated by the reference exponent data generator 940 will be “0000 0001 01”, which is a binary number equivalent of a decimal number “5”. In another example, when the mantissa data MA is “0y.xxx . . . ”, there is one bit (i.e., “y”) between the MSB of the mantissa data MA, “0”, and the binary point. Therefore, in this case, the reference exponent data REF_EX generated by the reference exponent data generator 940 will be “0000 0000 01”, which is a binary number equivalent of a decimal number “1”. The reference exponent data generator 9450 transmits the reference exponent data REF_EX to the first exponent adder 950.

The first exponent adder 950 receives the exponent data EX of the floating-point data FP_DATA and the reference exponent data REF_EX output from the reference exponent data generator 940. The first exponent adder 950 performs an addition operation on the exponent data EX and the reference exponent data REF_EX to generate modified exponent data MOD_EX. As the modified exponent data MOD_EX is generated, the selected mantissa data SEL_MA transmitted from the multiplexer 930 to the “1” search circuit 960 has a modified format, i.e., “x.xxxx . . . ,” in the “1” search circuit 960, where the binary point is positioned between the MSB of the selected mantissa data SEL_MA1 and the low-order bit of the MSB.

The “1” search circuit 960 of the normalizer 900 receives the selected mantissa data SEL_MA that is output from the multiplexer 930. The “1” search circuit 960 performs a leading “1” search operation, also referred to herein as a search operation for a leading first binary value (i.e., “1”), on the selected mantissa data SEL_MA to generate shift data SFT. In an embodiment, the “1” search circuit 960 generates the shift data SFT by performing a leading “1” search operation on the selected mantissa data SEL_MA to find the position of “leading 1”. The leading “1” search operation in the “1” search circuit 960 may be performed by detecting a bit position of “leading 1” having a value of the first “1” among values of the bits of the selected mantissa data SEL_MA, along the right direction (i.e., from MSB to LSB), starting with the MSB of the selected mantissa data SEL_MA. Here, the leading “1” means a first positioned “1”, i.e., “1” for the highest binary weight, and represents a hidden bit in the normalized mantissa data.

The “1” search circuit 960, in performing the leading “1” search operation, generates shift data SFT based on the number of bits by which the selected mantissa data SEL_MA is shifted in order to ensure that a binary point is positioned to the right of the leading “1” and that the leading “1” is positioned at the MSB of the selected mantissa data SEL_MA(i.e., in the normalized form of “1.xxxx . . . ”). In this case, the shift data SFT is a binary number corresponding to the number of bits by which the selected mantissa data SEL_MA is shifted. The shift data SFT generated by the “1” search circuit 960 is transmitted to the second exponent adder 970 and the unidirectional mantissa shifter 980.

The second exponent adder 970 of the normalizer 900 receives the modified exponent data MOD_EX, which is output from the first exponent adder 950, and the shift data SFT which is output from the “1” search circuit 960. The second exponent adder 970 performs an addition operation on the modified exponent data MOD_EX and the shift data SFT to generate the normalized exponent data NOR_EX. The unidirectional mantissa shifter 980 receives the selected mantissa data SEL_MA, which is output from the multiplexer 930, and the shift data SFT, which is output from the “1” search circuit 960. The unidirectional mantissa shifter 980 performs a shift operation on the selected mantissa data SEL_MA based on the shift data SFT to generate the normalized mantissa data NOR_MA. Because the shift data SFT is generated after the addition operation of the exponent data EX and the reference exponent data REF_EX is performed in the first exponent adder 950, the shift operation on the selected mantissa data SEL_MA in the unidirectional mantissa shifter 980 is always performed only in one direction, i.e., the left direction. Accordingly, in an embodiment, the circuit area of the mantissa shifter required to implement the normalizer 900 may be reduced. In an embodiment, the unidirectional mantissa shifter 980 may comprise a plurality of 2:1 multiplexers. The configuration of the unidirectional mantissa shifter 760 described with reference to FIG. 26 through FIG. 31 may be equally applicable to the unidirectional mantissa shifter 980 of the normalizer 900.

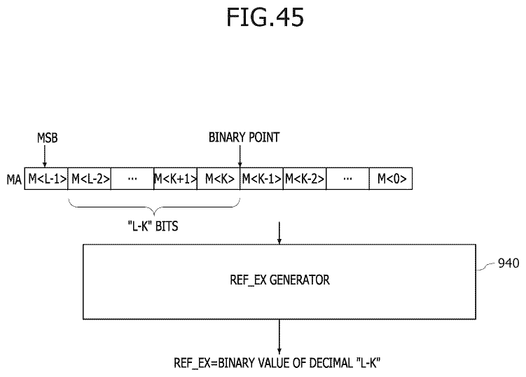

FIG. 45 is a diagram illustrating an example of an operation of a reference exponent data generator included in a normalizer of FIG. 44.

Referring to FIG. 45, a reference exponent data generator 940 receives mantissa data MA. The mantissa data MA may be in the form of a binary stream of “L” bits, where “L” is a natural number greater than or equal to 6. In the mantissa data MA, the binary point is located between a “K” bit M<K−1> and a “K+1” bit M<K>. Where “K” may be a natural number less than “L−3”. In the mantissa data MA, the binary digits to the left of the binary point have “L−K+1” bits. In mantissa data MA, the binary digits to the right of the binary point have “K” bits. The reference exponent data generator 940 detects the number of “L−K” bits between a MSB of the mantissa data MA, i.e., a “L” th bit M<L−1>, and the binary point. The reference exponent data generator 940 outputs the binary value of the detected number of bits, the decimal number “L−K”, as reference exponent data REF_EX.

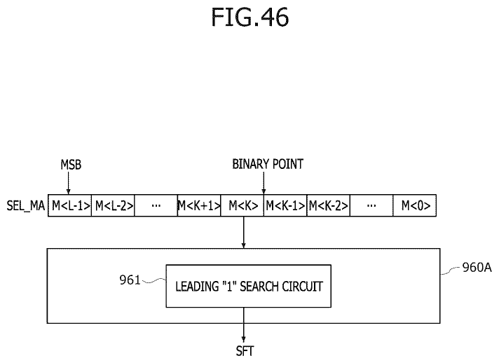

FIG. 46 is a block diagram illustrating an example of a “1” search circuit included in a normalizer of FIG. 44.

Referring to FIG. 46, a “1” search circuit 960A, also referred to herein as a search circuit, includes a leading “1” search circuit 961. In an embodiment, the leading “1” search circuit 961 may also be referred to as a leading first binary value search circuit. As described with reference to FIG. 44, the “1” search circuit 960A receives selected mantissa data SEL_MA from the multiplexer 930 of the normalizer 900 of FIG. 44 and outputs shift data SFT. The selected mantissa data SEL_MA is either the mantissa data MA in FIG. 44 or the 2's complement data MA_2C in FIG. 44 of the mantissa data, depending on the value of the sign data SIGN. Therefore, the mantissa data MA in FIG. 44, the 2's complement data MA_2C in FIG. 44 of the mantissa data, and the selected mantissa data SEL_MA all have the same binary stream format. The selected mantissa data SEL_MA, like the mantissa data MA in FIG. 44 and the 2's complement data MA_2C in FIG. 44 of the mantissa data, has a binary stream format of “L” bits (“L” is a natural number greater than or equal to 6). In the selected mantissa data SEL_MA, the binary point is located between the “K” bit M<K−1> and the “K+1” bit M<K>. Where “K” may be a natural number less than “L−3”. In the selected mantissa data SEL_MA, the binary digits to the left of the binary point have “L−K+1” bits. In the selected mantissa data SEL_MA, the binary digits to the right of the binary point have “K” bits.

The leading “1” search circuit 961 of the “1” search circuit 960A receives the selected mantissa data SEL_MA as input. The leading “1” search circuit 961 detects a bit position of the left-most “1” (i.e., the leading “1”) among the “L” bits from a “L”th bit M<L−1>, which is the MSB, to a first bit M<0>, which is the LSB, of the selected mantissa data SEL_MA. The leading “1” search circuit 961 outputs a binary number corresponding to the number of bits that the selected mantissa data SEL_MA is to be shifted so that the leading “1” detected by the leading “1” search process is located at the MSB M<L−1> of the selected mantissa data SEL_MA, as shift data SFT.

In an embodiment, when the leading “1” is located at the MSB M<L−1>, a shift operation on the selected mantissa data SEL_MA is not required. Therefore, in this case, the leading “1” search circuit 961 outputs “0000 0000 00” as shift data SFT. In an embodiment, when the leading “1” is located at the “L−1” bit M<L−2>, the selected mantissa data SEL_MA should be shifted by “−1” bit (i.e., 1 bit in the left direction) to make the “L−1” bit M<L−2>, which is the leading “1”, located at the MSB M<L−1> of the selected mantissa data SEL_MA. Therefore, in this case, the leading “1” search circuit 961 outputs “1111 1111 11” as shift data SFT, which is the binary value of the decimal number “−1”. In conclusion, except when the leading “1” is located at the MSB M<L−1> of the selected mantissa data SEL_MA, the shift data SFT has a binary value corresponding to a negative decimal number. Accordingly, the shift operation in the unidirectional mantissa shifter 980 of the normalizer 900 of FIG. 44 is performed in only one direction, i.e., the left direction.

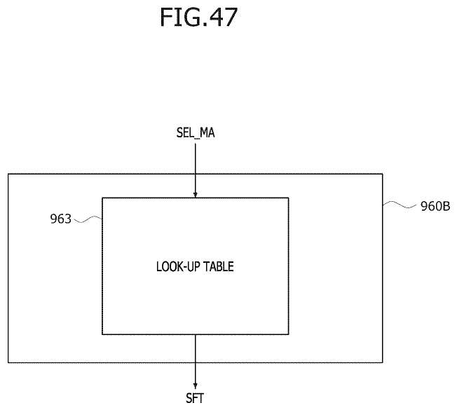

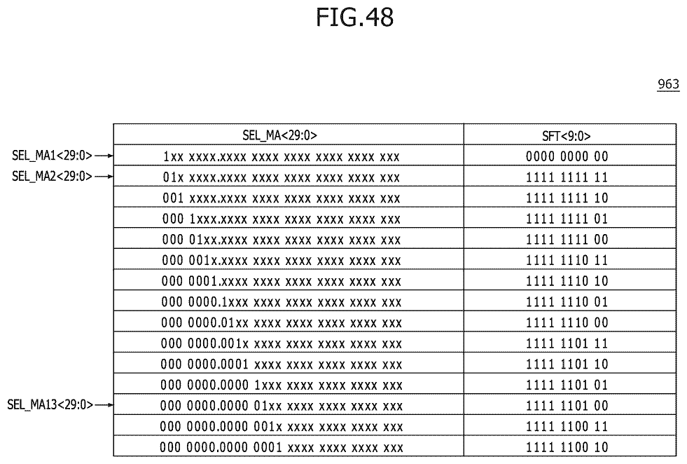

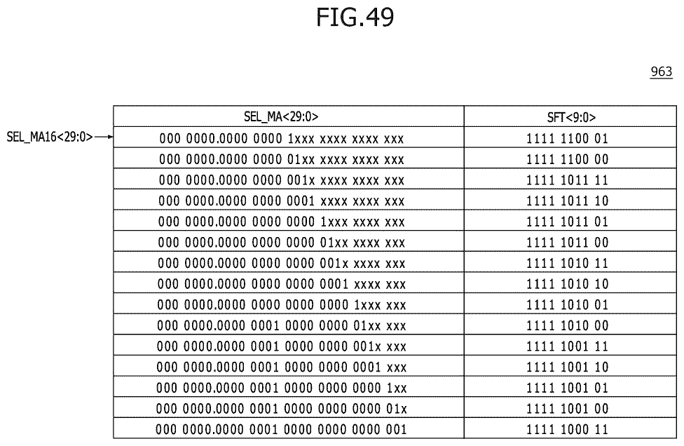

FIG. 47 is a block diagram illustrating a further example of a “1” search circuit included in a normalizer of FIG. 44. And FIGS. 48 and 49 are diagrams illustrating an example of a look-up table included in a “1” search circuit of FIG. 47. In FIGS. 48 and 49, the selected mantissa data SEL_MA(29:0> input to the “1” search circuit has a size of 30 bits, and the shift data SFT<9:0> output from the “1” search circuit has a size of 10 bits. Among the 10 bits of shift data SFT<9:0>, the lower 5 bits indicate the number of shifted bits, the upper 2 bits are sign extension bits, and the 3 bits in between the lower 5 bits and the upper 2 bits indicate whether an overflow occurs. In FIGS. 48 and 49, “x” represents the binary value “0” or “1”.

Referring to FIG. 47, the “1” search circuit 960B includes a look-up table 963. The look-up table 963 receives selected mantissa data SEL_MA as an input value (or index). As described with reference to FIG. 44, the selected mantissa data SEL_MA is transmitted from the multiplexer 930 in FIG. 44 to the look-up table 963. The look-up table 963 outputs the shift data SFT generated by the leading “1” search process for the selected mantissa data SEL_MA as an output. For this purpose, the look-up table 963 may be configured by storing the shift data SFT corresponding to the selected mantissa data SEL_MA with different positions of the leading “1” in a table format.

As shown in FIGS. 48 and 49, the look-up table 963 stores the selected mantissa data SEL_MA<29:0> of 30 bits in size, and the shift data SFT<9:0> determined by the position of the leading “1” in the selected mantissa data SEL_MA<29:0>. In this example, a binary number of 7 bits is placed to the left of the binary point of the selected mantissa data SEL_MA<29:0>, and a binary number of 23 bits is placed to the right of the binary point. The value of the shift data SFT<9:0> according to the position of the leading “1” in the selected mantissa data SEL_MA<29:0> may be determined by the method described with reference to FIG. 46. That is, the shift data SFT<9:0> is determined as a binary number corresponding to the number of bits that the selected mantissa data SEL_MA should be shifted so that the leading “1” detected by the process of searching for the leading “1” for the selected mantissa data SEL_MA is located at the MSB of the selected mantissa data SEL_MA.

As exemplified in FIG. 48, the first selected mantissa data SEL_MA1<29:0> is a binary stream of “1xx xxxx. xxxx xxxx xxxx xxxx xxxx xxxx xxx”. Because the leading “1” is already located in the MSB of the first selected mantissa data SEL_MA1<29:0>, the number of bits by which the first selected mantissa data SEL_MA1<29:0> should be shifted is “0”. Therefore, the shift data SFT<9:0> for the first selected mantissa data SEL_MA1<29:0> is “0000 0000 00”. In conclusion, the “1” search circuit 960B in FIG. 47 outputs “0000 0000 00” as the shift data SFT<9:0> stored in the look-up table 963 when the binary stream of “1xx xxxx.xxxx xxxx xxxx xxxx xxxx xxx” is input as the selected mantissa data SEL_MA<29:0>. The shift data SFT<9:0>, “0000 0000 00”, is input to the second exponent adder 970 in FIG. 44 and the unidirectional mantissa shifter 980 in FIG. 44 of the normalizer 900 in FIG. 44.

The second selected mantissa data SEL_MA2<29:0> is a binary stream of “01x xxxx.xxxx xxxx xxxx xxxx xxxx xxxx xxx”. In order for the leading “1” in the second selected mantissa data SEL_MA2<29:0> to be located at the MSB of the second selected mantissa data SEL_MA2<29:0>, a shift operation of 1 bit in the left direction (i.e., the “−1” bit) should be performed on the second selected mantissa data SEL_MA2<29:0>. As a result, the shift data SFT<9:0> for the second selected mantissa data SEL_MA2<29:0> will be “1111 1111 11”, which is the binary value of the decimal number “−1”. In conclusion, the “1” search circuit 960B in FIG. 47 outputs “1111 1111 11” stored in the look-up table 963 as the shift data SFT<9:0> when the binary stream of “01x xxxx.xxxx xxxx xxxx xxxx xxxx xxxx xxx” is input as the selected mantissa data SEL_MA<29:0>. The shift data SFT<9:0>, “1111 1111 11”, is input to the second exponent adder 970 in FIG. 44 and the unidirectional mantissa shifter 980 in FIG. 44 of the normalizer 900 in FIG. 44.

The 13th selected mantissa data (SEL_MA13<29:0>) is a binary stream of “000 0000.0000 01xx xxxx xxxx xxxx xxxx xxx”. In order for the leading “1” in the 13th selected mantissa data SEL_MA13<29:0> to be located at the MSB of the 13th selected mantissa data SEL_MA13<29:0>, a shift operation of 12 bits in the left direction (i.e., “−12” bits) should be performed on the 13th selected mantissa data SEL_MA13<29:0> . . . . As a result, the shift data SFT<9:0> for the 13th selected mantissa data SEL_MA13<29:0> will be “1111 1101 00”, which is the binary value of the decimal number “−12”. In conclusion, the “1” search circuit 960B in FIG. 47 outputs “1111 1101 00” stored in the look-up table 963 as the shift data SFT<9:0> when the binary stream of “000 0000.0000 01xx xxxx xxxx xxxx xxxx xxx” is input as the selected mantissa data SEL_MA<29:0>. The shift data SFT<9:0>, “1111 1101 00”, is input to the second exponent adder 970 in FIG. 44 and the unidirectional mantissa shifter 980 in FIG. 44 of the normalizer 900 in FIG. 44.

As exemplified in FIG. 49, the 16th selected mantissa data SEL_MA16<29:0> is a binary stream of “000 0000.0000 0000 1xxx xxxx xxxx xxx”. In order for the leading “1” in the 16th selected mantissa data SEL_MA16<29:0> to be located at the MSB of the 16th selected mantissa data SEL_MA16<29:0>, a shift operation of 12 bits in the left direction (i.e., “−12” bits) should be performed on the 16th selected mantissa data SEL_MA16<29:0>. Thus, the shift data SFT<9:0> for the 16th selected mantissa data SEL_MA16<29:0> becomes “1111 1100 01,” which is the binary value of the decimal number “−12”. In conclusion, the “1” search circuit 960B in FIG. 47 outputs “1111 1100 01” stored in the look-up table 963 as the shift data SFT<9:0> when the binary stream of “000 0000.0000 0000 1xxx xxxx xxxx xxx” is input as the selected mantissa data SEL_MA<29:0>. The shift data SFT<9:0>, “1111 1100 01”, is input to the second exponent adder 970 in FIG. 44 and the unidirectional mantissa shifter 980 in FIG. 44 of the normalizer 900 in FIG. 44.

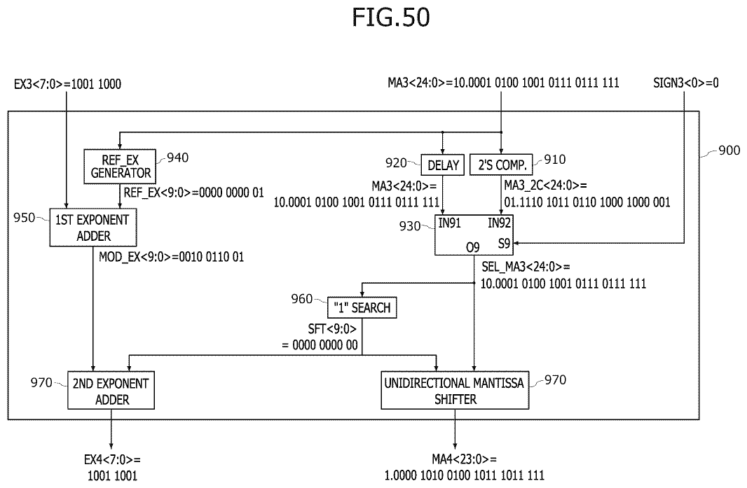

FIG. 50 is a block diagram illustrating an example of an operation of a normalizer of FIG. 44. Similar to the example operation of the normalizer 820 of FIG. 38 described with reference to FIG. 38, the following example is illustrated in which the third exponent data EX3<7:0> “1001 1000”, the third mantissa data MA3<24:0> “10.0001 0100 1001 0111 0111 111”, and the third sign data SIGN3<0> “0” are input to the normalizer.

Referring to FIG. 50, the third mantissa data MA3<24:0> “10.0001 0100 1001 0111 0111 0111 111” is input to the 2's complement circuit 910, the delay circuit 920, and the reference exponent data generator 940 of the normalizer 900. The 2's complement circuit 910 performs a 2's complement processing on the third mantissa data MA3<24:0> “10.0001 0100 1001 0111 0111 0111 111”. The 2's complement circuit 910 outputs “01.1110 1011 0110 1000 1000 001” as the 2's complement data MA3_2C<24:0> of the third mantissa data. The delay circuit 920 outputs the third mantissa data MA4<23:0> “10.0001 0100 1001 0111 0111 111” after the delay time elapses. The third mantissa data MA3<24:0> “10.0001 0100 1001 0111 0111 0111 111” output from the delay circuit 920 is transmitted to the first input terminal IN91 of the multiplexer 930. The 2's complement data MA3_2C<24:0> “01.1110 1011 0110 1000 1000 001” output from the 2's complement circuit 910 is transmitted to the second input terminal IN92 of the multiplexer 930.

The multiplexer 930 of the normalizer 900 receives the third sign data SIGN3<0> through the selection terminal S9. Because the third sign data SIGN3<0> has a value of “0”, the multiplexer 930 outputs the third mantissa data MA3<24:0> “10.0001 0100 1001 0111 0111 111,” which is input to the first input terminal IN91, as the selected third mantissa data SEL_MA3<24:0> through the output terminal O9. The selected third mantissa data SEL_MA3<24:0> “10.0001 0100 1001 0111 0111 0111 111” output from the multiplexer 930 is transmitted to the “1” search circuit 960 and the unidirectional mantissa shifter 970.

During the processing time for the third mantissa data MA3<24:0> in the 2's complement circuit 910, the delay circuit 920, and the multiplexer 930, the reference exponent data generator 940 and the first exponent adder 950 perform the reference exponent data REF_EX<9:0> generation and the first exponent addition operation, respectively. More specifically, the reference exponent data generator 940 generates and outputs the reference exponent data REF_EX<9:0> based on the number of bits between the MSB of the third mantissa data MA3<24:0> and the binary point. For the third mantissa data MA3<24:0> “10.0001 0100 1001 0111 0111 0111 111,” there is 1 bit between the MSB of the third mantissa data MA3<24:0> and the binary point. Therefore, in this case, the reference exponent data REF_EX<9:0> generated by the reference exponent data generator 940 is “0000 0000 01,” which is the binary equivalent of the decimal number “1”. The reference exponent data generator 940 transmits the reference exponent data REF_EX<9:0> “0000 0000 01” to the first exponent adder 950.

The first exponent adder 950 receives the third exponent data EX3<7:0> “1001 1000.” Also, the first exponent adder 950 receives the reference exponent data REF_EX<9:0> “0000 0000 01” from the reference exponent data generator 940. The first exponent adder 950 performs a first exponent addition on the third exponent data EX3<7:0> “1001 1000” and the reference exponent data REF_EX<9:0> “0000 0000 01.” The first exponent adder 950 outputs the result data of the first exponent addition, “0010 0110 10”, as modified exponent data MOD_EX<9:0>. The modified exponent data MOD_EX<9:0> “0010 0110 10” output from the first exponent adder 950 is transmitted to the second exponent adder 970.

The “1” search circuit 960 of the normalizer 900 detects the position of the leading “1” in the selected third mantissa data SEL_MA3<24:0> “10.0001 0100 1001 0111 0111 111,” which is output from the multiplexer 930. In the selected third mantissa data SEL_MA3<24:0> “10.0001 0100 1001 0111 0111 111,” the leading “1” is located at the MSB of the selected third mantissa data SEL_MA3<24:0>. Because the leading “1” in the selected third mantissa data SEL_MA3<24.0> is already located at the MSB of the selected third mantissa data SEL_MA3<24.0>, the shift data SFT<9:0> for the selected third mantissa data SEL_MA3<24.0> is “0000 0000 00,” which is the binary value of the decimal number “0”. The “1” search circuit 960 transfers the shift data SFT<9:0> “0000 0000 00” to the second exponent adder 970 and the unidirectional mantissa shifter 970.

The second exponent adder 970 receives the modified exponent data MOD_EX<9:0> “0010 0110 01,” which is output from the first exponent adder 950, and the shift data SFT<9:0> “0000 0000 00,” which is output from the “1” search circuit 960. The second exponent adder 970 performs a second exponent addition on the modified exponent data MOD_EX<9:0> “0010 0110 01” and the shift data SFT<9:0> “0000 0000 00.” The second exponent adder 970 outputs the resulting data, “1001 1001”, as the fourth exponent data EX4<7:0>. The fourth exponent data EX4<7:0> “1001 1001” is output from the normalizer 900 as normalized exponent data NOR_EX in FIG. 44.

The unidirectional mantissa shifter 980 receives the selected third mantissa data SEL_MA3<24:0> “10.0001 0100 1001 0111 0111 0111 111,” which is output from the multiplexer 930, and the shift data SFT<9:0> “0000 0000 00,” which is output from the “1” search circuit 960. Because the shift data SFT<9:0> is “0000 0000 00”, the number of bits by which the selected third mantissa data SEL_MA3<24:0> “10.0001 0100 1001 0111 0111 111” is shifted in the unidirectional mantissa shifter 980 is 0 bits. In other words, the unidirectional mantissa shifter 980 does not shift the selected third mantissa data SEL_MA3<24:0> “10.0001 0100 1001 0111 0111 111,” and outputs the fourth mantissa data MA4<23:0> “1.0000 1010 0100 1011 1011 111,” as the normalized mantissa data NOR_MA in FIG. 44. The process of inputting the selected third mantissa data SEL_MA3<24:0> “10.0001 0100 1001 0111 0111 0111 111” and outputting the fourth mantissa data MA4<23:0> “1.0000 1010 0100 1011 1011 111” in the unidirectional mantissa shifter 980 is the same as the process in the unidirectional mantissa shifter 826 in FIG. 39 described with reference to FIG. 39.

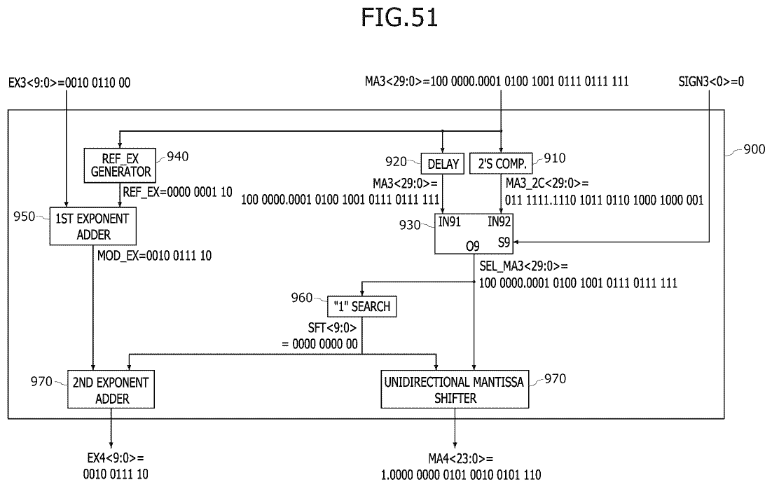

FIG. 51 is a block diagram illustrating a further example of an operation of a normalizer of FIG. 44. As with the example of the operation of the normalizer 820 of FIG. 40 described with reference to FIG. 40, the following example is illustrated in which the third exponent data EX3<9:0> “0010 0110 00,” the third mantissa data MA3<29:0> “100 0000.0001 0100 1001 0111 0111 111,” and the third sign data SIGN3<0> “0” are input to the normalizer.

Referring to FIG. 51, the third mantissa data MA3<29:0>“100 0000.0001 0100 1001 0111 0111 0111 111” is input to the 2's complement circuit 910, the delay circuit 920, and the reference exponent data generator 940 of the normalizer 900. The 2's complement circuit 910 performs 2's complement processing on the third mantissa data MA3<29:0> “100 0000.0001 0100 1001 0111 0111 111.” The 2's complement circuit 910 outputs “011 1111.1110 1011 0110 1000 1000 001” as the 2's complement data MA3_2C<29:0> of the third mantissa data. The delay circuit 920 outputs the third mantissa data MA3<29:0> “100 0000.0001 0100 1001 0111 0111 111” after the delay time elapses. The third mantissa data MA3<29:0> “100 0000.0001 0100 1001 0111 0111 111” output from the delay circuit 920 is transmitted to the first input terminal IN91 of the multiplexer 930. The 2's complement data MA3_2C<29:0> “011 1111.1110 1011 0110 1000 1000 001” output from the 2's complement circuit 910 is transmitted to the second input terminal IN92 of the multiplexer 930.

The multiplexer 930 of the normalizer 900 receives the third sign data SIGN3<0> through the selection terminal S9. Because the third sign data SIGN3<0> has a value of “0”, the multiplexer 930 outputs the third mantissa data MA3<29:0> “100 0000.0001 0100 1001 0111 0111 111,” which is input to the first input terminal IN91, as the selected third mantissa data SEL_MA3<29:0> through the output terminal O9. The selected third mantissa data SEL_MA3<29:0> “100 0000.0001 0100 1001 0111 0111 111” output from the multiplexer 930 is transmitted to the “1” search circuit 960 and the unidirectional mantissa shifter 970.

During the processing time for the third mantissa data MA3<29:0> in the 2's complement circuit 910, the delay circuit 920, and the multiplexer 930, the reference exponent data generator 940 and the first exponent adder 950 perform the reference exponent data REF_EX<9:0> generation and the first exponent addition operation, respectively. More specifically, the reference exponent data generator 940 generates and outputs reference exponent data REF_EX<9:0> based on the number of bits between the MSB of the third mantissa data MA3<29:0> and the binary point. For the third mantissa data MA3<29:0> “100 0000.0001 0100 1001 0111 0111 0111 111”, there are 6 bits between the MSB of the third mantissa data MA3<29:0> and the binary point. Therefore, in this case, the reference exponent data REF_EX<9:0> generated by the reference exponent data generator 940 is “0000 0001 10”, which is the binary equivalent of the decimal number “6”. The reference exponent data generator 940 transmits the reference exponent data REF_EX<9:0> “0000 0001 10” to the first exponent adder 950.

The first exponent adder 950 receives the third exponent data EX3<9:0> “0010 0110 00.” Also, the first exponent adder 950 receives the reference exponent data REF_EX<9:0> “0000 0001 10” from the reference exponent data generator 940. The first exponent adder 950 performs a first exponent addition on the third exponent data (EX3<9:0>) “0010 0110 00” and the reference exponent data REF_EX<9:0> “0000 0001 10.” The first exponent adder 950 outputs the result data of the first exponent addition, “0010 0111 10”, as modified exponent data MOD_EX<9:0>. The modified exponent data MOD_EX<9:0> “0010 0111 10” output from the first exponent adder 950 is transmitted to the second exponent adder 970.

The “1” search circuit 960 of the normalizer 900 detects the position of the leading “1” in the selected third mantissa data SEL_MA3<29:0> “100 0000.0001 0100 1001 0111 0111 111,” which is output from the multiplexer 930. In the selected third mantissa data SEL_MA3<29:0> “100 0000.0001 0100 1001 0111 0111 111,” the leading “1” is located at the MSB of the selected third mantissa data SEL_MA3<29:0>. Because the leading “1” in the selected third mantissa data SEL_MA3<29:0> is already located at the MSB of the selected third mantissa data SEL_MA3<29:0>, the shift data SFT<9:0> for the selected third mantissa data SEL_MA3<29:0> is “0000 0000 00,” which is the binary value of decimal “0”. The “1” search circuit 960 transfers the shift data SFT<9:0> “0000 0000 00” to the second exponent adder 970 and the unidirectional mantissa shifter 970.

The second exponent adder 970 receives the modified exponent data MOD_EX<9:0> “0010 0111 10,” which is output from the first exponent adder 950, and the shift data SFT<9:0> “0000 0000 00,” which is output from the “1” search circuit 960. The second exponent adder 970 performs a second exponent addition on the modified exponent data MOD_EX<9:0> “0010 0111 10” and the shift data SFT<9:0> “0000 0000 00.” The second exponent adder 970 outputs the resulting data, “0010 0111 10”, as the fourth exponent data EX4<9:0>.

The unidirectional mantissa shifter 980 receives the selected third mantissa data SEL_MA3<29:0> “100 0000.0001 0100 1001 0111 0111 111,” which is output from the multiplexer 930, and the shift data SFT<9:0> “0000 0000 00,” which is output from the “1” search circuit 960. Because the shift data SFT<9:0> is “0000 0000 00”, the number of bits by which the selected third mantissa data SEL_MA3<29:0> “100 0000.0001 0100 1001 0111 0111 111” is shifted in unidirectional mantissa shifter 980 is 0 bits. In other words, the unidirectional mantissa shifter 980 does not shift the selected third mantissa data SEL_MA3<29:0> “100 0000.0001 0100 1001 0111 0111 111,” and outputs the fourth mantissa data MA4<23:0> “1.0000 0000 0101 0010 0101 110” as the normalized mantissa data NOR_MA in FIG. 44. The process of inputting the selected third mantissa data SEL_MA3<29:0> “100 0000.0001 0100 1001 0111 0111 111” and outputting the fourth mantissa data MA4<23:0> “1.0000 1010 0100 1011 1011 111” in the unidirectional mantissa shifter 980 is the same as the process in the unidirectional mantissa shifter 826 in FIG. 41 described with reference to FIG. 41.

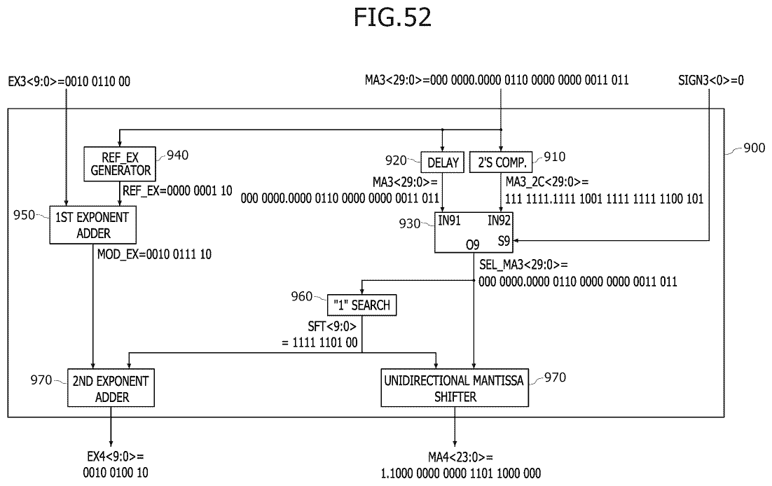

FIG. 52 is a block diagram illustrating a further example of an operation of a normalizer of FIG. 44. As with the example of the operation of the normalizer 820 of FIG. 42 described with reference to FIG. 42, the following example is illustrated in which the third exponent data EX3<9:0> “0010 0110 00,” the third mantissa data MA3<29:0> “000 0000.0000 0110 0000 0000 0011 011,” and the third sign data SIGN3<0> “0” are input to the normalizer.

Referring to FIG. 52, the third mantissa data MA3<29:0> “000 0000.0000 0110 0000 0000 0011 011” is input to the 2's complement circuit 910, the delay circuit 920, and the reference exponent data generator 940 of the normalizer 900. The 2's complement circuit 910 performs a 2's complement processing on the third mantissa data MA3<29:0> “000 0000.0000 0110 0000 0000 0011 011.” The 2's complement circuit 910 outputs “111 1111.1111 1001 1111 1111 1100 101” as the 2's complement data MA3_2C<29:0> of the third mantissa data. The delay circuit 920 outputs the third mantissa data MA3<29:0> “000 0000.0000 0110 0000 0000 0000 0011 011” after the delay time elapses. The third mantissa data MA3<29:0> “000 0000.0000 0110 0000 0000 0011 011” output from the delay circuit 920 is transmitted to the first input terminal IN91 of the multiplexer 930. The 2's complement data MA3_2C<24:0> “111 1111.1111 1001 1111 1111 1100 101” output from the 2's complement circuit 910 is transmitted to the second input terminal IN92 of the multiplexer 930.

The multiplexer 930 of the normalizer 900 receives the third sign data SIGN3<0> through the selection terminal S9. Because the third sign data SIGN3<0> has a value of “0”, the multiplexer 930 outputs the third mantissa data MA3<29:0> “000 0000.0000 0110 0000 0000 0011 011,” which is input to the first input terminal IN91, as the selected third mantissa data SEL_MA3<29:0> through the output terminal O9. The selected third mantissa data SEL_MA3<29:0> “000 0000.0000 0110 0000 0000 0011 011” output from the multiplexer 930 is transmitted to the “1” search circuit 960 and the unidirectional mantissa shifter 970.

During the processing time for the selected third mantissa data SEL_MA3<29:0> in the 2's complement circuit 910, the delay circuit 920, and the multiplexer 930, the reference exponent data generator 940 and the first exponent adder 950 perform the reference exponent data REF_EX<9:0> generation and the first exponent addition operation, respectively. More specifically, the reference exponent data generator 940 generates and outputs reference exponent data REF_EX<9:0> based on the number of bits between the MSB of the third mantissa data MA3<29:0> and the binary point. For the third mantissa data MA3<29:0> “000 0000.0000 0110 0000 0000 0011 011”, there are 6 bits between the MSB of the third mantissa data MA3<29:0> and the binary point. Therefore, in this case, the reference exponent data REF_EX<9:0> generated by the reference exponent data generator 940 is “0000 0001 10,” which is the binary equivalent of the decimal number “6”. The reference exponent data generator 940 transmits the reference exponent data REF_EX<9:0> “0000 0001 10” to the first exponent adder 950.

The first exponent adder 950 receives the third exponent data EX3<9:0> “0010 0110 00.” Also, the first exponent adder 950 receives the reference exponent data REF_EX<9:0> “0000 0001 10” from the reference exponent data generator 940. The first exponent adder 950 performs a first exponent addition on the third exponent data EX3<9:0> “0010 0110 00” and the reference exponent data REF_EX<9:0> “0000 0001 10”. The first exponent adder 950 outputs the resulting data of the first exponent addition, “0010 0111 10”, as modified exponent data MOD_EX<9:0>. The modified exponent data MOD_EX<9:0> “0010 0111 10” output from the first exponent adder 950 is transmitted to the second exponent adder 970.

The “1” search circuit 960 of the normalizer 900 detects the position of the leading “1” in the selected third mantissa data SEL_MA3<29:0> “000 0000.0000 0110 0000 0000 0011 011,” which is output from the multiplexer 930. In the selected 3rd mantissa data SEL_MA3<29:0> “000 0000.0000 0110 0000 0000 0011 011,” the leading “1” is located in the 12th lower bit from the MSB of the selected third mantissa data SEL_MA3<29:0>. To ensure that the leading “1” is located at the MSB of the selected third mantissa data SEL_MA3<29:0>, a shift of “−12” bits (i.e., “12” bits in the left direction) for the selected third mantissa data SEL_MA3<29:0> is required. Accordingly, the shift data SFT<9:0> for the selected third mantissa data SEL_MA3<29:0> becomes “1111 1101 00,” which is the binary value of the decimal number “−12”. The “1” search circuit 960 transfers the shift data SFT<9:0> “1111 1101 00” to the second exponent adder 970 and the unidirectional mantissa shifter 970.

The second exponent adder 970 receives the modified exponent data MOD_EX<9:0> “0010 0111 10,” which is output from the first exponent adder 950, and the shift data SFT<9:0> “1111 1101 00,” which is output from the “1” search circuit 960. The second exponent adder 970 performs a second exponent addition on the modified exponent data MOD_EX<9:0> “0010 0111 10” and the shift data SFT<9:0> “1111 1101 00.” The second exponent adder 970 outputs the resulting data, “0010 0100 10”, as the fourth exponent data EX4<9:0>.

The unidirectional mantissa shifter 980 receives the selected third mantissa data SEL_MA3<29:0> “100 0000.0001 0100 1001 0111 0111 111,” which is output from the multiplexer 930, and the shift data SFT<9:0> “1111 1101 00,” which is output from the “1” search circuit 960. Because the shift data SFT<9:0> is “1111 1101 00”, the number of bits by which the selected third mantissa data SEL_MA3<29:0> “100 0000.0001 0100 1001 0111 0111 111” is shifted the unidirectional mantissa shifter 980 is “−12” bits. The unidirectional mantissa shifter 980 shifts the selected third mantissa data SEL_MA3<29:0> “100 0000.0001 0100 1001 0111 0111 111” by 12 bits in the left direction to output the fourth mantissa data (MA4<23:0>) “1.1000 0000 0000 1101 1000 000.” The process of inputting the selected third mantissa data SEL_MA3<29:0> “100 0000.0001 0100 1001 0111 0111 111” and outputting the fourth mantissa data MA4<23:0> “1.1000 0000 0000 1101 1000 000” in the unidirectional mantissa shifter 980 is the same as the process in the unidirectional mantissa shifter 826 in FIG. 43 described with reference to FIG. 43.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A normalizer for performing normalization on floating-point data, the normalizer comprising:
a search circuit configured to receive selected mantissa data and to output reference exponent data and shift data, the selected mantissa data being either mantissa data of the floating-point data or 2's complement data of the mantissa data;
an exponent adder configured to output normalized exponent data by adding exponent data of the floating-point data and the reference exponent data; and
a unidirectional mantissa shifter configured to output normalized mantissa data by performing a unidirectional shift on the selected mantissa data based on a value of the shift data.

2. The normalizer of claim 1, further comprising:
a 2's complement circuit configured to receive the mantissa data of the floating-point data and to output the 2's complement data of the mantissa data;
a delay circuit configured to receive the mantissa data of the floating-point data and to output the mantissa data of the floating-point data after a delay time has elapsed; and
a multiplexer configured to receive the mantissa data from the delay circuit and the 2's complement data from the 2's complement circuit and to output the mantissa data or the 2's complement data as the selected mantissa data based on sign data of the floating-point data.

3. The normalizer of claim 2,
wherein the multiplexer is configured to:
output the mantissa data as the selected mantissa data, when the sign data is a second binary value, and
output the 2's complement data as the selected mantissa data, when the sign data is a first binary value.

4. The normalizer of claim 1,
wherein the search circuit is configured to:
perform a search operation for a leading first binary value to generate the reference exponent data and preliminary shift data, and
generate the shift data based on the preliminary shift data and the reference exponent data.

5. The normalizer of claim 4,
wherein the search circuit is configured to perform the search operation for a leading first binary value by detecting a bit position of a leading first binary value having a value of the first first binary value along the right direction, starting with the most significant bit of the selected mantissa data.

6. The normalizer of claim 4,
wherein the search circuit is configured to output a binary number as the reference exponent data, the binary number corresponding to the number of bits present between the most significant bit of the selected mantissa data and binary point.

7. The normalizer of claim 4,
wherein the search circuit is configured to output a binary number as the preliminary shift data, the binary number corresponding to the number of bits by which the selected mantissa data is to be shifted for positioning binary point to the right of the leading first binary value.

8. The normalizer of claim 7,
wherein a sign of the preliminary shift data is positive when a direction in which the selected mantissa data is to be shifted is to a right direction relative to the binary point, and
wherein the sign of the preliminary shift data is negative when the direction in which the selected mantissa data is to be shifted is to a left direction relative to the binary point.

9. The normalizer of claim 4,
wherein the search circuit is configured to output a binary number as the preliminary shift data, the binary number corresponding to the number of bits present between binary point and the leading first binary value.

10. The normalizer of claim 4,
wherein the search circuit is configured to generate the shift data by an operation of subtracting the reference exponent data from the preliminary shift data.

11. The normalizer of claim 1,
wherein the search circuit includes a look-up table comprising the selected mantissa data as an index and the reference exponent data and the shift data as output values.

12. The normalizer of claim 1,
wherein the unidirectional mantissa shifter includes a plurality of shift stages,
wherein the number of the plurality of shift stages is K satisfying a condition 2^{K}≥M, when the selected mantissa data is “M” bits, and
wherein “M” is a natural number greater than 2, and “K” is a natural number.

13. The normalizer of claim 12,
wherein each of the plurality of shift stages is comprised of a plurality of 2:1 multiplexers.

14. The normalizer of claim 13,
wherein a first shift stage of the plurality of shift stages includes first to “M”th 2:1 multiplexers, and
wherein the first to “M”th 2:1 multiplexers of the first shift stage output a first to “M”th bits of first shift data.

15. The normalizer of claim 14,
wherein the first to “M”th 2:1 multiplexers of the first shift stage receive first to “M”th bits of the selected mantissa data through first input terminals of the first to “M”th 2:1 multiplexers, respectively,
wherein the first 2:1 multiplexer of the first shift stage receives a second binary value through a second input terminal of the first 2:1 multiplexer,
wherein the second to “M”th 2:1 multiplexers of the first shift stage receive the first to “M−1”th bits of the selected mantissa data through second input terminals of the second to “M”th 2:1 multiplexers, respectively; and
wherein the first to “M”th 2:1 multiplexers of the first shift stage commonly receive a first bit of the shift data through select terminals of the first to “M”th 2:1 multiplexers.

16. The normalizer of claim 15,
wherein the first to “M”th 2:1 multiplexers of the first shift stage are configured to output the first to “M”th bit of the selected mantissa data that are input to the first input terminals of the first to “M”th 2:1 multiplexers as the first to “M”th bits of the first shift data, when the first bit of the shift data is a second binary value;
wherein the first 2:1 multiplexer of the first shift stage is configured to output a second binary value that is input to the second input terminal of the first 2:1 multiplexer as the first bit of the first shift data, when the first bit of the shift data is a first binary value; and
wherein the second to “M”th 2:1 multiplexers of the first shift stage are configured to output the first to “M−1”th bits of the selected manissa data that are input to the second input terminals of the second to “M”th 2:1 multiplexers as the second to “M”th bits of the first shift data, when the first bit of the shift data is a first binary value.

17. The normalizer of claim 14,
wherein a second shift stage of the plurality of shift stages includes first to “M”th 2:1 multiplexers, and
wherein the first to “M”th 2:1 multiplexers output first to “M”th bits of second shift data.

18. The normalizer of claim 17,
wherein the first to “M”th 2:1 multiplexers of the second shift stage receive the first to “M”th bits of the first shift data through first input terminals of the first to “M”th 2:1 multiplexers, respectively,
wherein the first 2:1 multiplexer and the second 2:1 multiplexer of the second shift stage receive a second binary value through second input terminals of the first 2:1 multiplexer and the second 2:1 multiplexer,
wherein the third to “M”th 2:1 multiplexers of the second shift stage receive the first to “M−2”th bits of the first shift data through second input terminals of the third to “M”th 2:1 multiplexers, respectively, and
wherein the first to “M”th 2:1 multiplexers of the second shift stage commonly receive a second bit of the shift data through selection terminal of the first to “M”th 2:1 multiplexers.

19. The normalizer of claim 18,
wherein the first to “M”th 2:1 multiplexers of the second shift stage are configured to output the first to “M”th bits of the first shift data that are input to the first input terminals as the first to “M”th bits of the second shift data, when the second bit of the shift data is a second binary value;
wherein the first 2:1 multiplexer and the second 2:1 multiplexer are configured to output a second binary value that are input to the second input terminals as the first and second bits of the second shift data, respectively, when the second bit of the shift data is a first binary value, and
wherein the third to “M”th 2:1 multiplexers of the second shift stage are configured to output the first to “M−2”th bits of the first shift data that are input to the second input terminals as the third to “M”th bits of the second shift data, when the second bit of the shift data is a first binary value.

20. The normalizer of claim 17,
wherein a third shift stage of the plurality of shift stages includes first to “M”th 2:1 multiplexers, and
wherein the first to “M”th 2:1 multiplexers output a first to “M”th bits of third shift data.

21. The normalizer of claim 20,
wherein the first to “M”th 2:1 multiplexers of the third shift stage receive the first to “M”th bits of the second shift data through first input terminals of the first to “M”th 2:1 multiplexers, respectively,
wherein the first to fourth 2:1 multiplexers of the third shift stage receive a second binary value through second input terminals of the first to fourth 2:1 multiplexers, respectively,
wherein the fifth to “M”th 2:1 multiplexers of the third shift stage receive the first to “M−4”th bits of the second shift data through second input terminals of the fifth to “M”th 2:1 multiplexers, respectively; and
wherein the first to “M”th 2:1 multiplexers of the third shift stage commonly receive a third bit of the shift data through select terminals of the first to “M”th 2:1 multiplexers.

22. The normalizer of claim 21,
wherein the first to “M”th 2:1 multiplexers of the third shift stage are configured to output the first to “M”th bits of the second shift data that are input to the first input terminals as the first to “M”th bits of the third shift data, when the third bit of the shift data is a second binary value;
wherein the first to fourth 2:1 multiplexers are configured to output a second binary value that are input to the second input terminals as the first to fourth bits of the third shift data, when the third bit of the shift data is a first binary value; and
wherein the fifth to “M”th 2:1 multiplexers are configured to output the first to “M−4”th bits of the second shift data that are input to the second input terminals as the fifth to “M”th bits of the third shift data, when the third bit of the shift data is a first binary value.

23. The normalizer of claim 20,
wherein a fourth shift stage of the plurality of shift stages includes first to “M”th 2:1 multiplexers,
wherein the first to “M”th 2:1 multiplexers output a first to “M”th bits of fourth shift data.

24. The normalizer of claim 23,
wherein the first to “M”th 2:1 multiplexers of the fourth shift stage receive the first to “M”th bits of the third shift data through first input terminals of the first to “M”th 2:1 multiplexers, respectively,
wherein the first to eighth 2:1 multiplexers of the fourth shift stage receive a second binary value through second input terminals of the first to eighth 2:1 multiplexers,
wherein the ninth to “M”th 2:1 multiplexers of the fourth shift stage receive the first to “M−8”th bits of the third shift data through second input terminals of the ninth to “M”th 2:1 multiplexers, respectively; and
wherein the first to “M”th 2:1 multiplexers of the fourth shift stage commonly receive a fourth bit of the shift data through selection terminals of the first to “M”th 2:1 multiplexers.

25. The normalizer of claim 24,
wherein the first to “M”th 2:1 multiplexers of the fourth shift stage are configured to output the first to “M”th bits of the third shift data that are input to the first input terminals as the first to “M”th bits of the fourth shift data, when the fourth bit of the shift data is a second binary value;
wherein the first to eighth 2:1 multiplexers are configured to output a binary value of “0” that is input to the second input terminals as the first to eighth bits of the fourth shift data, when the fourth bit of the shift data is a first binary value; and
wherein the ninth to “M”th 2:1 multiplexers are configured to output the first to “M−8”th bits of the third shift data that are input to second input terminals as the ninth to “M”th bit of the fourth shift data, when the fourth bit of the shift data is a first binary value.

26. The normalizer of claim 23,
wherein a fifth shift stage of the plurality of shift stages includes first to “N”th 2:1 multiplexers, wherein “N” is a natural number less than “M”, and
wherein the first to “N”th 2:1 multiplexers output a first to “N”th bits of the normalized mantissa data.

27. The normalizer of claim 26,
wherein the first to “N”th 2:1 multiplexers of the fifth shift stage receive the “M−N+1”th to “M”th bits of the fourth shift data through first input terminals of the first to “N”th 2:1 multiplexers, respectively,
wherein the first to “N−M+16”th 2:1 multiplexers of the fifth shift stage receive a second binary value through second input terminals of the first to “N−M+16”th 2:1 multiplexers,
wherein the “N−M+17”th to “N”th 2:1 multiplexers of the fifth shift stage receive the first to “M−16”th bits of the fourth shift data through second input terminals of the “N−M+17”th to “N”th 2:1 multiplexers, respectively; and
wherein the first to “N”th 2:1 multiplexers of the fifth shift stage commonly receive a fifth bit of the shift data through select terminals of “N−M+17”th to “N”th 2:1 multiplexers.

28. The normalizer of claim 27,
wherein the first to “N”th 2:1 multiplexers of the fifth shift stage are configured to output the “M−N+1”th to “M”th bits of the fourth shift data that are input to the first input terminals as the first to “N”th bit of the normalized mantissa data, when the fifth bit of the shift data is a second binary value;
wherein the first to “N−M+16”th 2:1 multiplexers of the fifth shift stage are configured to output a second binary value that is input to the second input terminals as the first to “N−M+16”th bits of the normalized mantissa data, when the fifth bit of the shift data is a first binary value; and
wherein the “N−M+17”th to “N”th 2:1 multiplexers of the fifth shift stage are configured to output the first to “M−16”th bits of the fourth shift data that are input to the second input terminals as the “N−M+17”th to “N”th bit of the normalized mantissa data, when the fifth bit of the shift data is a first binary value.

29. A normalizer for performing normalization on floating-point data, the normalizer comprising:
a reference exponent data generator configured to generate and output reference exponent data based on mantissa data of the floating-point data;
a first exponent adder configured to output modified exponent data by performing a first exponent addition on the exponent data of the floating-point data and the reference exponent data;
a search circuit configured to receive selected mantissa data and to output shift data, the selected mantissa data being either the mantissa data of the floating-point data or 2's complement data of the mantissa data;
a second exponent adder configured to output normalized exponent data by performing a second exponent addition on the modified exponent data and the shift data; and
a unidirectional mantissa shifter configured to output normalized mantissa data by performing a unidirectional shift on the selected mantissa data based on a value of the shift data.

30. The normalizer of claim 29,
wherein the reference exponent data generator is configured to output a binary number as the reference exponent data, the binary number be corresponding to the number of bits present between the most significant bit of the mantissa data and binary point.

31. The normalizer of claim 29, further comprising:
a 2's complement circuit configured to receive the mantissa data of the floating-point data and to output the 2's complement data of the mantissa data;
a delay circuit configured to receive the mantissa data of the floating-point data and to output the mantissa data after a delay time has elapsed; and
a multiplexer configured to receive the mantissa data from the delay circuit and the 2's complement data from the 2's complement circuit and to output the mantissa data or the 2's complement data as the selected mantissa data based on sign data of the floating-point data.

32. The normalizer of claim 31,
wherein the multiplexer is configured to:
output the mantissa data as the selected mantissa data, when the signed data is a second binary value, and
output the 2's complement data as the selected mantissa data, when the sign data is a first binary value.

33. The normalizer of claim 29,
wherein the search circuit includes a leading first binary value search circuit that performs a search operation for a leading first binary value to generate the shift data, and
wherein the leading first binary value search circuit is configured to:
perform the search operation for a leading first binary value by detecting a bit position of a leading first binary value having a value of the first first binary value along the right direction, starting from the most significant bit of the selected mantissa data; and
output a binary number as the shift data, the binary number being corresponding to a number of bits by which the selected mantissa data is to be shifted for positioning the leading first binary value to the most significant bit of the selected mantissa data.

34. The normalizer of claim 29,
wherein the search circuit includes a look-up table comprising the selected mantissa data as an index and the shift data as output values.
